(19) United States
(12) Patent Application Publication
(10) Pub. No.: US 2009/0198488 A1
(43) Pub. Date: Aug. 6, 2009

(54) System and method for analyzing communications using multi-placement hierarchical structures

(76) Inventor: Eric Arno Vigen, Laguna Hills, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/012,753

(22) Filed: Feb. 5, 2008

(51) Int. Cl. G06F 17/28

(52) U.S. Cl. 704/9

(57) ABSTRACT

A system and method are provided for analyzing communications to disambiguate the meaning of the analyzed communications using placements into a fixed hierarchical structure based on the words, position and grammar of the communications. The disambiguated meaning of the communications can be used in conjunction with other functional programs (e.g., search engines, email, word processing). The system and method may further analyze communications associated with a communicator to determine a profile (attributes, preferences, relationships, trends, ratios) for the communicator indicated by the communications. Automated communications can be generated to match the attributes of any communicator's preferences stored in their profile, to match the attributes of other communications, or to match certain standards.

### BACKGROUND

This disclosure relates generally to the field of analyzing text and other communications and, more particularly, to a system and method for analyzing communication and its underlying meaning, tone, personality, thinking and communicating process, believability, decision-making, persuasion processes, quality and/or other attributes using novel hierarchical structures.

There have been numerous attempts to utilize automated systems to analyze text or speech. For instance, systems exist which use a computer to translate text from one language into another language, where such systems typically use one-to-one mappings of words in one language to corresponding words in a second language without consideration of the context of the word. Unfortunately, it can be difficult to automatically translate text in one language to text in another language so that the meaning of the original text is accurately reflected in the translation. Furthermore, it is difficult to phrase the translated text correctly and comply with the grammar rules of the translation language.

There have been other attempts at evaluating writing using computerized techniques. For instance, word processing programs exist that include procedures for identifying particular writing errors, such as misspellings or subject-verb agreement problems. The usefulness of these approaches are limited in that they are based solely on grammar and parts of speech. Such approaches provide little feedback regarding a particular writing style being analyzed, which traditionally has been felt to be more subjective in nature. There have been some attempts at analyzing writing style by measuring coherence or the correlation between segments of text being evaluated. One such writing coherence analyzer, known as latent semantic analysis (LSA), uses a vector-based similarity calculations between text segments to measure relatedness. However, several drawbacks exist for these known systems of text coherence evaluation which simply calculate the similarity between adjacent sentences in a text and use the assumption that the chain of text coherence is essentially linear.

There is a need to develop a system and method to automatically evaluate and analyze text and other communications, wherein the analysis comprehends the meaning of the communications, wherein the analysis corresponds greatly with human-based scoring, wherein the analysis does not require voluminous sample data in order to complete the automatic evaluation, wherein a hierarchical structure is developed to accurately evaluate the communication and the hierarchical structure can be used to create various different types of outputs.

### SUMMARY

According to one or more embodiments, a system and method for analyzing communications are provided which process communications extracting at least one and often more than one element of meaning from words, position and grammar into a useful fixed, multi-dimensional, hierarchical structure capable of: 1) providing an analysis of the attributes of the communications, 2) providing an analysis of the meaning of the communications, 3) providing an analysis of the relationships between components within a communication and between other communications, 4) providing a visual interpretation and analysis of the communications to illustrate patterns in visual results, 5) allowing further processes to be performed on the hierarchical structure to identify weaknesses in the communications, 6) providing other analyses of the communication, such as grading of the communication and recommendations for improvement, 7) allowing for the automated creation of a new or improved communication in any form and in any language by performing transformations of the hierarchical structure in reverse, and/or 8) allowing for the automated creation of responses to communications based on the attributes of the received communications.

According to one or more embodiments, a system and method for analyzing communications are provided which disambiguate the meaning of the analyzed communications. In one or more embodiments, the meaning is disambiguated using a fixed, multi-dimensional, hierarchical structure created based on the words, position and grammar of the communications. The disambiguated meaning of the communications can be used for further analysis and/or functionality.

For example, in one or more embodiments, the system could include search engine functionality for searching Internet web sites, such that the particular search results that are returned to an individual submitting a search request can be analyzed to disambiguate the meaning of the search results. The search results could then be filtered or otherwise selected to be presented to a user making the search request based upon the user's profile (e.g., attributes, preferences). The results returned to the user could be limited to those matching the user's profile or the results could be presented to the individual in an order defined by the correspondence between the attributes of the results and the attributes of the individual. In another example represented in one or more embodiments, the system could be utilized with a word processing program that analyzes a document or communication prepared using the word processing program to provide some disambiguated meaning of the prepared document. For instance, a toolbar in the word processing program could be activated by a user to disambiguate the meaning of a document and provide an output to the user or the meaning can be automatically disambiguated and presented to the user as the user creates the document.

According to one or more embodiments, a system and method for analyzing communications are provided which analyze communications associated with a communicator to determine communicator-related characteristics, such as the attributes, patterns of attributes, preferences, relationships, trends, and ratios as indicated by the communications associated with a communicator. In one or more embodiments, such communicator-related characteristics are determined by analyzing the multi-dimensional, hierarchical structures that have been generated based on such communications and disambiguating the meaning of the analyzed communications. In this manner, the system creates a profile of characteristics associated with a communicator. The system and method may analyze multiple communications to revise and update a communicator's profile. Further, multiple communications associated with a group of communicators may further be analyzed to determine profiles relative to the entire group. These profiles may then be utilized by the system to generate responsive communications that are selected based upon the communicator's preferences as interpreted from the attributes.

In one or more embodiments, based upon the profile of an intended recipient of a communication, the system and method for analyzing communications further provides analysis, recommendations, recommended modifications and/or automatically performed modifications to communications directed to the intended recipient based upon a comparison of the attributes of the communications to those of the intended recipient. For instance, the communications directed to the intended recipient could be analyzed or modified with respect a desired degree of matching between selected attributes of the communications and those of the intended recipient. This allows a communication to be modified or specially tailored to address the intended recipient's profile. The communications directed to the intended recipient can be matched against the intended recipient's attributes, patterns and preferences. For instance, the goals, tone (voice), motivation, and other attributes of the communication can be matched to reflect similar goals, tone (voice), motivation, and other attributes of the intended recipient. In one or more embodiments, the information related to the profiles of both parties to a communication (i.e., both sender and recipient) can be matched to ensure the communication matches certain attributes of at least one of the parties. For example, the system could include email functionality, such that a responsive email to a received email would be analyzed before sending it, where analysis, grading and/or recommendations could be generated directing the party sending the responsive email to use a different goal, voice (tone), motivation or other attribute based on an intended recipient's profile and an analysis of the received email.

In one or more embodiments, the system and method for analyzing communications analyze an incoming communication received by the system to determine the attributes of the incoming communication. Based on the determined attributes, certain actions (e.g., analyses or profile generation) and/or certain communications (e.g., responsive communications directed to one or more intended recipients) can be automatically generated based the analysis performed. In one or more embodiments, different responsive communications are respectively generated for different recipients based upon the stored profile and/or attributes of the different recipients. Furthermore, rather than being a responsive communication, the system and method can similarly generate initial communications to one or more intended recipients based upon at least one of an analysis of communications intended to be sent and the respective profiles of the intended recipients.

In one or more embodiments, the system and method for analyzing communications is provided that analyzes specific relationships in the communications for recognizing topic sentences, long chain reasoning threads and certain outlines.

Various analyses performed by the various embodiments described herein may also be utilized for analytical purposes and not necessarily for the generation of a particular communication. For instance, communications can be analyzed for purposes related to marketing, relative education and other purposes not strictly related to the creation of communications.

For purposes of summarizing the disclosure and the advantages achieved over the prior art, certain advantages of the disclosure may be described herein. Of course, it is to be understood that not necessarily all such advantages may be achieved in accordance with any particular embodiment of the disclosure. Those skilled in the art will recognize that the disclosure may be embodied or carried out in a manner that achieves or optimizes one advantage or group of advantages as taught herein without necessarily achieving other advantages as may be taught or suggested herein.

All of these embodiments are intended to be within the scope of the disclosure herein disclosed. These and other embodiments of the present disclosure will become readily apparent to those skilled in the art from the following detailed description of the preferred embodiments having reference to the attached figures, the disclosure not being limited to any particular preferred embodiment disclosed.

### DRAWINGS

The above-mentioned features and objects of the present disclosure will become more apparent with reference to the following description taken in conjunction with the accompanying drawings wherein like reference numerals denote like elements and in which:

FIG. 1 is a flow diagram of a method for analyzing communication in accordance with the present disclosure.

FIG. 2 is a representative hierarchical structure of the Process dimension versus the Situation dimension in accordance with the present disclosure.

FIG. 3 is a representative hierarchical structure of the Decision Matrix in the Value dimension in accordance with the present disclosure.

FIG. 4 is a representative hierarchical structure of the View dimension as applied to Decision Matrix in the Value dimension in accordance with the present disclosure.

FIG. 5 is a representative hierarchical structure of the sub-classifications of the Parties classification in the Situation dimension versus the Process dimension in accordance with the present disclosure.

FIG. 6 is a representative hierarchical structure for the sub-classifications of the “Higher Order Goals” in the Decision Matrix in accordance with the present disclosure.

FIG. 7 is another example of a representative hierarchical structure of the Decision Matrix in the Value dimension in accordance with the present disclosure.

FIG. 8 is another example of a representative hierarchical structure of the Process dimension versus the Situation dimension in accordance with the present disclosure.

FIGS. 9A-9E illustrate an example of the transformation of a received communication into a representative hierarchical structure of the Process dimension versus the Situation dimension in accordance with the present disclosure.

FIGS. 10A-10C illustrate an example of the transformation of a received communication into a representative hierarchical structure of the Decision Matrix in accordance with the present disclosure.

FIG. 11 is a block schematic diagram of an exemplary computer system that may be utilized for implementing the communications analysis in accordance with the present disclosure.

FIG. 12 is another block schematic diagram of an exemplary computer system that may be utilized for implementing the communications analysis in accordance with the present disclosure.

FIGS. 13A-13C, 14A-14B, 15A-15B, 16A-16B, 17A-17B, 18A-18B, 19A-19B and 20A-20B illustrate examples of the communications analysis performed and output in accordance with the present disclosure.

FIG. 21 illustrates examples of dictionary database entries for a number of words in accordance with a thesaurus aspect of the present disclosure.

FIGS. 22A-22C illustrate an example of the communications analysis performed and output in accordance with one embodiment of the present disclosure.

FIG. 23 illustrates a representative output showing a depth of usage in accordance with one embodiment of the present disclosure.

FIGS. 24A-24B and 25 illustrate representative outputs showing the tone of the communication in accordance with one embodiment of the present disclosure.

FIG. 26 is a block schematic diagram of an exemplary networked system that may be utilized for implementing the communications analysis in accordance with the present disclosure.

FIG. 27 illustrates an operational flow diagram of a search engine program used in accordance with one embodiment of the present disclosure.

FIG. 28 is a table illustrating the search results filtering that can be accomplished in accordance with one embodiment of the present disclosure.

FIG. 29 illustrates a representative output of a word processing program used in accordance with one embodiment of the present disclosure.

FIG. 30 is an operational flow diagram showing a method for generating a communicator's profile in the communicator preference database in accordance with one embodiment of the present disclosure.

FIG. 31 is an operational flow diagram showing a method for analyzing communications directed to certain communicators in accordance with one embodiment of the present disclosure.

FIG. 32 illustrates a representative output of the audience connectivity factor in accordance with one embodiment of the present disclosure.

FIGS. 33A-33E illustrate a representative output of the audience connectivity factor in accordance with one embodiment of the present disclosure.

FIG. 34 is an operational flow diagram showing a method for generating an automated response using communication analyses described in accordance with one embodiment of the present disclosure.

FIG. 35 is an operational flow diagram showing a method for identifying topic sentences in accordance with one embodiment of the present disclosure.

FIGS. 36A-36B illustrates a representative output of the topic sentence analysis in accordance with one embodiment of the present disclosure.

FIGS. 37-39 illustrate an example of the communications analysis performed using a pattern of preferences in accordance with one embodiment of the present disclosure.

FIG. 40 is an operational flow diagram showing a method for further disambiguating search requests in accordance with one embodiment of the present disclosure.

### DETAILED DESCRIPTION

In one or more embodiments, a novel system and method are provided for analyzing communication by transforming such communication into a useful, multi-dimensional, hierarchical structure. Rather than relying solely on parts of speech and grammar as the means of analyzing communications as performed conventionally, the present method categorizes elements of communication into such hierarchical structures using novel classification hierarchies. These hierarchical structures provide a powerful communication analysis tool that can be used to disambiguate the meaning of the communication and can be used in various embodiments for many applications, including but not limited to, for example, objectively and accurately grading essays, providing recommendations for revising texts or for improving writing or speaking abilities, creating outlines that summarize the communication, documenting underlying decision making and persuasion processes or other attributes of the communication, translating the communication and providing more sensitive thesaurus word recommendations.

For the purposes of this disclosure, the term hierarchical structure shall refer to an array, table, chart or index of at least k dimensions (k≧1), where each dimension consists of classification information relevant to organization, meaning, reference, or understanding of the communication. Each dimension of the hierarchical structure may include any number of classifications or categories and may further include subclassifications within certain classifications such that a hierarchical tier of information can be represented in each dimension.

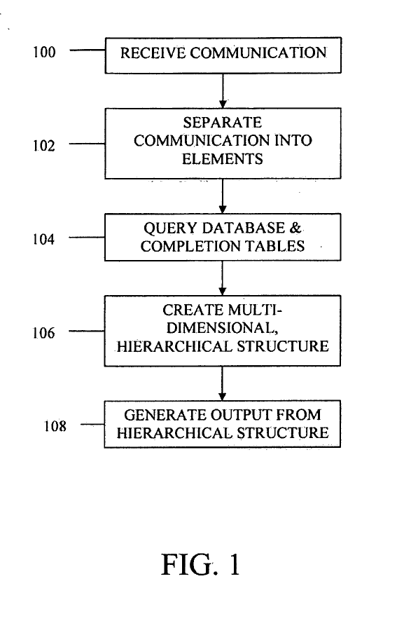

Referring now to FIG. 1, a flow diagram is illustrated for one embodiment of the method for analyzing communication by transforming such communication into a useful, multi-dimensional, hierarchical structure. At process block 100, a communication is received. The communication may be received in any form (e.g., text, handwriting, digital text files, audio files, audio streaming, live speech, visual communication, etc.) and in any language. Based upon the form in which the communication is received, some embodiments may require that the communication undergo an initial transformation to place the communication in a recognizable form capable of being parsed into the individual elements that make up the communication. For instance, a character recognition device may be utilized to convert written text or handwriting into a digital text files or a speech recognition device may be utilized to convert speech or audio files into digital text files as are known to those skilled in the art.

Each communication comprises a plurality of constituent elements, such as letters, words, punctuation, line breaks, paragraph breaks, page breaks, headings, text files, sound files and such. Each communication also includes at least one and likely many communication groups, such as words alone, phrases, sentences, paragraphs, passages, chapters and such.

After the received communication is placed into a recognizable and parsable form, the received communication is separated or parsed in process block 102 into individual communication elements, such as words, phrases or groups. Individual communication elements will be described in the various embodiments as words for ease in describing the present method, but it is understood that the communication elements may take any form consistent with the teachings herein. A database query is performed in process block 104 to retrieve hierarchical classification information contained therein for the parsed words from the received communication. In one embodiment, the database is a definition database containing stored words along with hierarchical classification information. The definition database comprises, in part, a lexicon of words including corresponding definitions, classification hierarchy elements and all of the various derivates of each word, such as plurals. Moreover, phrases, such as idioms, that convey meanings inconsistent with the definitions of each word of the phrase alone are included in the database.

Words stored in the definition database may have multiple definitions if reviewed only as a search for the word alone. However, the database will have a unique identifier for each word in combination with relative order and hierarchical classification of communications elements from surrounding words. The communication elements in the dictionary database have a primary hierarchical reference that follows from the top of the hierarchy to one specific primary subcategory with additional restrictive and reference links from other dimensions. The best match may be determined by examining the hierarchical references and relative communications order of the nearby communication elements. The retrieval process in process block 104 includes selection criteria that extend beyond merely looking up the word itself and include an examination of the surrounding communication elements according to search algorithms to assist in selecting the appropriate information to retrieve. The retrieval process may utilize a word plus its placement in relation to certain other hierarchical placements of communication elements surrounding it to determine the appropriate information to retrieve. Thus, for each word in a communications group, one or more information placements indicating a position in the hierarchical structures are retrieved, where each information placement may possess a value for priority based upon data in the dictionary database, the order of receipt and/or its relationship to surrounding words received. In an embodiment, entries with multiple classification hierarchy elements may have priority information embedded, which indicate the relative importance of the classification hierarchy element as related to the word, especially where multiple categories within the same classification hierarchy apply.

The database should have a primary information placement for the communications elements stored therein. In addition, the database may have number, gender, tense, voice or similar grammatical fields or formats for additional matching or may be two items with number and gender as one of the data fields.

Information and rules may also be retrieved from various types of completion tables, such as a grammar rule table. The information retrieved from the dictionary database and completion tables is then used to create the hierarchical structure or (k-dimensional array) in process block 106. Classification hierarchy categorical information directs each element of the communication (i.e., parsed words) to be placed into the hierarchical structure comprised of any number of dimensions, each dimension corresponding to a classification hierarchy. One or more classification hierarchies are contemplated, where each classification hierarchy is defined as a dimension in a k-dimensional array, which may be used to produce useful output. The k-dimensional array exists in multiple dimensions defined by the various classification hierarchy tiers, as will be described in detail below. Each classification hierarchy tier comprises categorical and sub-categorical elements, where each sub-categorical element may be further divided into yet additional sub-categorical elements which may also in turn be further divided. As such, the classification hierarchy tier may contain any possible number of levels of categorical and sub-categorical elements. The hierarchical structure may comprise one or more k-dimensional arrays defined by the various classification hierarchy tiers or, alternatively, may comprise a single multi-dimensional array storing all of the information in a plurality of dimensions with each dimension representing a respective tier of a classification hierarchy.

The database retrieval creates for each word one or more information placements in the hierarchical structure. The method continues placing words into the hierarchical structure according to algorithms using order, surrounding elements (other words, punctuation) until a complete hierarchical structure (i.e., table of information) is completed for a given grouping of communication elements, such as for each sentence, paragraph, chapter, etc.

Once the hierarchical structure has been completed, the hierarchical structure can be utilized to generate a desired output in process block 110. For instance, an output algorithm can evaluate various relationships and ratios between the word placements in the hierarchical structure in order to automatically elucidate the meanings intended in the communication. Relationships and ratios of the elements placed into the hierarchical structure based on the words, order and grammar of the communication will define the meaning of the communication. Further, placements missing from the hierarchical structure can be used to identify where ambiguities exist with respect to the analyzed communication. In this manner, the communication can be analyzed to disambiguate its meaning. Thus, the hierarchical structure exists as an organizer, where definitions of instances of words signify locations in at least one k-dimensional array where the word exists. Information can thereby be derived based on analysis of patterns, duplicative information, ratios, order, or the absence of data in the k-dimensional arrays.

The hierarchical structure can be utilized to output: 1) various presentations of the communication showing subsets of these dimensions or cross-dimensions in tables, charts and reports; 2) a visual chart/picture of certain elements of communication traditionally invisible from the words alone, such as motivation, theme, personality, thinking and communicating process, believability, decision-making, persuasion processes, tone and/or proficiency; 3) a structure documenting the communication on a more in-depth level than just the word received; 4) identification of communications weaknesses, missing information and critical thinking issues based upon algorithms applied to the structured information; 5) recommendations for improvements; 6) grading valuations and commendations; 7) communications improvements such as revised text with improved wording; and/or 8) a new structure for a dictionary and thesaurus based upon that structure.

In one embodiment, the hierarchical structure can also be used as a building block in reverse to build new communications in other languages or dialects based upon a completed hierarchical structure without having to start from an existing communication and having to perform a two-way decode and encode combination to translate communications from one language or dialect to other languages or dialects. Thus, the present method of analyzing communication can more accurately output useful information, such as grades or translations, with improved fidelity over current mechanical implementations seeking to accomplish similar tasks.

The various hierarchical structures representing groupings of communication can be used in combination or by using subsets thereof to analyze the communication by using placements within the structures, ratios of the subsets or by relating the order of the subsets to indicate the specific flow of information within the communication. The combinations of the hierarchical structures can be used to show the flow, order, organization, effectiveness, tone and depth of proper usage of elements of the communication. Those structures with backwards movements, with repeat placements, with extra placements, with missing placements or other undesirable placements each can be used to generate 1) grade valuation changes, 2) recommendations, comments and/or commendations and 3) improved or corrected communications.

The present communications analysis method uses a classification hierarchy that allows the meaning of the ideas conveyed in communication to be elucidated from the generated hierarchical structures. In this manner, a computer or machine could create and analyze the hierarchical structures to determine the meaning of the received communication in a manner equivalent to the subjective analysis provided by human proof-readers. Thus, the particular classification hierarchies or dimensions are selected to allow the meaning of the communication to be determined.

In one embodiment, the classification hierarchies include at least one of the following classifications or dimensions: Situation, Process, Value and View. However, it is understood that other similar classifications or dimensions could be utilized that elicit the meaning of the communication. The Value and View dimensions are closely related and can potentially be merged into a single dimension in another embodiment, which might call the combined Value and View dimensions according to another name, such as the Logical dimension, for example. In yet another embodiment, the use of grammar rules and parts of speech as independent categories may be used as a source to extract additional elements using those results by the same classification hierarchy in combination with elements extracted by analysis of the words relative to a dictionary database and the Situation, Process, Value, and View dimensions. In yet another embodiment, the use of position may be used as a source to extract additional elements using those results by the same classification hierarchy in combination with elements extracted by the dictionary or grammar methods. Each dimension may contain sub-classifications, and each sub-classification may comprise sub-sub-classifications and so forth to create desired hierarchies under each dimension as required to elicit the meaning of a communication to produce useful output.

Situation Dimension

In one embodiment, one of the classification hierarchies includes the Situation dimension which classifies words based on situation data: such as party, location, time, resources, abilities, beliefs, and goals. These situation criteria roughly correspond to the questions of who, where, when, what, how and why, respectively, in a given communication. Both beliefs and goals relate to the how question, albeit from different perspectives. Within the Situation dimension, some or all Situation classifications have sub-classifications. For example, in one embodiment, the parties classification sub-classifies into perspective, actors, and recipients. In another embodiment, the location classification sub-classifies into length, width, height, proximity, and physical location among others. These further sub-classifications under each classification create the opportunity for useful sorting when applying output generation procedures.

Process Dimension

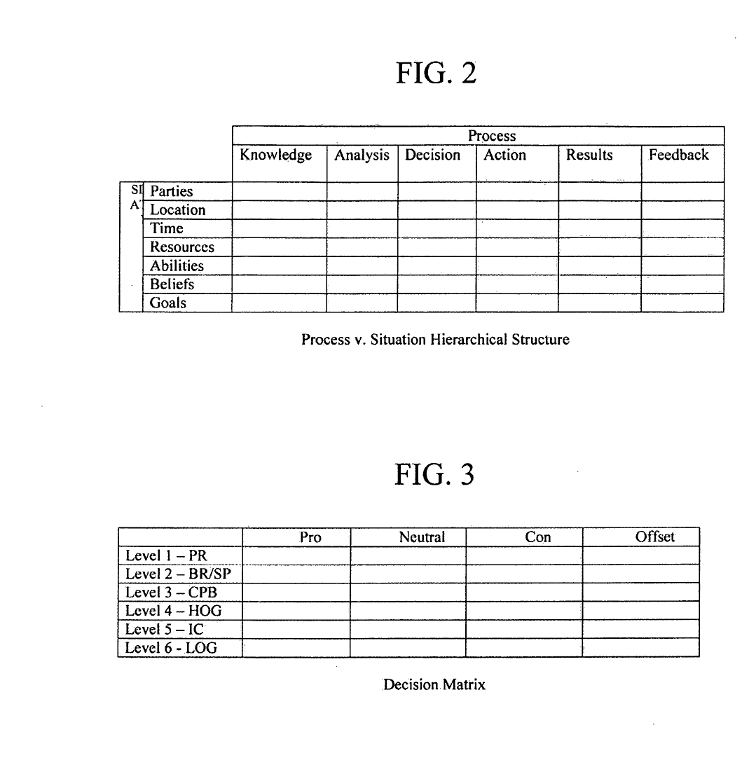

In one embodiment, one of the classification hierarchies includes the Process dimension which considers the process reflected in a communication. The Process dimension includes at least one of the following hierarchical sub-classifications: knowledge, analysis, decision, action, results, and feedback (KADARF). Another embodiment of the present communications analysis method also contemplates using a smaller set of process categories, such as the knowledge, analysis, action, and results categories. The sub-classifications of Process dimension relate to general points in a process. The knowledge sub-classifications relates to facts necessary to complete the process. The results and feedback sub-classifications related to the outcome of a process. Analysis, decision, and action are sub-classifications relating to steps taken during a process. Referring to FIG. 2, a hierarchical structure or array of the process dimension versus the situation dimension is illustrated.

In one aspect, the analysis sub-classification can be divided between criteria-based placements (analytical or deductive) and assessment-based placements (intuitive or inductive). In one aspect, the decision sub-classification can be divided between placements preferring either 1) being decisive or 2) keeping open options. In one aspect, the action sub-classification for interaction methods can be divided into the further sub-classifications: force, alone/avoid, compete and trade/team. In one aspect, the results sub-classification can be divided into the further sub-classifications: fun, security, support and growth placements. In one aspect, the feedback sub-classification can be divided into the further sub-classifications: emotional feelings (e.g., by analyzing the results sub-classification for the personal value) and deconstructive thinking (e.g., by analyzing the prior steps and their linkage for effectiveness).

Value Dimension

In one embodiment, one of the classification hierarchies includes the Value dimension which defines motivations reflected in a communication. The Value dimension includes a Decision Matrix as the fundamental organizational hierarchical structure, as illustrated in FIG. 3. The illustrated structure connects the 1) positive or negative Value concept by the columns with 2) the relative priority Value concept by the rows and 3) the truth Value concept by the communicator's choice to communicate such or the user's choice to place the item in the structure. The Value dimension includes the following sub-classifications of the Decision Matrix: practical reality (PR) (those items outside the control to change in this situation), basic respect and self-protection (BR/SP) (those items that harm other parties), core personal beliefs (CPB) (the actions that the perspective party believes creates results powerfully and consistently), higher order goals (HOG) (the highest ranking Results sought by the perspective party), interaction commitments (IC) (agreements, teams), and lower order goals (LOG) (lower ranking beliefs, goals, interactions). While one embodiment uses these six sub-classifications in the above, it is understood that other sub-classifications or a different order of categories is contemplated by the present communications analysis method.

Depending on the context, Value dimension subcategories differentiate by either truth and completeness or by positive and negative values. The subcategories of the Value dimension can be weighted differently. In one embodiment, values associated with practical reality are considered as being of greater weight than values associated with basic respect and self-protection, which are weighted more than core personal beliefs, and so forth down the progression in the Decision Matrix. Thus, all thing being equal, a value of +1 assigned to all Value classification hierarchy categories might practically be +6 for the practical reality subcategory, +5 for the basic respect and self-protection subcategory, and only a +1 for the lower order goals subcategory.

These weightings or rankings as well as the concepts of truth and/or completeness are often based on a subjective value based on perception and perspective. In one embodiment, the communications analysis method measures the communicator's subjective values by this placements and ranking in a novel way. This provides a method for transforming subjective analysis into workable components in the Decision Matrix and related structures. The subjective values of the communicator can be determined from this structure and even compared with the subjective values of others or with potential values standards.

An aspect of the Value dimension that may be considered in one embodiment is the bias related perspective inherent in a communication. For example, winning the lottery is perceived to be positive for the winner; it might also be perceived to be negative for some losers or irrelevant (neutral) to those who do not play the lottery. In one embodiment, the communications analysis method utilizes an output table including a comparison of the Value dimension selected for one party with additional subclassification rankings below the six Decision Matrix levels (that is, a personalized list of Practical Reality, Core Personal Beliefs, Higher Order Goals, etc.). This output table provides a map for items such as motivation or the persuasion of believability in communications. This table can be expanded in the View dimension for the particular party and the View dimension of a different party for the same Value elements. This table could then be utilized to generate visual presentation, predictions, recommendations, grading valuations and even propose further new or improved communications based upon algorithms applied to the table. Thus, values in the Decision Matrix may be reflected differently based on the perspective of the communicator and how they are processed by the receiver. Values and other subjective elements of communications as well as the decision making and persuasive processes can thus be analyzed in novel ways. The tables that process these analyses are a novel way to transform those concepts into new functional hierarchical structures. The generated output can provide recommendations that change the way the idea is communicated to fit the patterns of the recipient using the Decision Matrix structure and personalized subclassifications.

Similarly, different perspectives may account for variations in the degree to which truth and completeness are viewed in the communication, such as by providing grading values and recommendations about believability. The communications word choice, order and other communication elements express or implicitly derived through algorithms and completion tables connect to these personalized decision matrix tables. These tables can reference a completion table for missing communications elements or the system's novel structure for a thesaurus for better words that say all the same communications elements with fewer words or with words that have improved process flow or persuasive effect. These tables are a measurement of subjective values, truth concepts and completeness concepts. Consequently, the Value dimension considers the communicator's bias by using Pros and Cons.

In another embodiment, “Neutral” and “Offset” categories may be added to provide still further variations in the degree to which values, such as truth and completeness are viewed in the communication. These additional fields can be used with respect to certain functions and for the presentation of certain concepts. For example, the reversal of the Practical Reality Con “cannot” is not the Practical Reality Pro “must,” but a practical reality neutral at the practical reality priority “neither required to happen nor impossible to happen.” These extra fields are omitted when not relevant to the particular use.

View Dimension

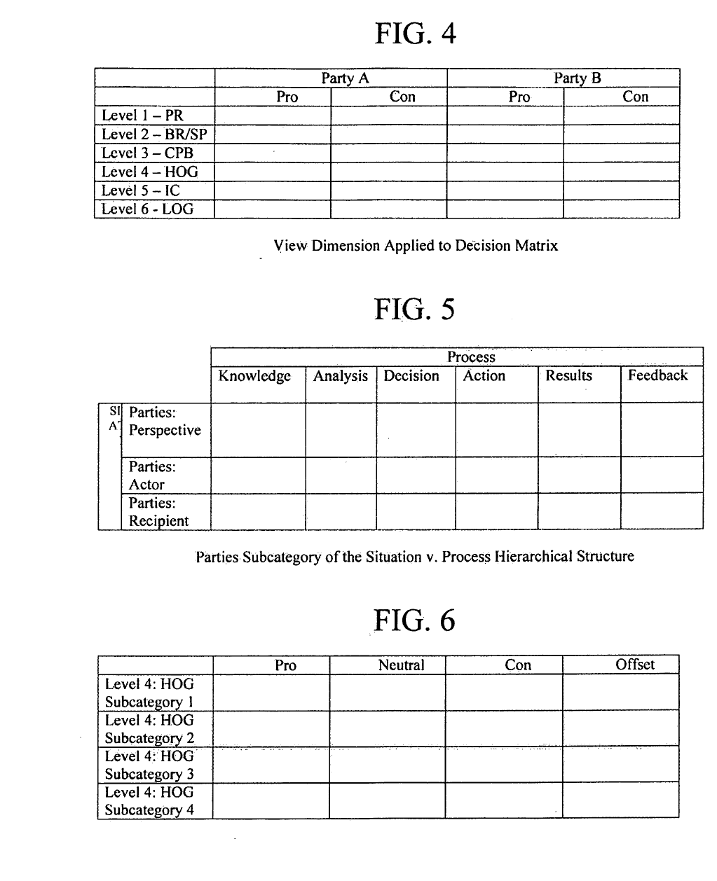

In one embodiment, one of the classification hierarchies includes the View dimension which considers the logical implications inherent in communication. The View dimension essentially captures various perspectives of the communicator and the communicatees. The View dimension uses informational comparisons, orderings, and variances to classify relative values based on perspective. A hierarchical structure array of the View dimension applied to the Decision Matrix is illustrated in FIG. 4. The View dimension could further include a number of subdivisions in the hierarchical structure, including but not limited to Grouping, Identification, Comparison/Differentiation, Relativity/Perspective, Prioritization, Evidence/Examples, Linkage and Convergence subdivisions.

In another embodiment, in addition to the four classification hierarchies previously discussed, the present communications analysis method may further include additional classification hierarchies. One such classification hierarchy would consider, in combination with the other classification hierarchies, a word's part of speech. Analysis of a word's part of speech in conjunction with other classification hierarchies allows fine tuning of the correct analysis of a word's use in a sentence or paragraph. Another such classification hierarchy would consider the order of ideas occurring in a communication. Analysis of the order in which classification hierarchy categories occur provides insight as to the coherence of the communication's flow. For example, an essay that discusses the outcome of a party's action before it discusses the facts surrounding the action may present the ideas out of order. Thus, including a classification hierarchy that tracks the order in which ideas are presented in a communication can further fine tune the analysis of the communication.

As described above, each of the classifications in the various dimensions can also have sub-classifications, wherein hierarchical structures can be generated for the sub-classifications as well in order to provide a deeper layer of understanding of the communication. For example, referring to FIG. 5, a hierarchical structure of the sub-sub-classifications of the Parties sub-classification in the Situation dimension versus the Process is illustrated. It is also contemplated that the sub-classifications can be modifiable, such that different sub-classifications can be selected for different purposes. For example, referring to FIG. 6, a hierarchical structure for the sub-classifications of the “Higher Order Goals” in the Decision Matrix is illustrated with several unnamed subcategories that can selected as appropriate for a given analysis.

The hierarchical structures described herein are populated with information placements for the words in the communication that are being parsed and analyzed. As described above, there are situations where a word will have different meanings and different information placements in the hierarchical structures depending upon the intended meaning of a word in a particular context. For example, a dictionary comprises the word ‘throw’ in at least four instances, comprising at least four distinct definitions of classification hierarchy elements. Thus, a communication may use ‘throw’ as follows: ‘throw up,’ ‘throw a party,’ ‘throw a bash,’ ‘throw a fit,’ or ‘throw a baseball.’ These uses roughly correspond to the following categories: an idiom (‘throw up’), a social event (‘throw’ plus ‘party,’ ‘bash,’ or ‘a ball’), a movement of a physical object event (‘throw a baseball’ or ‘a ball’), and behavior event (‘throw a fit’). To determine which meaning is associated with the word ‘throw,’ contextual clues are used to select the instance of ‘throw’ in the dictionary that gives the definition of classification hierarchy elements that matches the intended meaning of ‘throw’ in the communication. Accomplishing this task requires evaluation of the classification hierarchy elements of the words nearby to ‘throw.’ This novel approach selects the correct solution for multiple combinations of communications with only one database record. One record retrieves the specific communication elements for ‘throw a bash’ or ‘throw a party.’ Of course, some definitions may be very specific. If the nearby word immediately to the right is ‘up,’ regardless of ‘up's’ classification hierarchy elements, then the classification hierarchy elements of ‘throw’ associated with the act of vomiting are selected. The search would start at the deepest hierarchy level and continue up until a single match occurs. The communications analysis system and method provides a means for performing such a search.

However, the instances of ‘throw’ involving the social event, physical event, and behavioral event must be evaluated on the basis of the classification hierarchy elements of the nearby words. This principle is most evident in the social event example; as exemplified, three words, ‘party,’ ‘bash,’ or ‘a ball,’ can be used to convey the same idea, which is to have a party. Thus, rather than permute all of the possible combinations of words that can be associated with the word ‘throw’ to indicate the idea of having a party such as the words ‘party,’ ‘bash,’ ‘a ball,’ the present disclosure looks to the classification hierarchy elements of the nearby words to determine the context of ‘throw.’ Here, an embodiment could classify the words ‘party,’ ‘bash,’ and ‘ball’ as “events” in hierarchy of “situation” words further restricted by “with more than one parties. Similarly, the identification of ‘throw a baseball’ would be unique from the database because the surrounding word in the object position is a physical resource word.

As exemplified in this example, however, the word ‘ball’ when searched alone can signify both an event, a party, and a physical resource (e.g., a baseball). Hence, prior methods would have excess or multiple ambiguous results. However, the communications analysis method envisions that ‘ball’ would be first determined between a situation as a whole “event” and a physical “resource” by its prior unique search definition of surrounding communication elements, then the method would return the proper definition of “throw a ball” between the event definition and the physical object definition. Because the system derives a unique definition of ‘ball,’ the ambiguity of ‘throw’ disappears or is resolved. That is, when such an ambiguity exists, additional nearby words are examined until the ambiguity is resolved. Consequently, by using classification hierarchy elements of surrounding words, the correct instance of a word in the dictionary is selected, making the present disclosure a powerful tool by automatically or mechanically deriving the meaning intended in the communication.

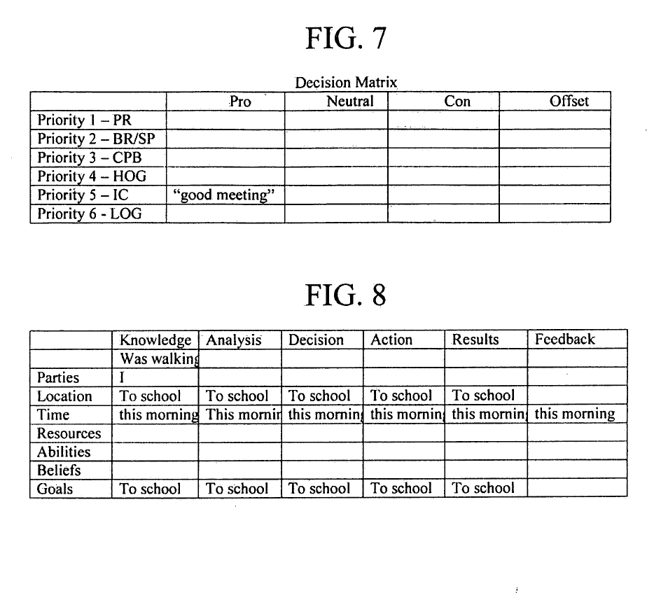

When transforming the received communication elements into the respective hierarchical structures, one embodiment of the present method utilizes guidelines that analyze the qualities of sets of words together in order to determine their proper placement in the hierarchical structures. For example, when transforming the phrase “good meeting” into the Decision Matrix hierarchical structure, the word “good” alone indicates that the item (situation and process) referenced is a Pro in the Analysis subset of the Decision Matrix. However, “good” by itself does not indicate which priority level in the Decision Matrix to place the term. The word “meeting” refers to an Interaction Commitment, thus a complete placement of the phrase “good meeting” is accomplished using the combined qualities of the words as illustrated in FIG. 7. Further, additional words might create a placement change algorithm such that, for example, the phrase “not a good meeting” has the placement of “good meeting” with the positive or negative concept reversed.

In another embodiment, the communications analysis method may employ guidelines which automatically fill in locations in the hierarchical structures unless other specific communication elements dictate that other information placements should be placed in those respective locations in the hierarchical structure. For example, information placements can be populated in the KADARF Process hierarchical structure to the right to the point decided by the clause creating the hierarchical structure. Referring to the example illustrated in FIG. 8, the phrase “I was walking to school this morning” could be transformed with the clause “to school” being populated through the Process from the Knowledge sub-classification to the Results sub-classification for various Situation sub-classifications.

An embodiment also includes completion tables or relational tables, which are able to add missing, and often necessary, classification hierarchy category information implied in a communication. The completion tables may either be stored together or separately from the dictionary database. Completion tables are implemented to supply missing information into the hierarchical structure and decision algorithm process. Missing information may include information that must populate related or connected classification hierarchy categories and may also constitute information implied in the communication. For example, in a sentence that reads “This is good,” the sentence implies a subject represented by the word ‘this.’ A completion table may be implemented to discover and populate the hierarchical structure with the word referred to by the word ‘this.’

For example, in a communication where the listener is identified as the Actor (a Situation party that performs the action), the Knowledge sentence, “It's cold outside,” can be matched in the completion table database to the following selection criteria—1) the party receiving the communication is an Actor 2) communicating a Knowledge process step 3) including a Situation ability of an energy word 4) with a value outside normal (cold, freezing, hot, etc.) and 5) the Situation location is changing (e.g., the location is different from the Knowledge step to the Results step). The completion table would then know that one sentence actually translates to three sentences with a complete Knowledge step, Analysis step and Decision step. The analysis being, “The [cold] might create a negative value to your health abilities.” The decision communications step inferred being, “[You must first or please] provide yourself protection (a positive to Basic Respect/Self-Protection) from the [cold].” The positive to Self-Protection Value dimension being the second most powerful driver of Decisions. Each of those elements occurs within the standard hierarchy of the system and can be determined from prior communications elements (or a decision making direct analysis by other means). Further, those are each one of the communication elements that are not at the word level, but at the communication more detailed elements level in the system's dictionary database and hierarchy defined in this system.

This completion in the above-described example would be insert in the missing Analysis and Decision steps in a different combination of search/selection criteria differently. If the party speaking “It is cold” is now the Actor from the communication of the other party, who had questioned, “Do you want to come out and play?,” then the completion algorithm would find a different matching completion table where the Decision step is different. The Decision step predicted by the system may be “I will not move to [outside].” Again, each component can be mapped to the combination of the various dimensions and viewed with various combination reports in this system. Both the completion table and the generated output use elements from all of the dimensions of the system in combination: process KADARF steps, situation framework criteria, negative and hierarchical Decision Matrix values. The system uses procedures that follow clear priorities and order as defined in the system to translate not just the meaning of what is communicated, but also to translate the unspoken, inferred elements of the communication.

Further, the system may even go on to make determinations including algorithms that use one or both party's personal priorities as built for previous knowledge about that party. Such knowledge can be acquired by inference from communications or by direct input or questionnaire. The system can predict the positive Decision to move to the likely or probably Action. The use of the Decision Matrix creates concrete factors used in the calculation of that likelihood, where that determination comes from the expanded Value dimension maintained for each party. This view is a database utilizing the View restricted to that party or some View grouping to which that party is a member. In such, the communications system expands to provide decision making predictions, evaluations, and recommendations and can even create further communications geared to more effective persuasion as warranted by the use of algorithms on the combination of those elements.

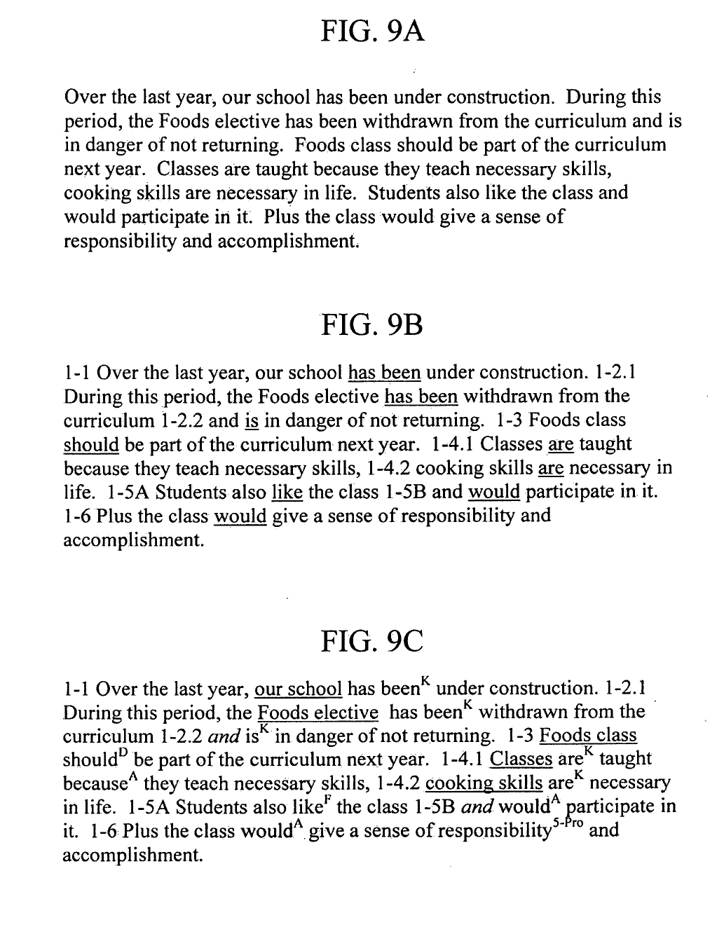

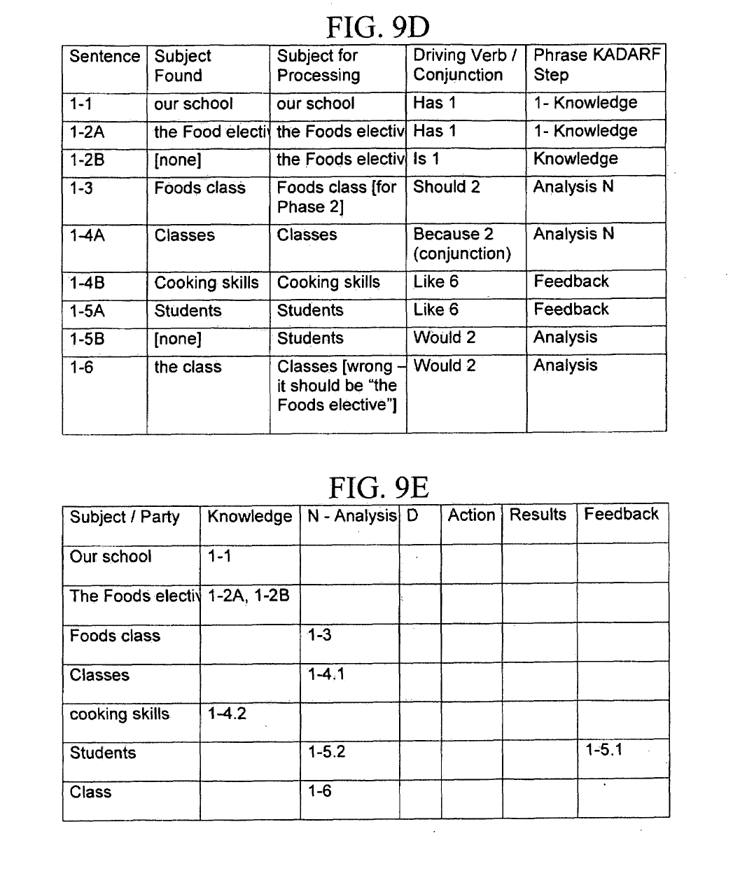

Referring now to FIGS. 9A-9E, one exemplary teaching of the present communications analysis method is set forth for the purposes of illustrating how the KADARF procedures are implemented to transform a communication into a hierarchical structure in one specific example; however, the communications analysis method is not intended to be limited solely to this example. In this exemplary embodiment, the communications analysis method performs the actions of identifying phrases in a received communication to be transformed and the respective main verb in such phrases, identifying the appropriate KADARF step, identifying the subject/party, creating an intermediate paragraph table, creating the hierarchical structure, and creating the analysis recommendations.

A sample received text communication is illustrated in FIG. 9A. The step of identifying the phrases and respective main verbs in the text communication includes a number of actions. Sentences are initially broken up by periods, conjunctions and commas. The sentences are identified by each period. At the start of each paragraph and after each period, each phrase is number sequentially by paragraph-sentence. If there is a comma or conjunction (using just Knowledge conjunctions not Analysis conjunctions), then it is determined if a verb exists (only in the simple present singular and plural and simple past format). A participle (-en with exceptions) or gerund (-ing) format is preferably not used for this determination. If there is no verb between commas, conjunctions and period, that section is determined to not be a verb phrase. If there are verbs in one or more sections of that sentence, then each section is numbered with a paragraph, sentence and section identifier, such as Para#-Sent#A, Para#-Sent#B and so on (1-1A, 1-1B and so on). These identifiers are placed just after the comma or just before the conjunction appropriately. This division is then used as the basic unit for paragraph mapping functions.

FIG. 9B illustrates how the phrases and respective main verbs would be identified for the textual paragraph of FIG. 9A with the main verbs being underlined and the identifiers labeled. In sentences 1-1 and 1-3, there are no commas or conjunctions. In sentence 1-2, the “,” after period is ignored because no main verb exists within that segment. The conjunction “and” does create another section because it includes a main verb “has” before and a main verb “is” after, which makes both sections distinct verb phrases. In sentence 1-4, the conjunction “and” does create another section because there is a main verb “are” before it and a main verb “are” after it, which makes both sections distinct verb phrases. In sentence 1-5, the conjunction “and” creates another section because there is a main verb “like” before it and a main verb “would” after it, which makes both sections distinct verb phrases. Finally, in sentence 1-6, the conjunction “and” does not create another section because there is no main verb after it before the next period, which keeps this sentence as a single verb phrase.

The KADARF driving verb or conjunction is next identified for each verb phrase. That is, analysis conjunctions override verbs for placement even though the primary hierarchical communication element of a verb might be another KADARF step. That is, “If I throw the ball, . . . ” is not an Action, it is Analysis because of the conjunction, even though ‘throw’ has an Action primary KADARF communications element in the word database. The entire placement process follows a series of steps. First, if there is an Analysis conjunction, the KADARF step is Analysis. Second, if no conjunction exists, a placement of verb first (as in the imperative case) places all the communication elements in that verb phrase (sentence) as a Decision. Third, if a Knowledge verb is found but the subject or object has a Feedback secondary communication element, the verb phrase is Feedback. Certain words, such as in “That was a stupid answer,” override the first verb for KADARF placement of the entire verb phrase. Finally, if none of those overrides are present, the first verb found provides its KADARF step as the KADARF step for this verb phrase (only in the simple present singular, plural or simple past format {a participle (/-en) or gerung (-ing) format does not count for this determination). For example, “I can run” is Knowledge by the first verb. The “can” drives the verb phrase placement based upon its KADARF step primary communication element lookup for the database. “I will run” is a Decision by the first verb “will” KADARF step Decision primary communication element lookup for the database. The final steps handle “helping words” and tenses that are complex in existing grammar programs in a novel method. It replaces those tables with one rule and database look-up into the hierarchical table used for that and other purposes.

The subject is then identified depending on a set of rules for each verb phrase. In this exemplary embodiment, this involves a three-step process of 1) identifying when specifics words come before the KADARF driving verb, 2) eliminating the Knowledge or Analysis conjunctions, 3) applying further guidelines when no words exist before the KADARF-driving verb: a) at the beginning of a sentence by filling in the Imperative [You] as the subject (e.g., “[You] Get out of the way”), b) as a second verb phrase in a sentence that uses the same subject as the previous verb phrase, and 4) modifying long subject phrases in two ways: a) pronouns follow a same-as-the-previous subject guideline, and b) same words (excluding articles like “the”) follow the same-as-the-previous subject guideline. The subject is essentially determined in two stages: 1) the subject words are segments looking at the text and 2) the subject is checked for matches already existing in the created table.

FIG. 9C illustrates how the subjects would be identified for the textual paragraph of FIG. 9A with the subject being underlined and the KADARF process verb identifiers labeled. In sentence 1-1, the “over the last year,” is ignored because it is a clause within a period, but without a KADARF driving verb. Therefore, only the “our school” before the verb is the subject. In section 1-2A, the “During this period,” is ignored because it is a clause within a period without a KADARF driving verb. Therefore, only the “our school” before the verb is the subject. In section 1-2B, the “and” is ignored because that is a Knowledge Validation conjunction and, after that, because there is no word before verb and this is a “B” clause, the subject is “the Foods elective” from the previous verb phrase. In section 1-3, “foods class” is the word before the verb and is the subject. However, the table of existing subjects already has one that says “the Foods elective,” since a word (excluding the list of articles “the”) within certain relative positions in consideration of other communications elements algorithms is the same. In section 1-4A, “classes” is the word before the verb and does not match “the Foods elective” so this is a new subject. In section 1-4B, “Cooking skills” is the word group before the verb. In section 1-5A, “Students” is the word group before the verb. In section 1-5B, because there is no word before verb and this is a “B” clause, the subject is “Students” from the previous verb phrase. In section 1-6, the “plus” is ignored because that is a Knowledge Validation conjunction and, after that, “the class” is the words before the KADARF-driving verb. However, that word class is included in a previous subject-for-processing so this joins that one and the subject is “Classes.” The information identified above from the communication of FIG. 9A would then be placed into the table illustrated in FIG. 9D.

From the table of FIG. 9D, a hierarchical structure representing the Parties subcategory of the Situation versus the Process dimensions are created with the identifying placements inserted into the hierarchical structure, as illustrated in FIG. 9E. It is understood that the hierarchical structure could alternatively be created without requiring the intermediately-formed table of FIG. 9D. Grading, commendations and recommendations can then be generated by analyzing how each verb phrase moves through the hierarchical structure.

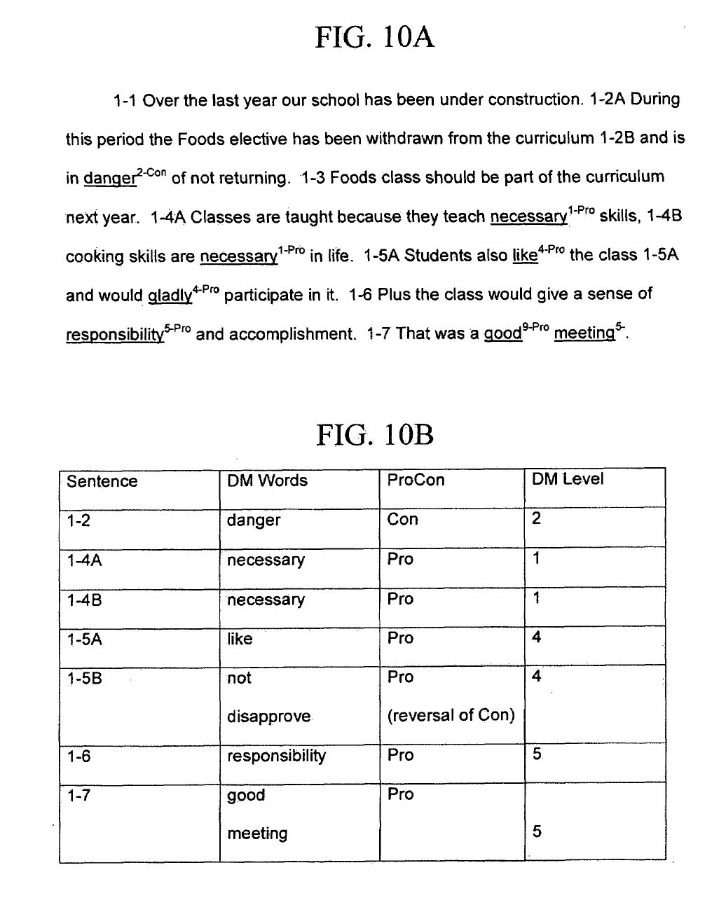

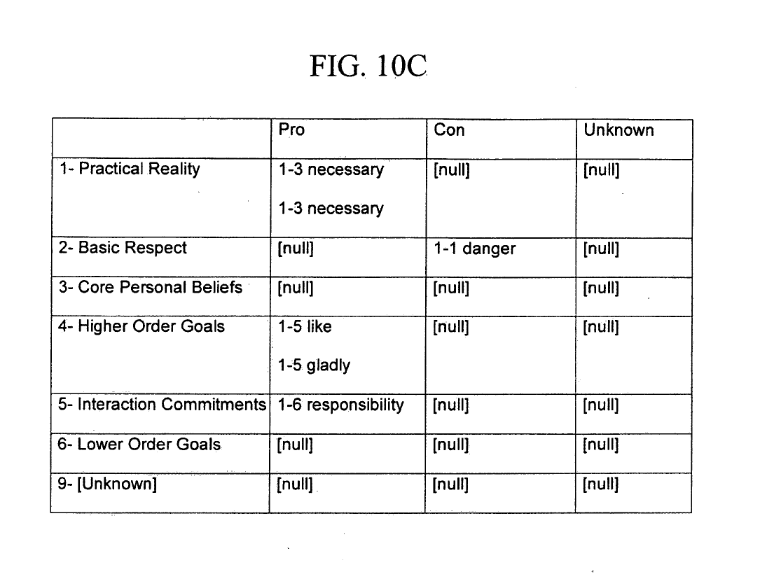

Referring now to FIGS. 10A-10C, one exemplary teaching of the present communications analysis method is set forth for the purposes of illustrating how the Decision Matrix procedures are implemented in one specific example; however, the communications analysis method is not intended to be limited in any manner to this example. The Decision Matrix shows when and how communications elements document the relative priorities that drive the real life (or fictional) related activities. The Decision Matrix is designed to show 1) the relative strength of values argued, 2) instances when the arguments are favorable or unfavorable and 3) the strength or weakness of the communications of those values and 4) the thinking process that underlies the parties (or character's) decision.

The Decision Matrix compares the goal of the motivation or conflict portion of any passage to determine:

1. Are factors clearly placed as Pros and Cons at distinct levels based upon the grid created?

2. Are the Pros higher, so that the Pros outweigh the Cons to drive the decision maker? Or are the Cons higher to describe that the situation rests in conflict at this stage?

3. If a comparison paragraph, does the communication limit the comparison to two clear levels, and is Pro or Con higher?

4. For support paragraphs, does the communication stick with all support sentences that describe the same?

5. If an Offset paragraph, does the communication go back to describe the Action and Results so that they offset properly?

6. What is the pattern, number of placements and relative positions of those placements?

7. What order does the communication use to fill in that grid?

For the sample received communication illustrated in FIG. 9A, the communication is analyzed similar to the previous example to identify the Decision Matrix classification identifiers, where the communication would be broken down to appear as shown in FIG. 10A with the Decision Matrix words being underlined. These identifications would then be converted into the table illustrated in FIG. 10B, which in turn would be converted into the Decision Matrix hierarchical structure illustrated in FIG. 10C. From the Decision Matrix hierarchical structure, grading, commendations and recommendations can then be generated by analyzing how the Pros and Cons relate to each other using the rules set forth above.

For example, if a Decision Matrix includes all Cons, a Recommendation may be output stating: “This paragraph paints a very negative picture. That might be important if fear is the motivation to action. However, if you want to show how most people think, you might consider if you can present words that also show why the Actor continues in the face of this negative.” Contrarily, by example, if a Decision Matrix includes all Pros, a Comment may be output stating: “This paragraph paints a very positive picture. While this is great for sales literature or a evidence support paragraph, the paragraph lacks any conflict. If this is a narrative, then most people move forward with decision based upon a balancing of Pros and Cons.”

The Decision Matrix provides a review of the values from the perspective of the writer's chosen party within each paragraph and for passages overall. The words people use describe the level of importance which they apply to each item and a positive/negative connotation. The communications analysis method derives this information from the dictionary database. For a Decision Matrix analysis in one embodiment, only the Value ‘communication elements’ are extracted from the dictionary database and placed into a new table for the segment of communication (e.g., a paragraph. The retrieved communication elements plus the algorithms and completion tables described herein are used to handle issues such as double negatives or phrases like “not a bad idea.”

Decision Matrix Output Patterns

### EXAMPLE 1

A superior Analysis paragraph would describe the conflict, and it would have one placement at each of two levels. For example, the paragraph:

“I am tired. I cannot go out tonight even though I want to.”

would have placements as shown in the following table:

| | | | |
|---|---|---|---|
| Pro | Con | Offset | Unknown |

| | | |
|---|---|---|
| Practical Reality | | 1.1 cannot |
| Basic Respect - | | |
| Self-Protection | | |
| Core Personal | | |
| Beliefs | | |
| Higher Order | | |
| Goals | | |
| Interaction | | |
| Commitments | | |
| Lower Order | 1.4 want to | |
| Goals | | |
| Unknown | | |

A paragraph with those only those two Decision Matrix communication elements creates a clear communication of the party's analysis and decision.

### EXAMPLE 2

A superior Support paragraph would have a series of placements from each verb phrase in the same location. For example, the paragraph:

“1 Protecting the environment is important. 2A It saves lives and 2B conserves resouces.”

would have placements as shown in the following table:

| | | | |
|---|---|---|---|
| Pro | Con | Offset | Unknown |

| | |
|---|---|
| Practical Reality | |
| Basic Respect - | 1 protecting |
| Self-Protection | 2A saves |
| | 2B conserves |
| Core Personal | |
| Beliefs | |
| Higher Order | |
| Goals | |
| Interaction | |
| Commitments | |
| Lower Order | |
| Goals | |
| Unknown | |

### EXAMPLE 3

Paragraphs that mix Analysis and Support paragraphs together can be improved by division into two paragraphs, one with the decision issues and the other with only the deciding factors and support. For example, the paragraph:

“1 I plan to vote against the new River Dam. 2 The plan protects the environment. 3 It saves energy. 4 It also stops the damage of flooding. 5 However, we do not have the money.”

would have placements as shown in the following table:

| | | | |
|---|---|---|---|
| Pro | Con | Offset | Unknown |

| | | |
|---|---|---|
| Practical Reality | | 5 do not have |
| | | the money |
| Basic Respect - | 2 protects | |
| Self-Protection | 3 saves | |
| | 4 stops the | |
| | damage | |
| Core Personal | | |
| Beliefs | | |
| Higher Order | | |
| Goals | | |
| Interaction | | |
| Commitments | | |
| Lower Order | | |
| Goals | | |
| Unknown | | 1 against |

The paragraph forming the above table would be acceptable, but not superior by the system grading. It succeeds for focus because the table only shows a group of Pros of the same type next to each other. The clear comparison is the limit of only one Pro level and one Con level. The evidence is multiple items in the paragraph in the same placement; that is, on the same Pro/Con side and priority level. However, the paragraph can be improved, because it is more difficult to understand due to the mixing of those two procedures and their order. The reader feels the weight of the evidence, but the conclusion is elsewhere. The set of evidence is on the lower weighted item. Therefore, the writer presented a decision for a Con at Practical reality, but presented evidence for the opposite Pro at the Basic Respect level. The communication would be better written by splitting the paragraph into one paragraph for evidence and one paragraph for comparison, possible with wording so the evidence matched the item the final comparison presents at the higher priority.

Further, if the decision is based upon the Con, the evidence is about a different level. The evidence does not support the decision as documented by the system from the communication. The system would recommend that support for items not at the higher, decision-driving level seems inappropriate. If the decision is negative, one example of a Pro is probably sufficient.

Further, the method also identifies that the Con might have an Offset that would also change the underlying decision. The Offset would balance the top level that drove the decision.

Finally, the method would also identify that the flow was from bottom to top. The decision driving communication element was the last item. This creates suspense. The method would summarize all the decision path choices for a document and determine if the suspense pattern was used more than standard levels.

From the above principles, the patterns of words placed into the Decision Matrix can be analyzed to generate respective commendations, comments or recommendations. In one embodiment, a 3×2×2 matrix representing 12 possible scenarios of patterns for commendations, comments or recommendations can be summarized as follows:

| Levels | Placements | 1 Side Only Used | Both Sides Used |
|---|---|---|---|
| 1 Level | 1 Placement | Scenario.1.- | Scenario.11.- |
| | | Commendation | Commendation |
| Only | >1 | Scenario.2.- | Scenario.3.Comment |
| | Placement | Commendation | |
| 2 | 1 Placement | Scenario.11.- | Scenario.4.- |
| | | Commendation | Commendation |
| Levels | >1 | Scenario.12.Comment | Scenario.5.Comment |
| Only | Placement | | |
| >2 | 1 Placement | Scenario.6.Comment | Scenario.8.- |
| | | | Recommendation |
| Levels | >1 | Scenario.7.Comment | Scenario.9.- |
| | Placement | | Recommendation |

The pattern analysis performed in the Decision Matrix should not be limited to the pattern recognition scenarios set forth in the above table, where it is understood that the Decision Matrix can be utilized to recognize any number of possible scenarios depending upon the particular classifications utilized for the Decision Matrix.

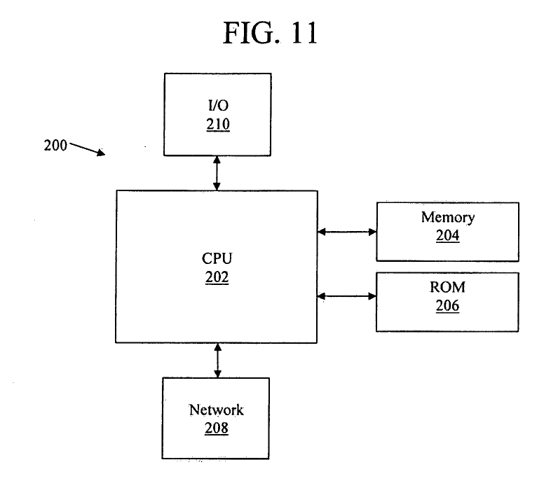

Referring now FIG. 11, an illustration of a general-purpose computer system 200 is provided which is suitable for implementing communications analysis in accordance with the present disclosure. The computer system 200 is only one example of a suitable computing environment and is not intended to suggest any limitation as to the scope of use or functionality of the invention. Neither should the computer system 200 be interpreted as having any dependency or requirement relating to any one or combination of components illustrated in the exemplary computer system 200.

In various embodiments, the present system and method for analyzing communications is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices; and the like.

The present system and method for analyzing communications may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. In one embodiment, the computer system 100 implements communications analysis by executing one or more computer programs. The computer programs are stored in a memory medium or storage medium such as the memory 204 and/or ROM 206, or they may be provided to the CPU 202 through the network 208 or I/O bus 210.

The computer system 200 includes at least one central processing unit (CPU) or processor 202. The CPU 202 is coupled to a memory 204 and a read-only memory (ROM) 206. The memory 204 is representative of various types of possible memory: for example, hard disk storage, floppy disk storage, removable disk storage, or random access memory (RAM). As shown in FIG. 11, typically the memory 204 permits two-way access: it is readable and writable. The ROM 206 is typically readable only. The memory 204 and/or ROM 206 may store instructions and/or data which implement all or part of the communications analysis system and method described in detail below, and the memory 204 and/or ROM 206 may be utilized to install the instructions and/or data.

The computer system 200 may further include a variety of additional computer readable media. Computer readable media can be any available media that can be accessed by the computer system 200 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system 200. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media.

The CPU 202 may be coupled to a network 208, such as a local area network (LAN), wide area network (WAN), or the Internet. The CPU 202 may acquire instructions and/or data for implementing communications analysis transformation over the network 208. Through an input/output bus 210, the CPU 202 may also coupled to one or more input/output devices that may include, but are not limited to, data storage devices, video monitors or other displays, track balls, mice, keyboards, microphones, touch-sensitive displays, magnetic or paper tape readers, tablets, styluses, voice recognizers, handwriting recognizers, printers, plotters, scanners, satellite dishes and any other devices for input and/or output. The CPU 202 may acquire communications, instructions and/or data for implementing communications analysis through the input/output bus 210. It is further understood that the present method for analyzing communications may alternatively be implemented using non-computer-related methods and systems.

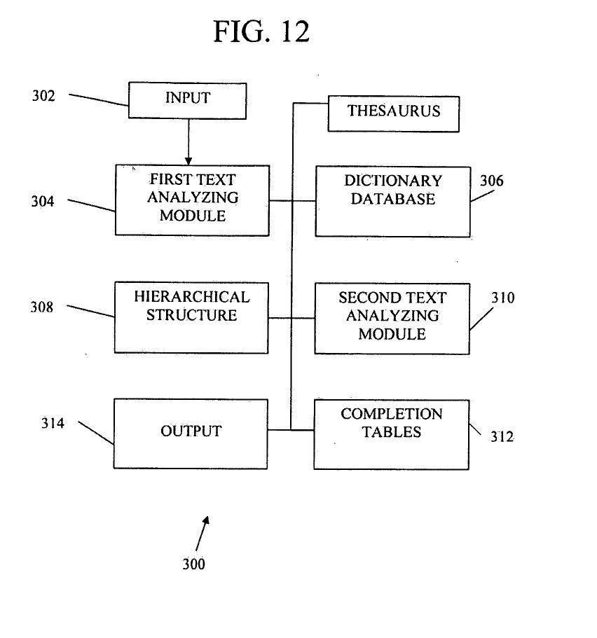

Referring now to FIG. 12, a block diagram of a system 300 for analyzing communications is illustrated. In one embodiment, the components of FIG. 12 are located within a personal computer system, such as the computer system 200 shown in FIG. 12. In other embodiments, the components are distributed across a distributed computing environment and connected together through network connections and protocols. For example, the components could be distributed across an intranet or the Internet. The components include program modules and data files stored on the computer system 200 for implementing the communications analysis method described herein.

The system 300 includes input communication 302 that is provided to the system 300 in machine readable form. Communications comprising digital files known to those skilled in the art are preferred. However, other communications are also contemplated by the present disclosure and the input communication 302 may further include devices for converting received communication into machine readable form, such as optical character recognition (OCR) devices, speech recognition devices and the like.

The system 300 includes a first text analyzing module 304 which parses or divides the received communication into communication elements, such as by performing natural divisions in the communication including but not limited to passage, paragraph, sentence and phrase division. Information gathered during the transformation process includes identifying the steps of the Process classification hierarchy, determining Value classification hierarchy identification, and determining View classification hierarchy identification. Information relevant to these classification hierarchy categories is often derived based on context. This information is not always able to be completely determined from the definitional information in the dictionary.

Thus, the first text analyzing module 304 also performs verb phrase division, performs subject identification and KADARF step identification or other identifications required for the particular classification hierarchies being employed. Information related to parts of speech may also be gathered by first text analyzer. Once the necessary communication element divisions and identifications have been performed, a dictionary database 306 containing classification hierarchy element is queried as previously described. When a match is determined in the dictionary database 306, the definition of a match is used to populate k-dimensional hierarchical structure 308 (or analysis array). The first text analyzing module 304 will also perform Value identification and prepare new View, Situation and/or Process identifiers for the received communication that are placed into the hierarchical structure 308. The first text analyzing module 304 will still further perform reference clause processing as previously described.

When multiple instances of the same word with different definitions occur in the dictionary database 306, first text analyzer examines the classification hierarchy elements of nearby words until it excludes all but a single instance of the word. The definition of the single instance of the word is used to populate k-dimensional analysis array. The process of matching a word in the communication with a word in the dictionary database 306 occurs for all words in the communication.

In an embodiment, an instance of a word in the dictionary may have multiple definitions within the same classification hierarchy. Consequently, classification hierarchy definitions in the dictionary may be prioritized based on the importance of a given classification hierarchy definition. Thus, an addition to using the classification hierarchy definitions to populate k-dimensional analysis array, priority information may also be included in k-dimensional analysis array as extra information with which to analyze the data in k-dimensional analysis array.

A second text analyzing module 310 is utilized to further complete entries in the hierarchical structure 308. The second text analyzing module 310 will perform perspective, actor and recipient identification for the Parties and will also fill in missing items in the hierarchical structure 308 using relationships stored in completion tables 312 that are accessed. Such information may be information inherent within a given placement within a classification hierarchy dimension of k-dimensional analysis array. For example, in an embodiment the word ‘school’ is defined as a location in the Situation classification hierarchy. However, a sentence reads “I want to go to school,” the word ‘school’ is both a Location and a Goal under the Situation classification hierarchy framework. Conversely, the sentence “There is a school” does not imply the a goal of arriving at school. The completion table used in conjunction with second text analyzer populates the Goal category in the Situation classification hierarchy dimension of k-dimensional analysis array in the first instance, but not in the second instance.

Moreover, one embodiment uses completion tables 312 to populate k-dimensional hierarchical structure 308 with information implied in the communication. For example, a sentence may read “Let's go.” The context of the surrounding words in the sentence omit clues as to the identify of the speaker, the identity of the recipient of the communication, or the intended destination. It may match the “us” to specific parties. The completion table 312, in conjunction with second text analyzing module 310, directs population of k-dimensional array based on textual clues in other parts of the communication. Thus, the combination of completion tables 312 with the second text analyzing module 310 forms a powerful tool that populates the k-dimensional hierarchical structure 308 with information based on the communication and specific instructions how to populate k-dimensional hierarchical structure 308 in completion tables based on implied elements within a communication. An embodiment expressly contemplates omitting the second text analyzing module 310 by implementing the first text analyzing module 304 with the functionality of the second text analyzing module 310 as previously described.

The second text analyzing module 310 will further identify confusing, redundant and/or conflicting terms in the hierarchical structure 308 after populating additional items using the information retrieved from the completion tables 312. After the hierarchical structure 308 has been completed by the second text analyzing module 310, the hierarchical structure 308 is stored on any of the computer storage media. The hierarchical structure 308 is then utilized to generate a desired output 314. By using information in multiple dimensions, output related to various aspects of the communication is generated. Output may be generated by examination of ratios, orders, patterns, identification of duplicated information, evaluations of linearity in the flow of the ideas presented, tone of the communication, and depth of the proper usage of terms in the communication.

As an example of this principle, a communication comprises a single paragraph describing a boy's trip to the store to buy milk. Examination of the Situation classification hierarchy versus the Process classification hierarchy provides information relevant to the organizational flow of the paragraph. In this example, if information about the boy, his errand, and his deadline to accomplish the errand are presented after a discussion of the results of his errand, then the paragraph may be deemed to be disorganized and need rewriting or receive a reduced grade. By comparing data within classification hierarchies against data from other classification hierarchies, an automated procedure can be implemented to mechanically extrapolate meanings intended in the communication, which can be used to provide useful output.

One output may be an evaluation or grading of communication skills. Evaluations may be in the form of grades and grading values, outlines and summaries, recommendations, and other useful implementations as known to those skilled in the art. Because the present disclosure essentially derives the meaning of communications, it can also revise and rewrite the text mechanically while preserving the meanings of the original communication. Because the hierarchical structure contains information relevant to the ideas communicated in the original communication, the present disclosure can essentially reverse the steps to translate the communication into another language or another form of communication. One embodiment for accomplishing a translation substitutes one dictionary for another dictionary in a different language along with various algorithms for placements and transformation to and from that language. In an embodiment, the process of populating the k-dimensional analysis array is reversed. Fidelity of translation may be improved in this embodiment using a grammar algorithm to ensure the grammar of the translation.

Another embodiment may utilize the hierarchical structure as a more “sensitive” thesaurus. Because the present disclosure captures the meaning conveyed by the communication, recommendations for synonyms and antonyms can be suggested with greater precision and/or more useful information than those from a thesaurus that strictly relies on single words alone.

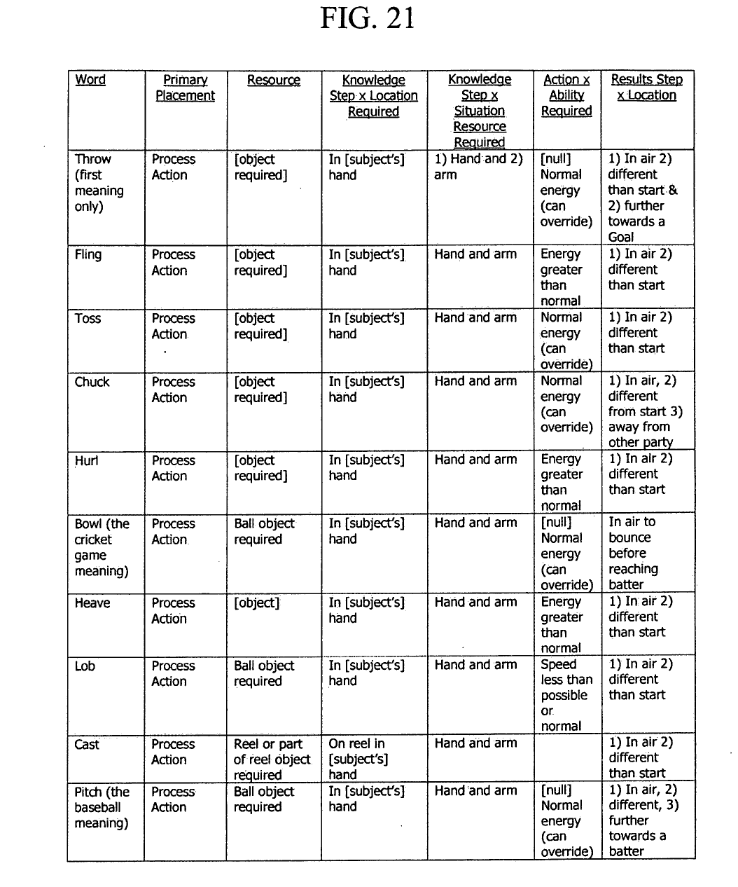

Conventional thesaurus and word search algorithms produce results that are simply a listing of words and do not have a closeness measurement. For example, a search for the first word “throw” using conventional thesaurus techniques would provide a list of words that are synonyms, such as “fling, toss, chuck, hurl, bowl, pitch, heave, lob, cast, confuse, puzzle, bewilder.” However, the dictionary database of the communications analyzer contain much more information associated with each stored word than simply a listing of other potentially synonymous words. Referring to FIG. 21, a hierarchical structure illustrating the components stored in the dictionary database for the word “throw,” for example, and for the other words in the list of synonyms is provided. The columns represent various boxes and placements of the k-dimension structure. In this example, they represent the Process Step (1-dimensional structure) or the Situation Resource×Process Results step (2-dimensional structure) or the View:Relative×Value:Positive×Process Action Step×Situation Energy (4-dimensional placement). Multi-dimensional structures having more than 2 dimensions are difficult to illustrate on a 2-dimensional picture, and are thus set forth as additional logic and words in the table box. However, the function in the boxes of the structure go beyond the words or phrases written in the boxes, such that they can further possess other functionality within the hierarchical structure.

As can be seen from the table in FIG. 21, the various definitions of the words have both similarity and difference in specific placements in the structure. The output table can be utilized by the communications analysis system to provide further user output that can prioritize those differences. For instance, the similarities and differences could be summarized as:

| Word | Elements (similarities/differences) |
|---|---|
| throw | 7 elements |
| toss | 7 matching elements, 0 extra |
| fling | 7 matching elements, 1 extra |
| chuck | 7 matching elements, 1 extra |
| hurl | 7 matching elements, 1 extra |
| heave | 7 matching elements, 1 extra |
| lob | 7 matching elements, 1 extra |
| bowl | 7 matching elements, 2 extra |
| pitch | 7 matching elements, 2 extra |
| cast | 7 matching elements, 3 extra |

One prior method to address closeness was adopted by George A. Miller and Christiane Fellbaum of Princeton's Cognitive Science Laboratory, which created a lexical database for the English language. The lexicon is a hierarchical database that has only one placement per word. By way of example, the word “cheat” in such a lexical database is a member of the subset of “wrong” which is a member of the subset of “interact” which is a subset of “act.” Thus, the word “act” is three steps away from the word “cheat” in the lexical database, whereupon a word in the “interact” subset, such as the word “meet,” would also be three steps away. The Princeton method presumes that all words create one specific meaning. The Princeton method differs substantially from the present disclosure in which various embodiments herein presume that all words are the combination of various elements. Embodiments in the present disclosure can measure words in terms of the closeness of various elements of the word that the Princeton method cannot measure.

For example, when assessing two student essays, the choice of words in the two different essay may yield different measurements. One essay might include the phrase, “he cheats his customers,” while another might include the phrase, “he failed to act very professionally.” Using the single-placement technique of the Princeton method, one would find “cheat” which is closely related to “swindle,” “bamboozle,” etc. The word “act” is six levels higher as the most general word relating thereto. The Princeton lexicon further shows the word “professional” in the subset of “adult” which is a subset of “human” and shows the word “fail” is also 3 steps from “act.” As such, the “fail to act professionally” would be at best three (3) steps away from “cheat” in the Princeton lexicon and the only connection would be they are both Actions.

Contrarily, in one of embodiment of the present disclosure, the word “professional” would have at least two elements—human and a value Basic Respect as a Pro—along with other elements about abilities/skills. The word “act” is about Action. “Cheat” would have multiple elements including Action and a Con to Basic Respect. In these senses, these two words would possess similarities, with both including an element about the same element Basic Respect. The analysis would also find that both words are about Actions of the same subject. The two verb phrases have two exact matches. The complete phrases look very similar as a complete placement using the multiple-placement format in one aspect of this invention. While the Princeton lexicon would identify the two sentences as not very closely related, the present embodiment of this disclosure would identify and provide grading and recommendations that would match these same two sentences as being closely related. Further, the present system would identify the elements of meaning with the words that create that closeness. Thus, the present system would lead to more robust solutions than the prior systems, such as the Princeton lexicon.

As such, the use of matching elements from within words in a hierarchy provides the invention with a unique method to identify passages that have corresponding plot flow, persuasive flow, logical flow, etc. Two passages written with different words can be identified as being similar using the multiple-placement element matching and closeness measures of the present disclosure. Furthermore, when this added functionality is linked to other aspects of the essay, the present system can provide even deeper understandings of the communications.

In this aspect, the present system and method provide a unique way to identify comparable portions of a passage from different writers. The essays can identify from very different words, writers and phrases to address the same issues and integrate those with other grading, recommendation and logical analysis. The system can show users how others can write differently while being built on the same elements.

Further, the communications analysis system might add a word to the list which has many matching elements but it also has conflicting elements. For instance, “fly” is an Action and ends in the air, but it will have a start location requirement “in the air” which is different than “in the hand” of “throw.” Thus, “fly” would have the following similarities and differences:

| | |
|---|---|
| fly | 6 matching elements, 3 extra, 1 conflicting element |

Alternatively, the output may include a more specific description of the different elements or more particularly by connecting elements into a concept and then concepts into words:

| | |
|---|---|
| Lob | adding the concepts “speed less than normal” |
| Cast | adding the concept “reel” |
| Pitch | adding element “toward batter” |

The concept phrase is one embodiment to show the linkage as a set or group of various elements. “Less than normal” is a combination of the Logical subdivision Relative and the Value Negative. “Speed” is an Energy Ability connected to Location Change Actions. Each of the capitalized words being members of the hierarchical structure.

By any measure, the use of the hierarchical structure in the communications analysis method and system provides more options and information regarding word relations than a conventional thesaurus. The present thesaurus capabilities capture the meaning conveyed by the communication and allow recommendations for synonyms and antonyms to be suggested with greater precision.

Output, in an embodiment, can be displayed to a user based on visual representations of information in k-dimensional hierarchical structure. Because the k-dimensional hierarchical structure is capable of storing data in greater than three dimensions, data may be represented as combinations of classification hierarchy tiers plotted against other classification hierarchy tiers. The output may be provided to an output device such as a computer screen, display, printer, email, a computer file, or other notification device or electronic storage medium as commonly known in the art.

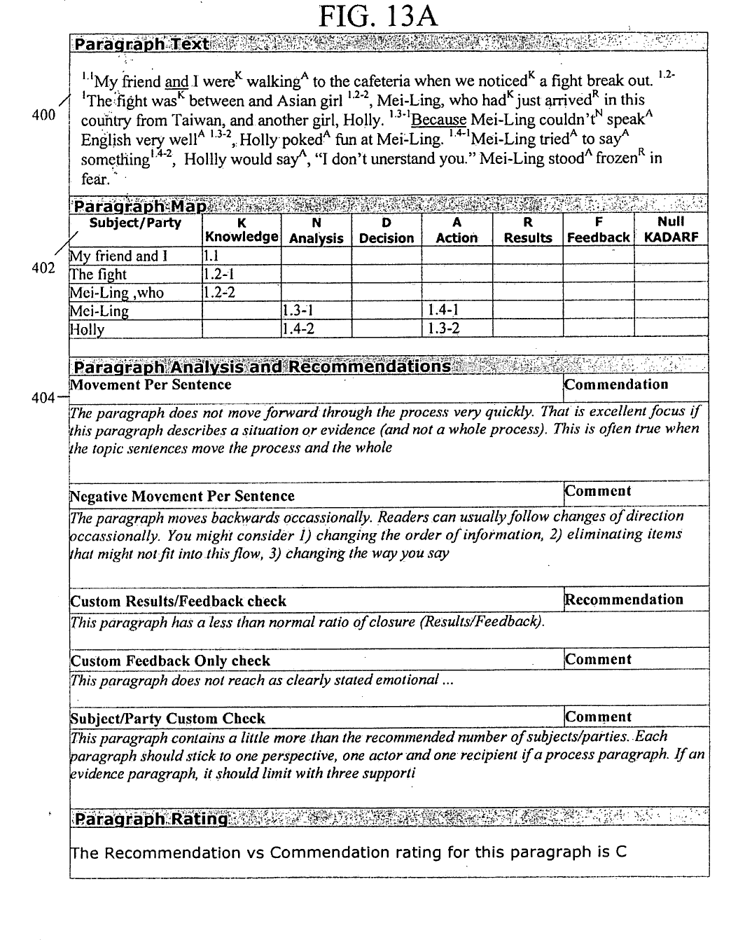

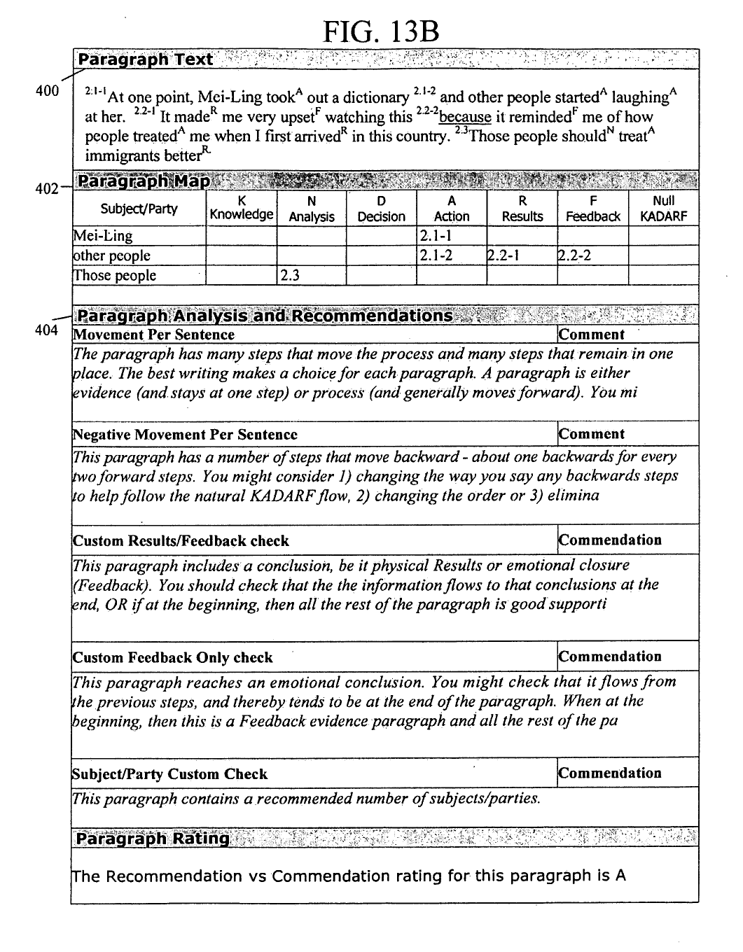

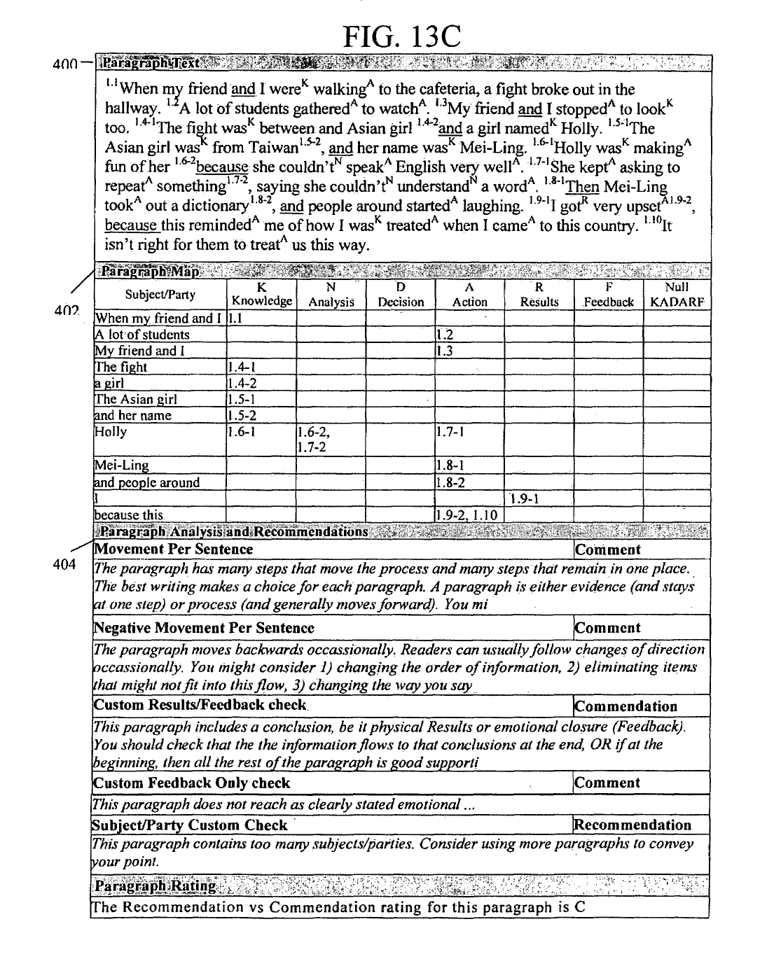

Referring now to FIGS. 13A-13C, a number of examples of output of the communications analysis performed in accordance the present disclosure are illustrated. In these example outputs, a paragraph text section 400 includes the communication being analyzed along with various identifications performed being indicated. The paragraph map 402 represents the Parties sub-classification in the Situation dimension versus the Process dimension of the hierarchical structure. The paragraph analysis and recommendations section 404 sets forth the analysis of the paragraph text using the information provided in the paragraph map 402.

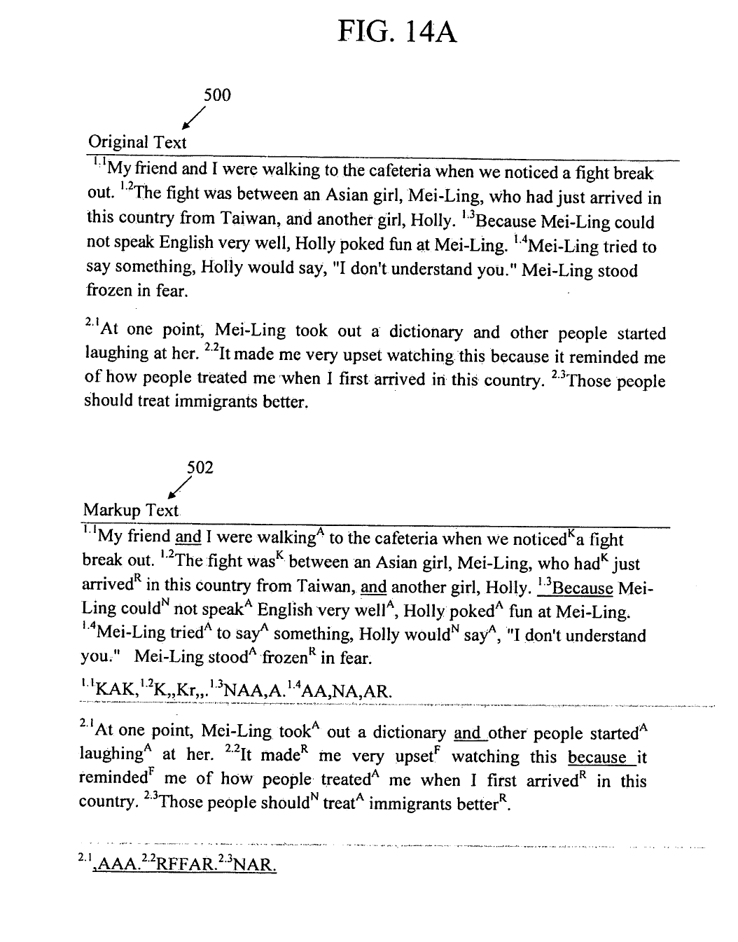

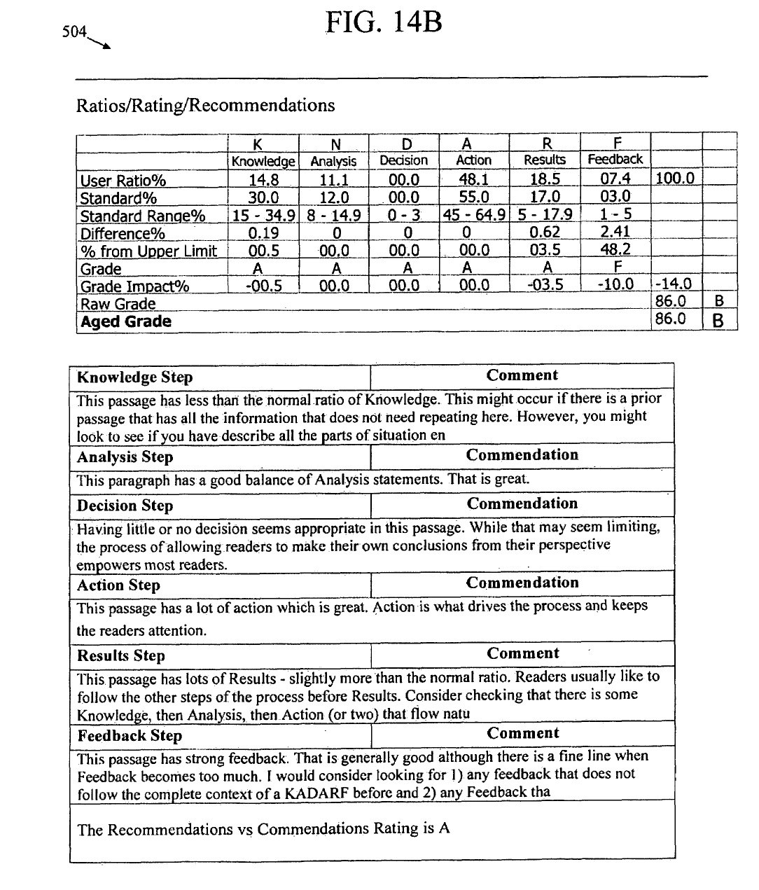

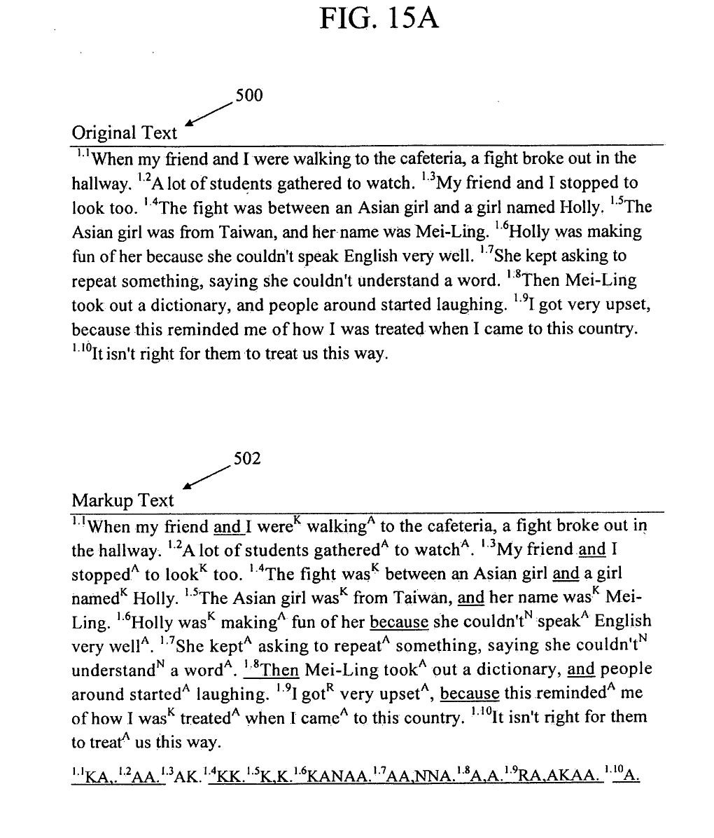

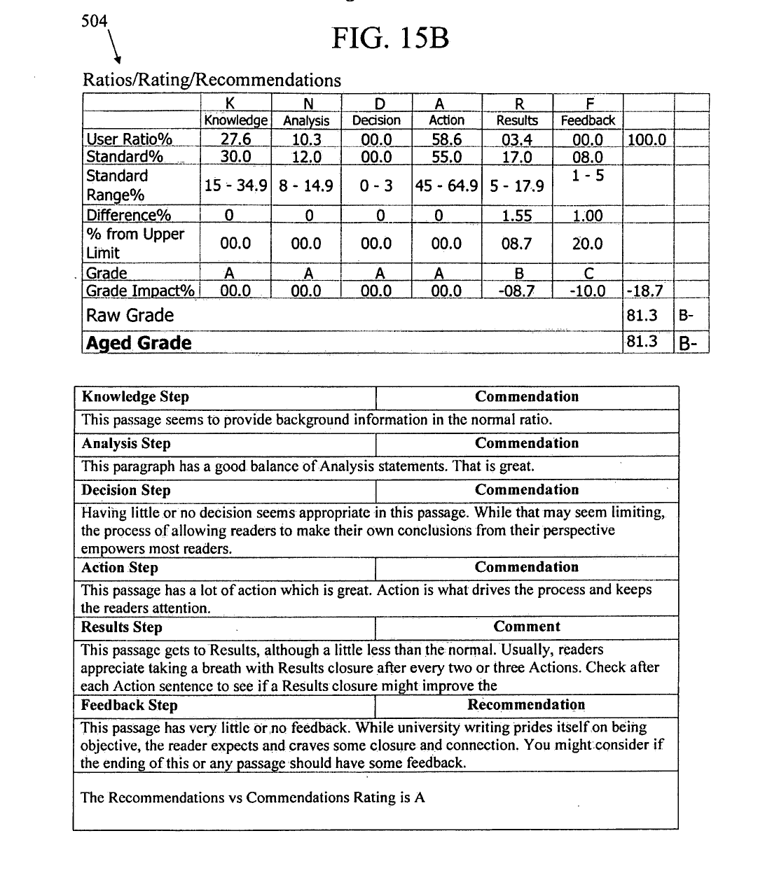

Referring now to FIGS. 14A-14B and 15A-15B, a number of examples of the output of communications analysis performed in accordance the present disclosure are illustrated. These examples illustrate the original text 500, the marked-up text 502 as broken down and identified in accordance with the text analyzing procedures described herein. The hierarchical structure section 504 represents the KADARF Process dimension of the text, where analysis of the information contained in the hierarchical structure is output there beneath.

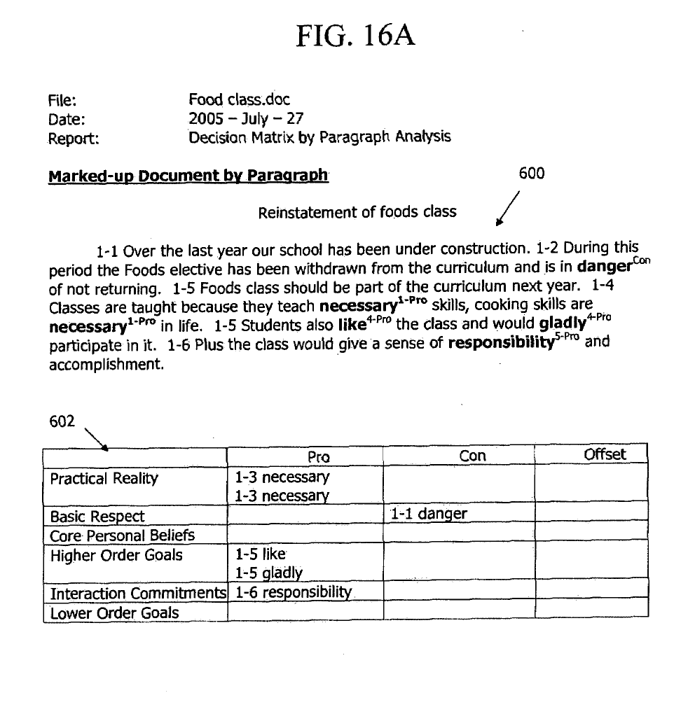

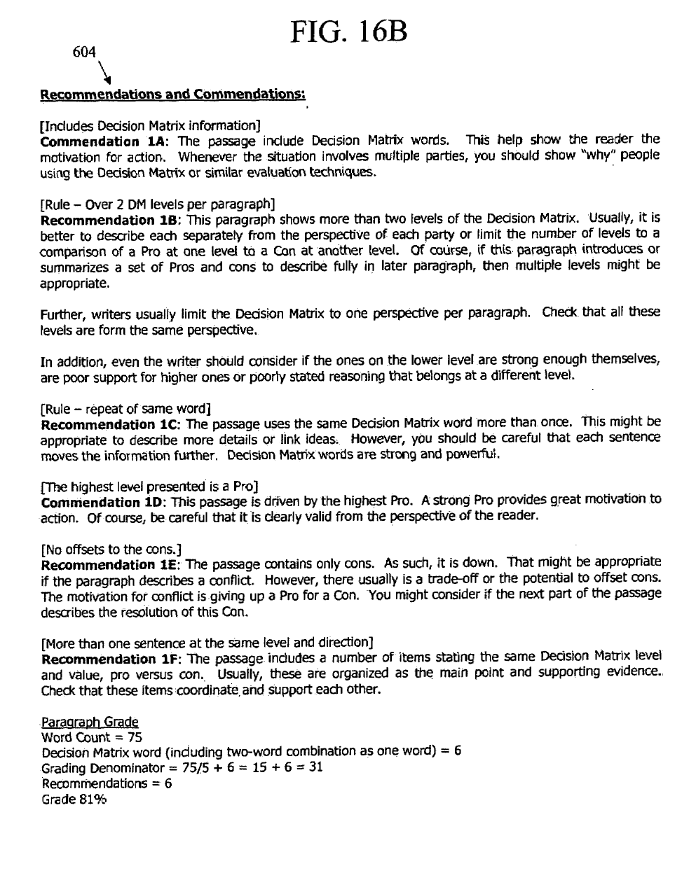

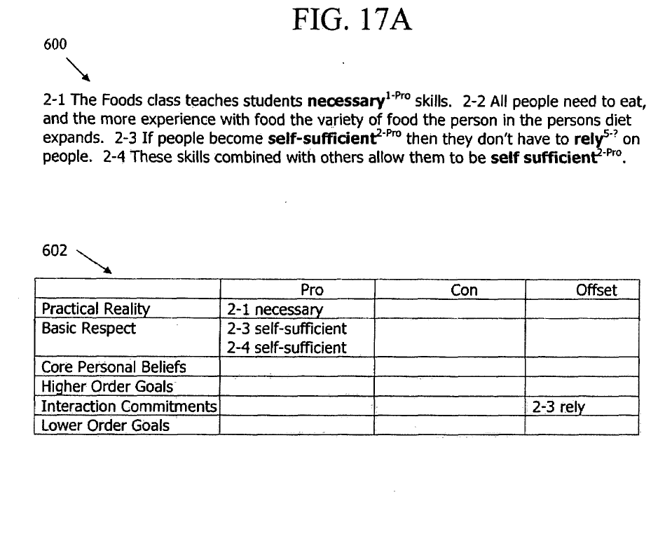

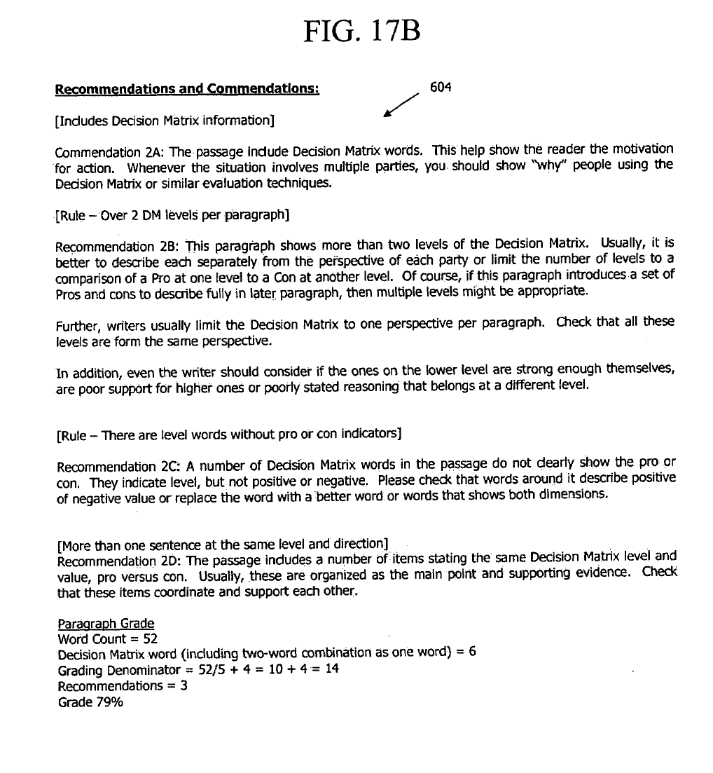

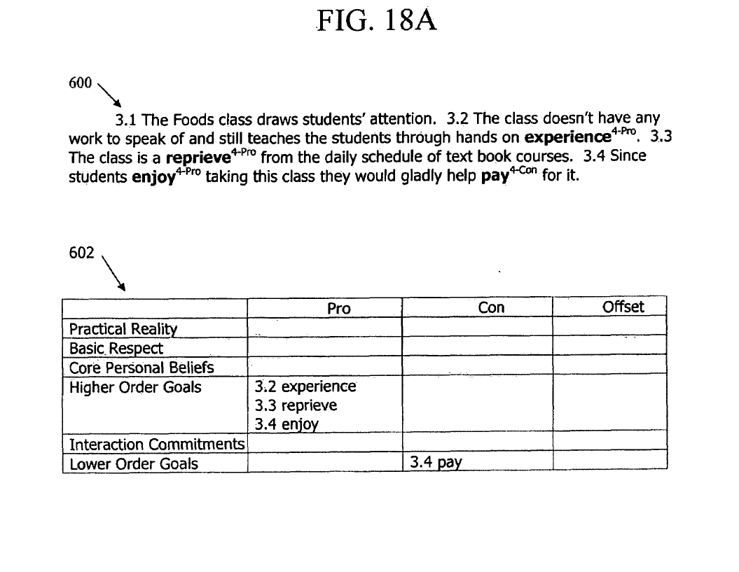

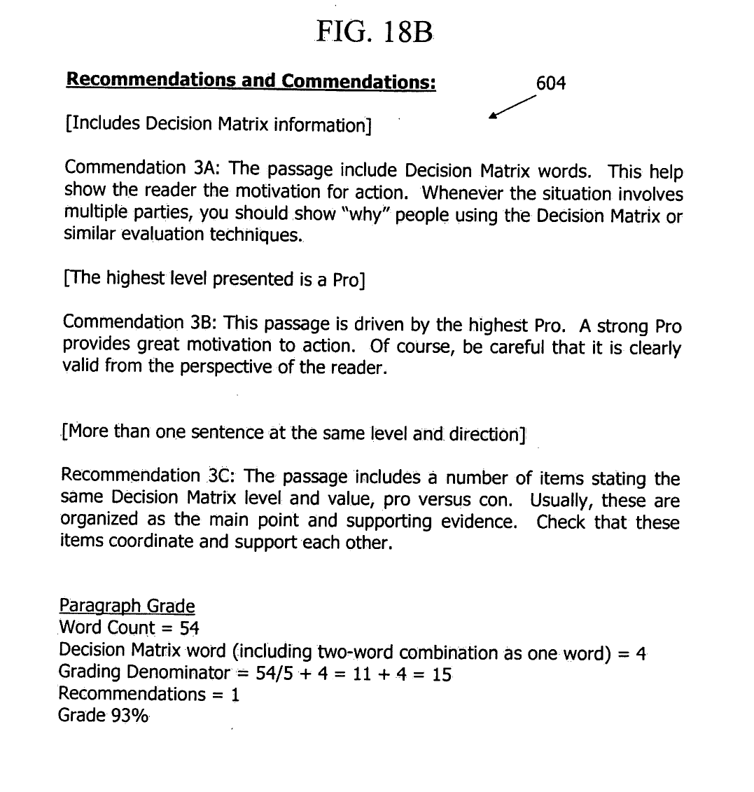

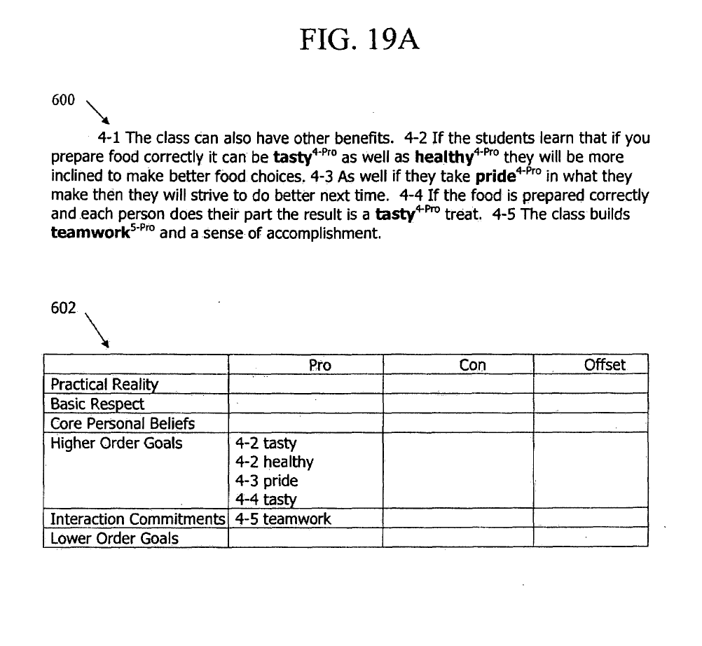

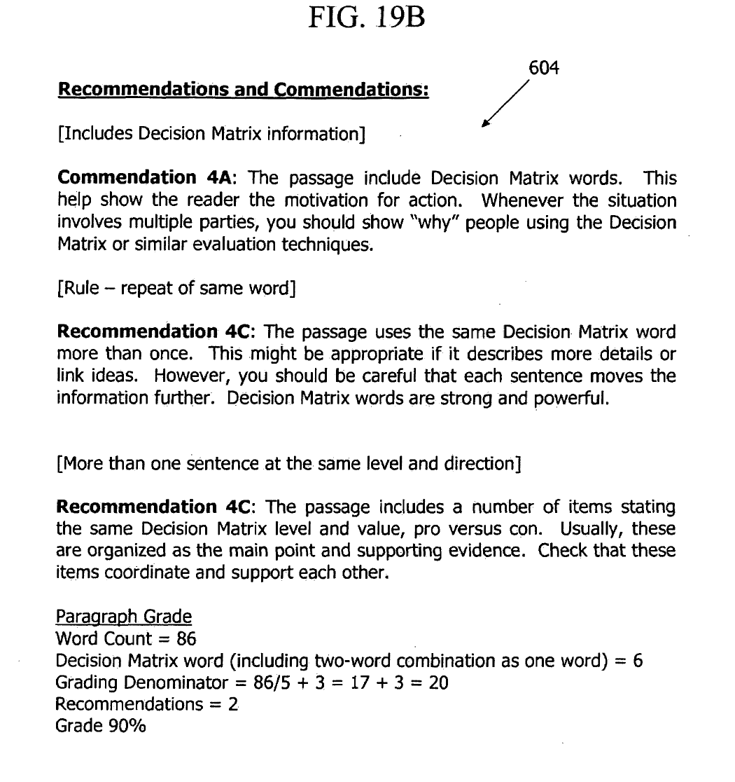

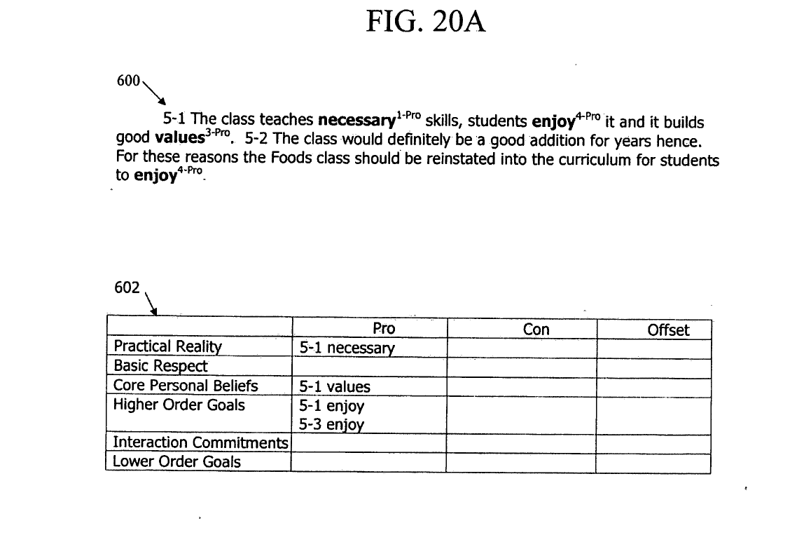

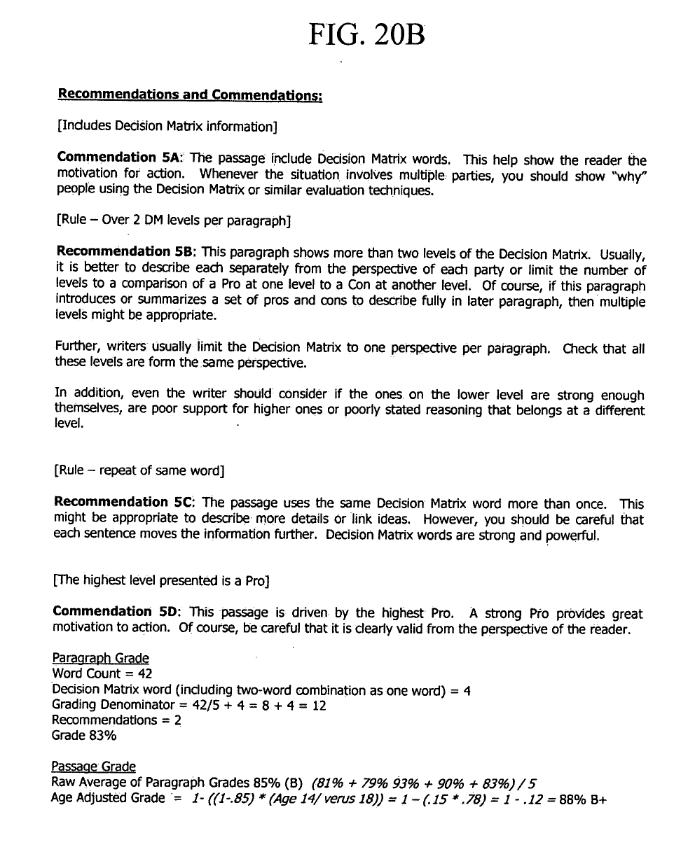

Referring now to FIGS. 16A-16B, 17A-17B, 18A-18B, 19A-19B and 20A-20B, a number of examples of the output of communications analysis performed utilizing the Decision Matrix in accordance the present disclosure are illustrated. These examples illustrate the marked-up text 600 as broken down and identified in accordance with the text analyzing procedures described herein. The hierarchical structure section 602 represents the Decision Matrix dimensions of the text, where recommendations, commendations and other analysis of the information contained in the hierarchical structure is output there beneath in section 604.

In one aspect, certain portions of the output of the communications analysis can be optionally selected by a user to reveal additional analysis of the communication. Such additional analysis may include a deeper analysis according to different levels of sub-classifications within the hierarchical structure or may otherwise include a different aspect of analysis. This enables the communication to be assessed on several different levels of the hierarchical structure that can lead to deeper levels of recommendations and grading adjustments that are not always readily visible at the broader, upper levels of the hierarchical structure.

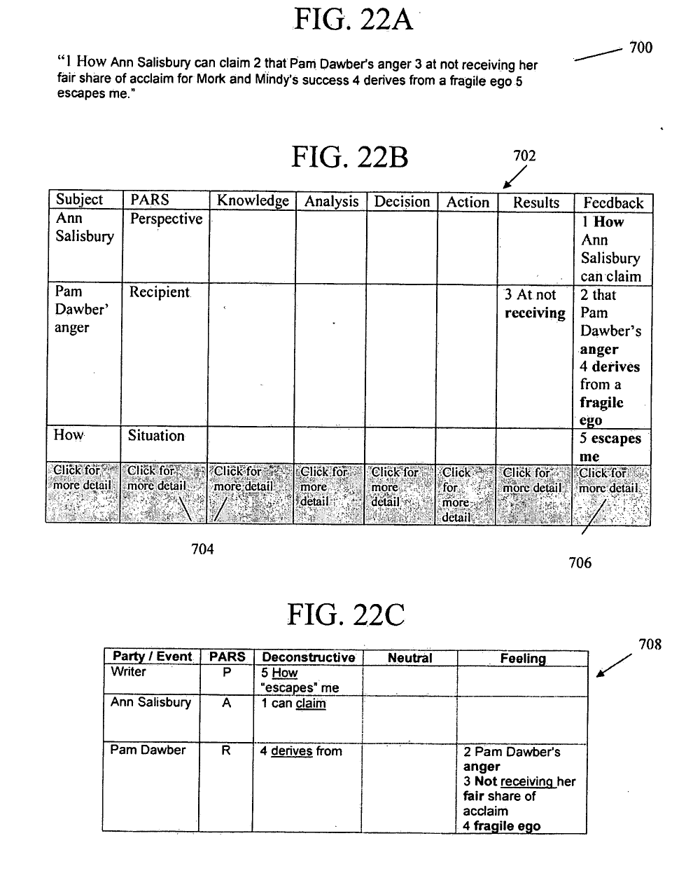

Referring to FIGS. 22A-22C, an example of an output for a communications analysis performed in accordance with one method of the present disclosure is illustrated, in which a portion of the hierarchical structure contains a reference or link to additional information regarding the analysis. This example illustrates marked-up text 700 in FIG. 22A as broken down and identified in accordance with the text analyzing procedures described herein. The hierarchical structure 702 in FIG. 22B represents the sub-classifications of the Parties classification in the Situation dimension versus the Process dimension in accordance with the present disclosure, where the PARS column in the structure 702 contains reference to either the Perspective, Recipient, Actor or Situation. In this example, the output is displayed on a computer screen or display to a user. As can be seen from the hierarchical structure 702, the majority of the placements from the text 700 are inserted into the Feedback column. The Feedback classification includes deconstructive and feeling/emotional sub-classifications, where a text passage typically should not be both. However, the hierarchical structure 702 shown in FIG. 22B does not provide a visual indication to the user regarding any information about the deconstructive and feeling/emotional sub-classifications.

The hierarchical structure 702 also includes a selectable portion 704 that contains a link or reference to additional or more detailed information regarding the analysis illustrated in the hierarchical structure 702. In one aspect, the selectable portion 704 may be activated by a user positioning a cursor over a “click for more detail” icon or other similar icon and selecting the selectable portion 704 (e.g., through use of a mouse, keyboard or other user-interactive device). After the selectable portion 704 is activated by a user, the user is provided with an output illustrating the corresponding additional or more detailed information. For example, by selecting icon 706 in the Feedback column of the hierarchical structure 702, an output such as the structure 708 illustrated in FIG. 22C would be provided to the user illustrating how the placements for the analyzed communication into the Feedback classification would be more precisely placed into the various sub-classifications for the Feedback classification, namely the Deconstructive, Neutral and Feeling sub-classifications. In this manner, more precise recommendations and grading evaluation calculations can be performed and illustrated to a user. For example, for the hierarchical structure illustrated in FIG. 22C where both Feeling and Deconstructive paths are present in the communication, a recommendation could be provided that readers do not usually follow both Feeling and Deconstructive paths and that incompatible Feedback subdivision methods may exist in the same communication passage.

By providing various outputs to a user that are based on respective levels of the hierarchical structure for the communication being analyzed, different levels of understanding of the communication can be expressed to the user and, in turn, different levels of analysis, recommendations and grading evaluations can be provided. This allows proficiency reports to be generated based upon summary placements for each classification, including sub-classifications, that provide deeper relationships, recommendation patterns and additional graphical representations of the results.

In another aspect, output reports can provide easily determinable feedback for analyzing communication by simply viewing patterns or progressions within the hierarchical structure. For instance, jumps or the lack of jumps through the hierarchical structure can provide a visual indication for analyzing the communication. This type of analysis is not possible with conventional graphic presentations of communication, such as word and grammar trees.

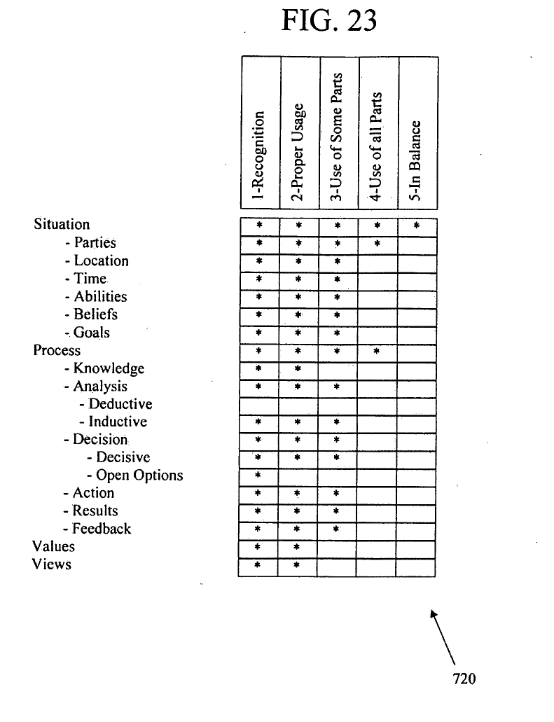

In one embodiment, the output displayed to a user can illustrate the depth of proper usage of communication elements in a communication being analyzed. Referring now to FIG. 23, an illustrative output report table 720 is shown which provides a visual representation of the depth of proper usage of communication elements in the analyzed communication as determined from placements of the communication elements in a multi-dimensional hierarchical structure. The depth of proper usage is illustrated in the various columns of the table 720 for the various classifications and sub-classifications of the dimensions of the hierarchical structure shown in the various rows of the table 720.

In one aspect, the depth of proper usage may be identified according to multiple different categories or levels of usage: 1) recognition, 2) proper usage, 3) use of some sub-classifications of a classification, 4) use of all sub-classifications of a classification, and 5) in balance. The “recognition” category identifies whether or not a particular classification or sub-classification exists in the communication. The “proper usage” category identifies whether communication elements, as placed into particular classifications or sub-classifications in the hierarchical structure, are being used properly in accordance with predefined rules (e.g., as set forth in the thesaurus, dictionary database, completion tables, etc.) or in accordance with the relationship of such placement within the hierarchical structure. The “use of some sub-classifications of a classification” category identifies whether at least one of the sub-classifications of particular classification category are represented in the hierarchical structure, while the “use of all sub-classifications of a classification” category identifies whether all of the sub-classifications of particular classification category are represented in the hierarchical structure. The “in balance” category identifies whether placements in a particular sub-classification or classification are in balance with placements in other sub-classifications or classifications in the hierarchical structure based upon desired ratios or relationships, where such desired ratios or relationships can be empirically determined from representative communications, from predetermined values or otherwise. The determination of whether or not placements are in balance can vary based upon the level of the communication being analyzed (e.g., an elementary school book report as compared to a college level thesis), where the desired ratios or relationships will vary accordingly. The determination of whether or not placements are in balance can also be instrumental in preparing commendations or recommendations for improvement.

The above-listed categories are but one example of the possible categories for determining the depth of proper usage, where it is the intention of the present inventor that the depth of proper usage can be determined or shown using any number of possible categories, including but not limited to the above-listed categories. These include comparison to standards, comparison to essays within a group, such as a particular prompt for a particular teacher and grade level or other comparative manipulations that are possible with the data so organized by the invention. In one aspect, the output presentation of the depth of proper usage using the hierarchical structures, such as shown in FIG. 23, is based upon placement of communication elements in the hierarchical structure and may include recommendations from other calculations, as described herein above. In the particular example illustrated in FIG. 23, asterisks “*” in the chart 720 indicate that a particular depth of usage has been achieved.

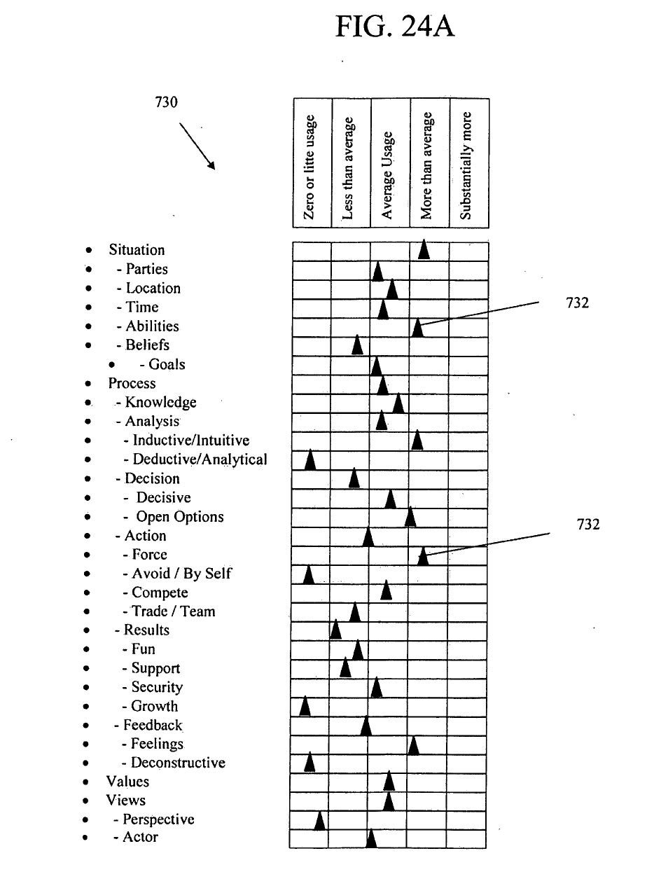

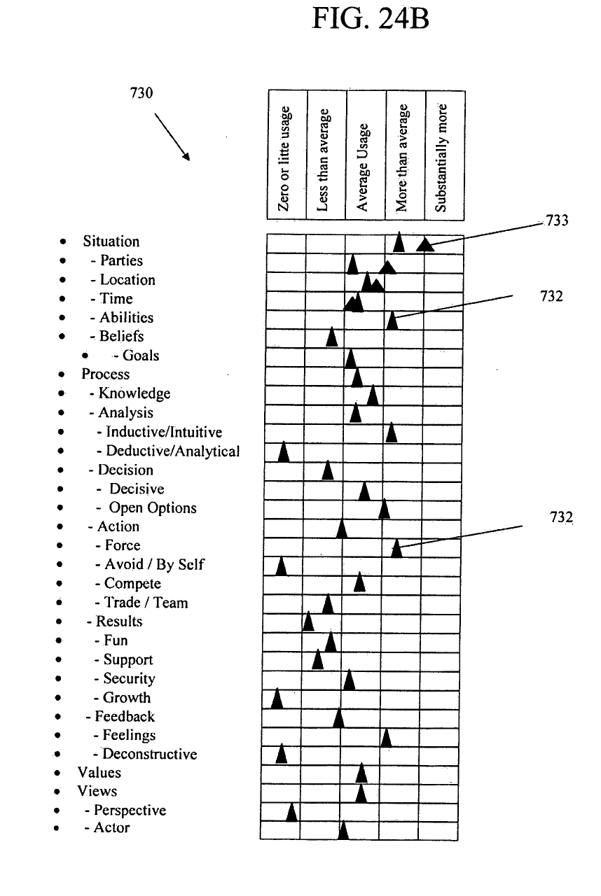

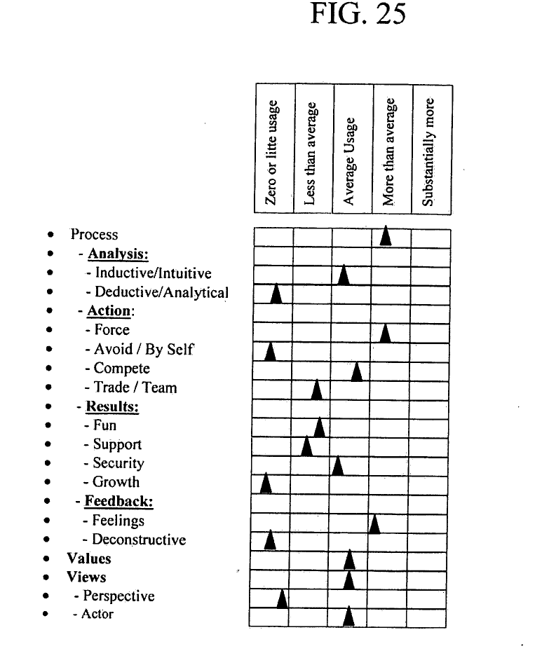

In another embodiment, the output displayed to a user can illustrate the tone of the communication being analyzed. The measurement of tone would be the selection of various elements and comparison in ratio, order, grouping and existence of different elements. For example, the tone in one embodiment might be described as 1) visual (from the ratio Knowledge step subdivisions), 2) inductive, 3) decisive, as wells a practical (from the Value Decision Matrix ratio of Practical Reality placements), where each of these can be scaled, reported, and/or graded. In one aspect, the tone of the communication can be illustrated by usage of particular communication elements as determined by 1) concepts in communication elements and/or 2) concepts by grammatical constructs. For the communication being analyzed, the tone of the communication can be determined from the hierarchical structure, such that information (e.g., character traits, etc.) is clearly linked to the hierarchical structure that has conventionally been independent of communications analysis. The tone of the communication can be presented in an illustrative output by showing the usage of particular sub-classifications or classifications (based on their placement in the hierarchical structure) as such usage relates to a desired value or ratio for such sub-classifications or classifications in the communication. The desired values or ratios can vary based upon the level of the communication being analyzed (e.g., an elementary school book report as compared to a college level thesis), where the desired values or ratios can be derived from predefined standards or can be empirically determined from other communications. One example of an output to a user that illustrates the tone of a communication is shown in the table 730 in FIG. 24A, where the markers “▴” 732 in the table 730 illustrate the degree of usage of a particular sub-classification or classification. In one aspect, the categories for the degree of usage may include: 1) zero or little usage, 2) less than average usage, 3) average usage, 4) more than average usage, and 5) substantially more than average usage. These are but a few possible categories of ratios for the degree of usage of a particular sub-classification or classification, where it is the intention of the present inventor that any number of possible categories and possible degrees of usage for such categories can be utilized, including but not limited to the above-listed categories.

In one aspect, the markers “▴” 732 in the table 730 can be interactive for a user, such that specific markers can be selected to yield additional information regarding their placement. Markers “▴” 732 appearing in “less than average” or “more than average” usage categories can have recommendations for improvement associated therewith that can be presented or output to a user if selected. In another aspect, the identification of markers “▴” 732 falling within specific categories over more than one analyzed communication can be monitored and used for additional analysis and/or recommendation. For example, referring to the illustrative example of FIG. 24A, the Deductive, Avoid/By Self, Growth and Deconstructive sub-classifications fall into the “zero or little usage” category. If that trend continues over a portfolio of communications that are analyzed, a problem in a communication style for a user can be identified and used to create specific areas for subsequent training or improvement.

In another aspect, in order to simplify the scope of the output presenting an analyzed tone to the user, charts or tables having a reduced set of sub-classifications, classifications, and/or categories can be utilized. The particular sub-classifications, classifications, and categories can be variably selected for a desired output based upon the results that are intended to be displayed. For example, referring to FIG. 25, a table 740 is illustrated having a reduced number of sub-classifications and classifications from the table 730 illustrated in the example of FIG. 24A. Such simplified tables may alternatively only present specific sub-classifications, classifications, or categories or combinations thereof to a user, as desired.

Further, the inventor has found that various combinations of these tone elements relate to more grading, evaluation and recommendation aspects. For example, for certain writing, a Feedback step tone that is Emotional does not work as well with a Kinesthetic Knowledge step tone. It is not just the relative position of each of these tone elements, but their ratio and combination sets that define appropriate paths. The Kinesthetic approach, which can grade poorly in certain narrative essays as noted above, would work superior when connected to deconstructive Feedback in instruction manual writing. Therefore, secondary markers, as illustrated by the wider marker “▴” 733 in FIG. 24B can be compared to other markers which indicate the path of the highly graded essays or multiple paths with different symbols to write various combinations that create complete tones sets ranked as more effective.

From the foregoing it can be seen that the present disclosure provides a system and method which automatically evaluates and analyzes communications by comprehending the meaning of the communications to generate feedback that usually requires subjective grading by a human reader. A system and method is provided which processes communication into a useful multi-dimensional, hierarchical structure capable of: 1) providing a visual interpretation and analysis of the communication to illustrate patterns in visual results, 2) allowing further processes to performed on the hierarchical structure to identify errors in the communication, 3) providing an analysis of the communication, such as grading of the communication and recommendations for improvement, and 4) allowing for the automated creation of a new communication in any form and in any language by performing transformations of the hierarchical structure in reverse.

According to one or more embodiments described herein, the system and method for analyzing communications can be utilized to disambiguate the meaning of an analyzed communication. As used herein, the term “disambiguate” refers to extracting meaning from at least a portion of the analyzed communication in order to reduce or even completely eliminate ambiguities with respect to the meaning of the analyzed communication. In one or more embodiments, after the words, position and grammar of the communication are analyzed to provide placements into a fixed, multi-dimensional, hierarchical structure, the hierarchical structure is analyzed to disambiguate the meaning of the communication. The disambiguated meaning of the communication can be used for a variety of possible uses, such as but not limited to analysis of the communication, generating results of the disambiguated meaning, and using the disambiguated meaning to drive additional functions and/or processes. For example, the disambiguated meaning derived from the system and method by analyzing a communication can be used in conjunction with search engine, email and/or word processing functionalities.

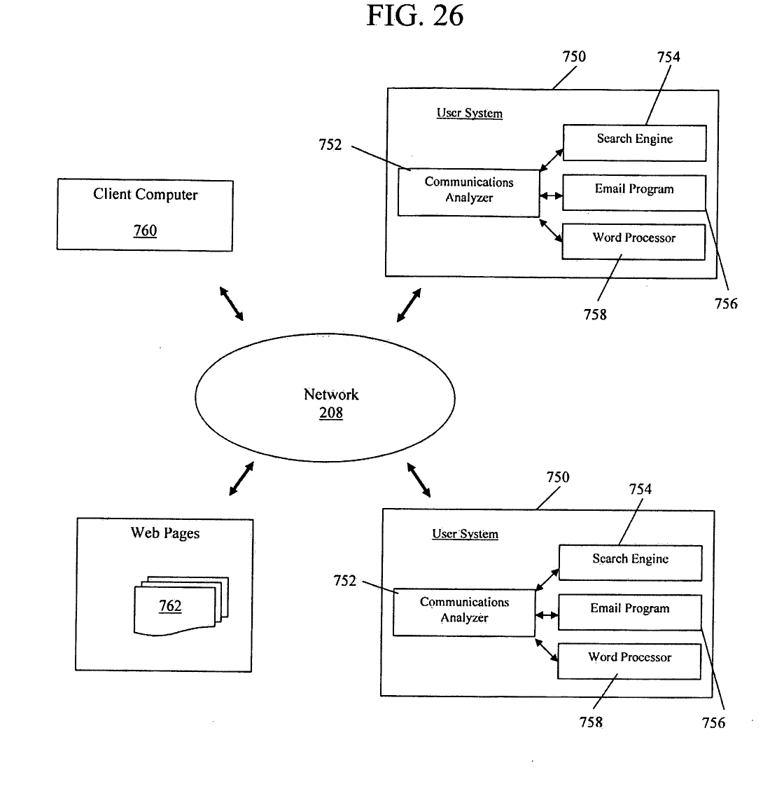

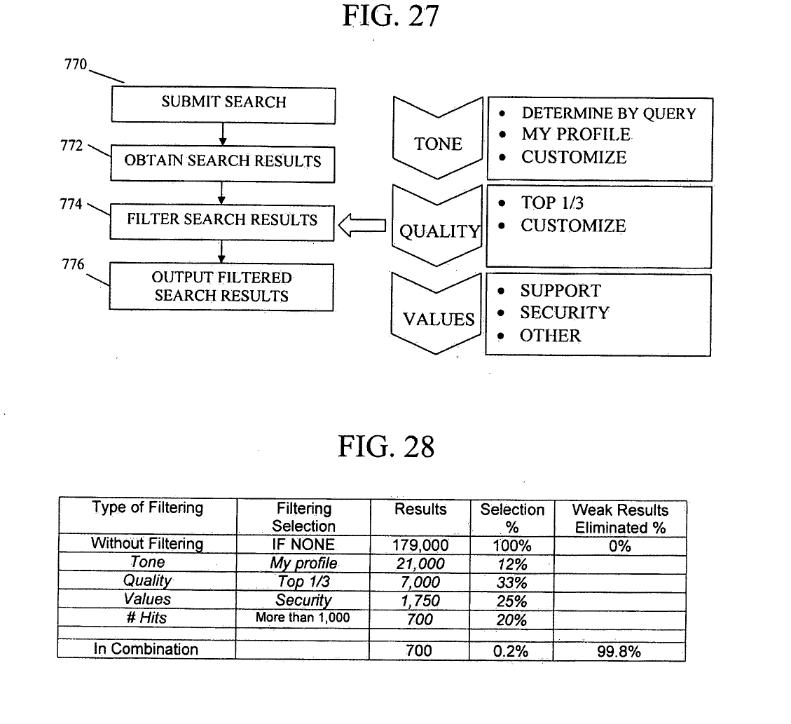

Referring now to FIG. 26, a block schematic view is provided for a system 750 for analyzing communications by disambiguating the meaning of a communication associated with a functional program also running within the system 750 or otherwise accessible by the system 750. The system 750 may comprise a computer system (such as the computer system 200 described in association with FIG. 12) or may comprise numerous other general purpose or special purpose computing system environments or configurations. The system 750 includes a communications analyzer 752 which is a software module operable for performing any of the communications analyses in connection with any of the various embodiments described herein. A plurality of possible additional software programs may also be operable on the system 750 in conjunction with the communications analyzer 752, such as but not limited to a search engine 754, an email program 756, a word processing program 758, or other functional programs. Each user system 750 may be connected directly to additional user systems 750 or may be interconnected through a network 208. The network 208 connection may include any type of wired or wireless connection. Further, the communications analyzer 752 and the various functional programs generating, receiving and sending communications may either be located within each user system 750 or may be separately located and accessed in different components connected to the network 208.

The network 208 can also be connected to other client computers 760 to access communications or other stored content or programs. The network 208 may further comprise the Internet or a connection to the Internet in order to access remotely stored web pages 762.

Search Engine Functionality

Search engines are typically used to search for data in unstructured documents stored on Internet web pages that contain information that may or may not be formatted into any predefined manner. Such documents may include disparate information loosely arranged into paragraphs, lists, tables and other layouts. Unstructured documents may include web pages (e.g., Hypertext Markup Language (HTML) pages), web logs (blogs), Portable Document. Format (PDF) documents, word processor documents, etc. In general, prior conventional keyword search engines have combed through unstructured documents and store keywords in a text index. The index record is associated with a network location and, often times, additional metadata about the document. When a user submits a keyword search, the search engine examines its records and returns the network locations of documents matching the keyword search. Some popular keyword search engines include Google® and AOL®. Google is a registered trademark of Google Incorporated and AOL is a registered trademark of AOL LLC Ltd. Liability Co. Prior conventional keyword search engines have only provided limited usefulness, because the results that are returned are ambiguated. For example, if a search term possesses multiple different meanings, then results associated with each of the multiple different meanings may be returned to a user.

In one or more embodiments, the system 750 could include search engine 754 functionality or otherwise be included within a search engine such that the either or both of the user input search request and the search results would be analyzed by the communications analyzer 752 in order to disambiguate the search results. The meaning of the search request and/or the search results can in this manner be disambiguated in order to provide more effective, efficient and useful searches. Referring now to FIG. 26, an operational flow diagram of a method for disambiguating search results is illustrated in accordance with one or more embodiments.

Initially, in step 770, a user inputs a search request in connection with the search engine 754. Search results are then obtained in step 772 using known search engine techniques and/or search engine functionality. The search results may then be filtered in step 774 by disambiguating the meaning of the search results using the communications analyzer 752 and optionally using other filtering techniques to reduce the number of search results to those having a certain meaning that will be more useful to the user requesting such search results. The filtered search results are then output in step 776, such as by displaying the search results on the user's screen.

In this manner of searching Internet web sites, the particular search results that are returned to the user submitting a search request can be analyzed to disambiguate the meaning of the search results. The search results could then be filtered or otherwise selected to be presented to a user making the search request based upon certain selectable characteristics. For instance, in one or more embodiments, a profile associated the user (e.g., communicator attributes, preferences, etc. as will be described in greater detail below) can be used to eliminate search results that do not possess a desired degree of similarity to the user's profile. In this manner, for instance, only those search results having a tone that match the preferred tone of the user are returned. In one or more embodiments, the attributes and meaning of the search request can be analyzed and used as filtering criteria, such that search results that do not possess a desired degree of similarity to the attributes and meaning of the search request can be eliminated. In one or more embodiments, the quality of the search results can be used as filtering criteria, such that either a predefined or a selectable percentage of the search results are selected (e.g., only the top ⅓ of the filtered search results are output to the user). In one or more embodiments, various attributes and/or meaning of a communication that fall within one of the classification or sub-classification hierarchies can be used as filtering criteria. For instance, a user could request that only search results corresponding to certain Values (e.g., possessing a certain Support or Security) will be returned to the user. In one or more embodiments, conventional search engine filtering techniques can be used in conjunction with any one of the various filtering techniques described herein to further filter the search results.

The communications analyzer 752 thus operates in conjunction with the search engine 754 to eliminate ambiguity in the search results by extracting meaning from the search results in an automated manner. Further, by analyzing the search results (i.e., communications) by placing the elements of communicated search results into hierarchical structure, search results that are missing certain meaning can be eliminated. That is, the present system and method identify and eliminate ambiguity in the search results. The present system and method can further identify and eliminate ambiguity in the search request. If the search request is analyzed by the communications analyzer 752 and determining to be ambiguous in any manner (e.g., the search request is missing the Location dimension), the user can be prompted by the system 750 to specify that dimension or certain default criteria can be used in order to disambiguate the search request. Because all search requests and search results can be placed into the fixed hierarchical structure described herein, the search results can always be disambiguated.

Referring now to FIG. 28, an exemplary table is illustrated showing the drastic reduction in search results that can be provided by the present system and method in order to provide more effective, efficient and useful search results to a user. In this representative example, if conventional search engine techniques are employed without any special filter, then a large number of ambiguous search results would be returned to the user (e.g., 179,000 results) that the user would need to examine to determine the most relevant results. These search results could then be filtered by the communications analyzer 752 and the search engine 754 based on the user's stored profile (e.g., only those search results analyzed to have a matching tone to the user's stored profile). These filtered results could be further filtered by selecting the best quality search results that match the user's selected profile criteria (e.g., the top ⅓ of those results matching the user's preferred tone). The search results could then be filtered even further to only those search results having a certain meaning falling within one or more of the classification or sub-classification hierarchies (e.g., used as filtering criteria. For instance, a user could request that only search results corresponding to certain Values (e.g., possessing a certain Support or Security) such that only results determined to possess those same Values would be returned to the user. From this particular example, it can be seen that only those specific disambiguated search results that fall within the filtering criteria are delivered to the user, thereby eliminating the majority of the ambiguous results that a user would typically need to sort through (e.g., 99.8% of the ambiguous search results are eliminated in this example). In this manner, only those search results that match criteria such as the attributes and meaning of the search request or the preferences of the user are returned to the user, such that only meaningful search results are returned to the user.

Email Functionality

In one or more embodiments, the system 750 could include the functionality of an email program 756 or the communications analyzer 752 could otherwise be included within or connected to an email program 756 such that the emails received and/or sent by the email program would be the communications analyzed by the communications analyzer 752 in order to disambiguate the communicated emails. When an email is going to be sent by a user to an intended recipient, the communications analyzer 752 can analyze the email before it is sent to ensure that it complies with certain criteria, such as the intended recipient's preferences as determined from their profile, the level of similarity between the attributes of the email to be sent and any analyzed emails that have previously been received, or some predetermined standards or attributes for communications.

Before emails are communicated, the emails can be analyzed where recommendations or grading can be performed by the communications analyzer 752 directing the user sending the email to use a different goal, voice (tone), motivation or other attribute based on the criteria, such as at least one of the intended recipient's preferences from their profiles and/or an analysis of prior received emails from the intended recipients. The information that is created and the recommendations provided can further based upon relationships to ratios and data gathered from at least one or a history of incoming emails received from the intended recipient(s) of the outgoing email.

In one or more embodiments, when delivering a received email communication to a user, the system 750 can highlight only the important passages of the email communication to the user based on any one of the communications analyses described in the various embodiments here. Thus, instead of the user needing to read every email in detail, the system 750 can highlight certain key statements (e.g., those matching certain criteria, such as the user's preferences) allowing the recipient to skim or view as a summary only 5-20% of the email communication instead of the entire passage or communication. Further, the email communication can be even further condensed by filtering the portion displayed using values, situation or view summaries, if a recipient so desires.

Word Processing Functionality

In one or more embodiments, the system 750 could include the functionality of a word processing program 758 or the communications analyzer 752 could otherwise be included within or connected to a word processing program 758 such that a document prepared by the word processing program 758 can be analyzed by the communications analyzer 752 in order to disambiguate the meaning of the document. For instance, a toolbar in the word processing program 758 could be activated by a user to disambiguate the meaning of a document and provide an output to the user. Alternatively, the meaning of the document can be automatically disambiguated while the document is being prepared, such that the disambiguated meaning of the document can be presented to the user as the user creates the document.

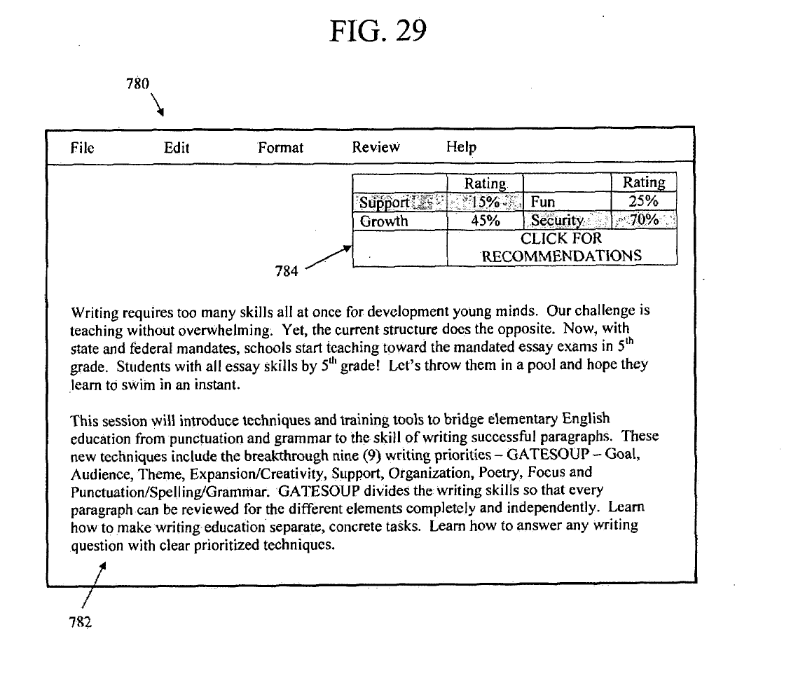

Referring now to FIG. 29, an exemplary screen shot 780 of a document being prepared on the screen associated with the word processing program 758 is illustrated. As the user types the text 782 of the document, a meaning indicator 784 can be displayed to the user on the screen or otherwise generated or indicated to the user, where the meaning indicator 784 contains an identification of the analyzed meaning of the document by the communications analyzer 752. The meaning indicator 784 includes selected ones of the classifications and/or sub-classifications from the hierarchical structure that has been generated based on this document. Certain classifications presented in the meaning indicator 784 can be highlighted if the values they contain fall beneath or below a certain value. Further, the meaning indicator 784 can include a functional icon (e.g., “click for recommendations”) that can be activated by a user to perform the analysis of the meaning of the document and to update or originally display the meaning indicator 784.

Communicator Profiles

In one or more embodiments, a system and method for analyzing communications are provided which analyze communications associated with at least one communicator to determine certain information relating to the communicator(s), such as the attributes, patterns of attributes, preferences, relationships, trends, and ratios as indicated by the analyzed communications. This information obtained by analyzing a communicator's communications is stored as a profile associated with the communicator in a communicator preference database. In one or more embodiments, such profiles are determined by analyzing the multi-dimensional, hierarchical structures that have been generated based upon the analyzes performed on certain communications as described with respect to various embodiments herein.

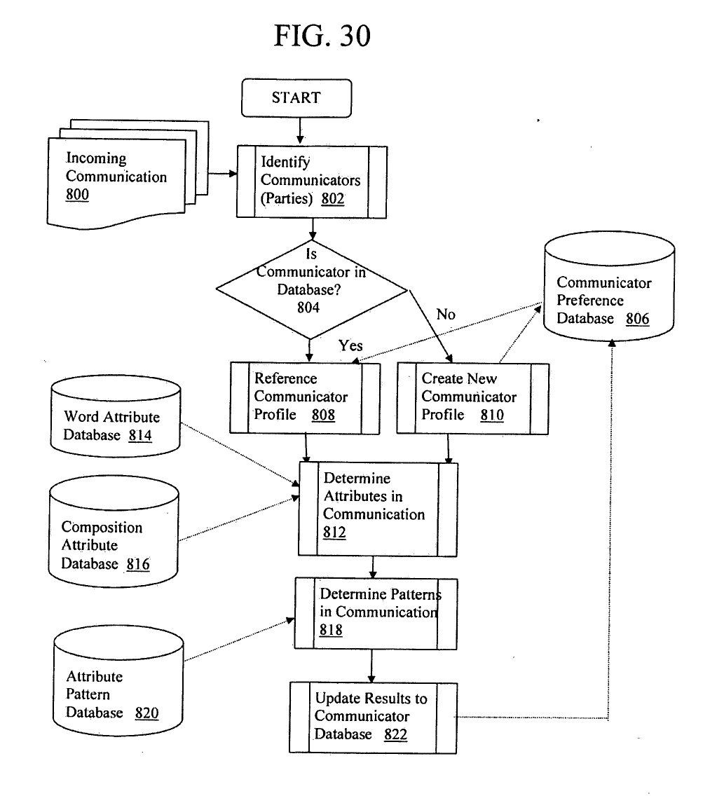

Referring now to the operation flow diagram of FIG. 30, a method for generating or updating a communicator's profile in the communicator preference database is illustrated based upon a communication associated with a communicator. Initially, in step 800, the system receives an incoming communication or otherwise identifies a communication to be analyzed. The particular communicators associated with the incoming communication are identified in step 802. A determination is made in step 804 whether a profile already exists in the communicator preference database 806 for the identified communicators. In one or more embodiments, each profile will at least include a Communication Attribute Table and a Relationship Table. Each profile further includes an identifier for the respective communicator (e.g., a name, email address, identification number, phone number, etc.). For those communicators that already have an existing profile, their profile is referenced in step 808. If no profile is already stored for the identified communicators, new communicator profiles are created in step 810.

In step 812, the disambiguated meaning and/or attributes of the incoming communication are determined. For example, in one or more embodiments, the communication is isolated and then separated into its respective elements (e.g., words, sentences, paragraphs) via known communication analysis methods (e.g., electronic text, scanner, optical character readers, voice recognition, picture and video analysis techniques, etc.). A Communication Attribute Table is created for the separated words and phrases with additional information about each separated component, including the position of each word phrase. A Word Attribute Database 814 is accessed in order to identify and place information in the Communication Attribute Table, such as the definition and attributes of the words. The Word Attribute Database 814 uses the word plus the attributes of predecessor and subsequent words to filter and find the most appropriate and specific definition, even if the word has multiple meanings. A Composition Attribute Database 816 is further accessed based on the previously determined relationships to determine additional attribute and placement information in order to create placements for various phrases (groups of words). The rules in the Composition Attribute Database 816 are determined by relative placement of various attributes. Placements into the Communication Attribute Table are determined both by word choice and by composition analysis.

In further determining the attributes of the communication in step 812, a Relationship Table is created which contains various comparisons of the relationships of the attributes stored in the Communication Attribute Table. In one or more embodiments, these comparisons include basic KADARF ratios, deeper KADARF ratios, Decision Matrix relationships, PLTRABG relationships and change identifiers (as determined by the perspective analyzer), SPVV relationships and the relationship of these to each standard pattern (FSCG, KVA). The compared relationships can be measured against certain standards for determining: a) grading/sophistication, b) persuasiveness, c) process balance, d) audience connectivity patterns and e) style/tone patterns using an Interpretation Ratio Table. The Interpretation Ratio Table has a) grading values and b) improvement recommendations connected to various attributes existence in the Communication Attribute Table and relative ratio in the Relationship Table.

In step 818, the patterns of the incoming communication are determined by utilizing an Attribute Pattern Database 820. The use of certain patterns and/or changes in the use of certain patterns are associated with a communicator's attributes. In step 822, the determined communication attributes and patterns are associated with the communicator's profile and are stored in the Communicator Preference Database 806. If the communicator profile already exists, then the stored profile is updated in step 822.

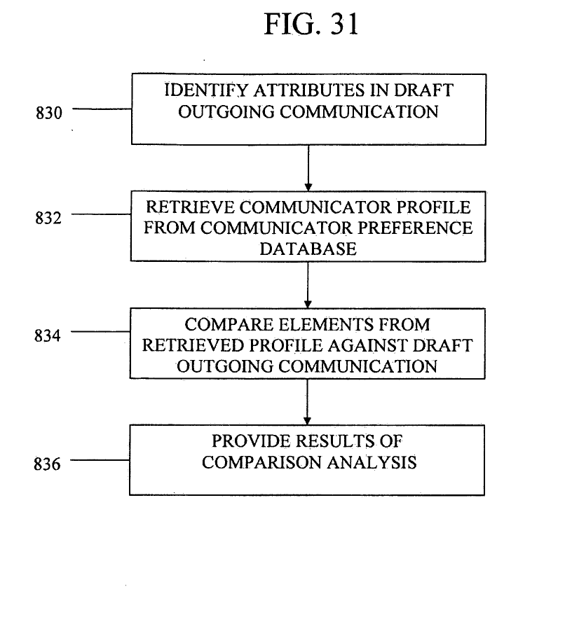

In one or more embodiments, the stored communicator profiles can be utilized to analyze certain aspects of outgoing communications directed to certain communicator(s), as illustrated in the operational flow diagram of FIG. 31. In step 830, the pattern, attributes and/or disambiguated meaning of an outgoing draft communication is identified. The profiles of the intended recipients of the draft communication are retrieved from the Communicator Preference Database 806 in step 832. A comparison is then performed in step 834 between the retrieved profiles and the draft communication, such that a report can be generated that compares the attributes, patterns, priorities and preferences of the chosen recipient (as determined from the retrieved profiles) versus the attributes, patterns, priorities and preferences identified in the draft communication. The results of the comparison are then provided in step 836, where the results may include a table showing the relationship between intended recipients and the draft communication, recommendations for changes to the draft communication to better align with the intended recipient's preferences, or other information.

In one or more embodiments, the stored communicator profiles can be utilized to generate certain actions and/or responsive communications based on certain comparisons performed between the attributes and patterns of incoming communications to the stored communicator profiles of the intended recipients of the incoming communications.

Audience Connectivity Factor

In one or more embodiments, the relationships in the Relationship Table associated with a communicator's profile stored in the Communication Attribute Table 806 recognize when communications combine into various patterns. The present system and method can calculate the relative matching of communications to those patterns. One such relationship resulting from that pattern is a calculation of the Audience Connectivity for each factor. This calculation measures the variance of the communications elements (attributes alone and in combination) from patterns established for certain driving attributes.

These relationships may be presented as relative relationships to each other and to standards as illustrated, for example, by the following tables:

Relationships Relative to Each Other:

| Option A | | Option B |
|---|---|---|
| Standards | \|\| | Comparative |
| Decisive | \|\| | Open Options |

Relative to Standards |S|:

| Option A | | Option B |
|---|---|---|
| Standards | \|S\| \|\| | Comparative |
| Decisive | \|\| \|S\| | Open Options |

In one or more embodiments, the present system and method identify patterns in communications where one element drives different relationships. Specific attribute choices (which can be identified by the prior procedures) drive the relationship of other element sections. These have a high correlation to differentiate where one attribute choice changes the ratios, occurrences, order or other reference data for other attributes. For example, the choice of Results as the top priority of the four Results choices by abundance, order and subrogation (placement in subsidiary clauses versus main sentences) drives some other elements. These analysis and reports are performed by choosing one attribute for comparison to the ratios, order and occurrences of other attributes, such that the system and method can further analyze and report that combination. In one aspect, this analysis is useful because a user might identify one pattern that is less matched (not in synchronization) as other patterns. Reports containing these combinations can provide desired results without the requiring analysis of the full details of communications.

Table comparisons for different outputs are described herein with respect to various embodiments herein, where the comparison of that data can be used by selecting more granular averages, orders, or ranges based upon filtering for a driving attribute. A representative example for the correlation/relativity of one attribute choice to the other attributes and measurements will now be described with reference to the table shown below.

| | | Standard in |
|---|---|---|
| | Relative to next higher | all population |
| | level | and communications |
| Driving Attribute: | | |
| Process: Results: | Selected just for Security | |
| Security | #1 | |
| Related Attribute: | | |
| Process: Decision: | Between 2-4% | Approximately 1% |
| Decisive | | |
| Knowledge: Auditory | Between 0-4% | Between 10-20% |
| Analysis: Standards | Higher than normal | 75% |
| | (90%) | |
| Action: Compete | Higher than normal | 20% |
| | (90%) | |
| Related Measurements: | | |
| Audience Connectivity | Higher Grades/Sales | |
| | when the related | |
| | attributes rates match | |
| | more granular, more | |
| | refined ratios | |

Instead of just measuring the difference from the overall standard, the system can measure the variance from the preferred path for just a single driving attribute or a combination of driving attributes. The system can further create a measurement of that correlation that provides an even quicker understanding of the attribute data. For example, audience losses are shown in the following illustrative table:

| | Audience | Importance for | Attribute |
|---|---|---|---|
| Placement | Loss for this | Chosen | Connectivity |
| Weighting | Attribute | Attribute | Factor |
| 10% | 100% | 10% | 90.0% |
| 20% | 50% | 10% | 95.0% |
| 30% | 40% | 10% | 96.0% |
| 40% | 30% | 10% | 97.0% |
| 50% | 20% | 10% | 98.0% |
| 60% | 0% | 10% | 100.0% |
| 70% | 10% | 10% | 99.0% |
| 80% | 20% | 10% | 98.0% |
| 90% | 20% | 10% | 98.0% |
| 100% | 20% | 10% | 98.0% |

For example, the Importance for Decisive Decisions is more important for a Security goal or audience than the same for a Growth one. Security has Importance for Decisive Decisions near 70% while Growth has Importance less than 30%. This creates different results when applied to different writing with different goals or trying to reach different audiences. Further, the Audience Loss for this attribute might similarly have a different profile. For the convenience of illustrating this example embodiment, only the Importance in manipulated when the driving attribute (such as goal or audience) changes.

The product of the Audience Loss and the Importance Factor becomes the Attribute Connectivity Factor for a particular communication or set of communications with similar driving attributes chosen by the user. The Overall Audience Connectivity Factor equals the product of the individual Attribute Audience Connectivity Factors of the attributes involved in the Situation and Process dimensions. That is, the Overall Audience Connectivity Factor equals Audience Connectivity Factor for the Process Knowledge step for Auditory Connectivity time multiplied by the Connectivity Factor for the Visual step and so on. An example of the attributes and corresponding Attribute Connectivity Factors are shown by the following table:

| | Attribute |
|---|---|
| | Connectivity |
| Attribute | Factor |
| Process: Knowledge: Auditory | 100.0% |
| Process: Knowledge: Visual | 98.0% |
| Process: Knowledge: Kinesthetic | 96.0% |
| Process: Knowledge: Abstract (MindSense) | 97.0% |
| Process: Analysis: Comparative | 98.0% |
| Process: Analysis: Standards | 100.0% |
| Values: Decision Matrix: Practical Reality | 100.0% |
| And so on . . . | |
| Overall Audience Connectivity Factor | 89.43% |

The hierarchical structure can be used by the system for both full and partial analysis, where any number of attributes can be used in the analysis. In the above example, the output uses only a subset of all attributes and it is intended to analyze tone, and not facts. As such, the system works effectively with less processing. In one or more embodiments, the system reviews only the Process attributes without using the Values or Views attributes. For processing time and results relevance, the selection has been limited to certain attributes that have typically material Importance factor values (ranges that move away from 100%) to the particular driving attributes chosen (goal and audience). Attributes that do not usually create values materially less than 100% can be excluded to further avoid extra processing time that may have little impact. Similar matching processes can be used with the entire base, or other subsets, of attributes, but will extend different driving criteria to the matching of Situation and View elements when matching other driving attributes.

In one illustrative example, for the communication “Oh my gosh, he is tall,” the following information is obtained:

| | | |
|---|---|---|
| Verb from database: | ‘is’ | Knowledge: Abstract |
| Phrase from database: | ‘oh my gosh’ | Feedback: Emotional |

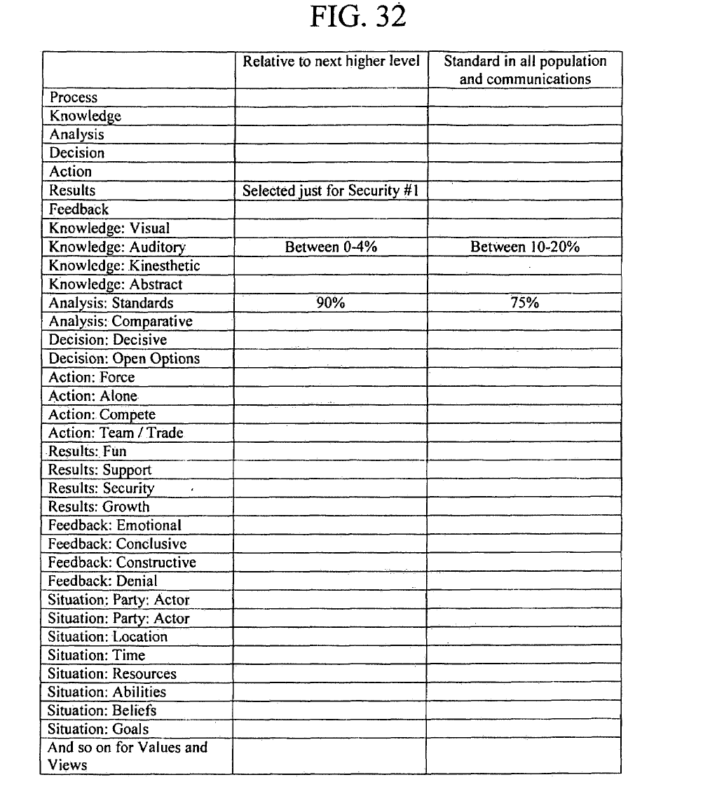

Valuation can then be based upon the order: Feedback is presented first which makes the phrase Emotional Feedback and not Knowledge, where this preference feeds to the calculation, as illustrated in the table shown in FIG. 32.

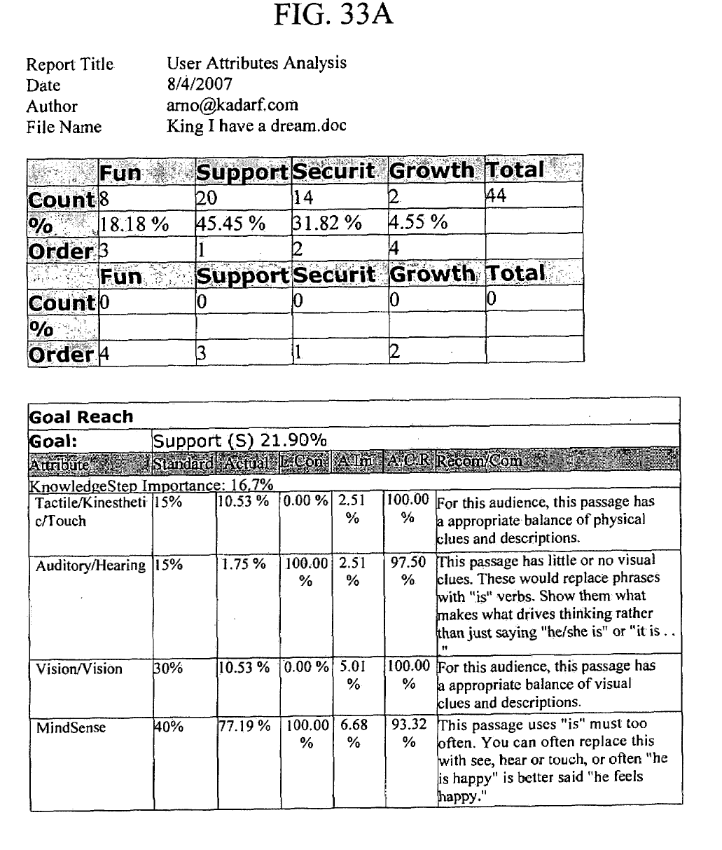

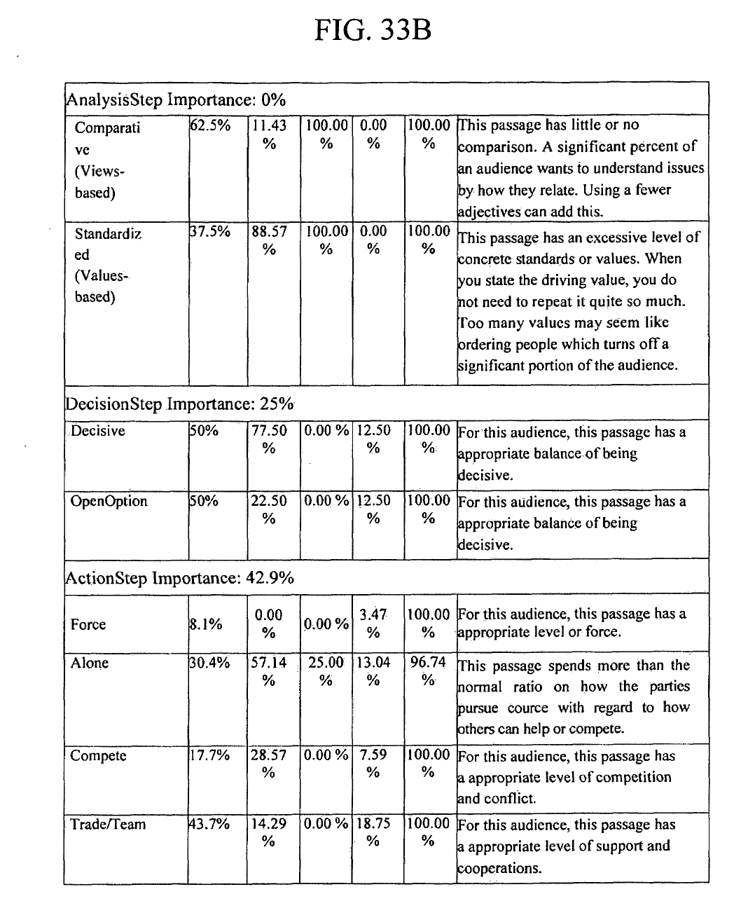

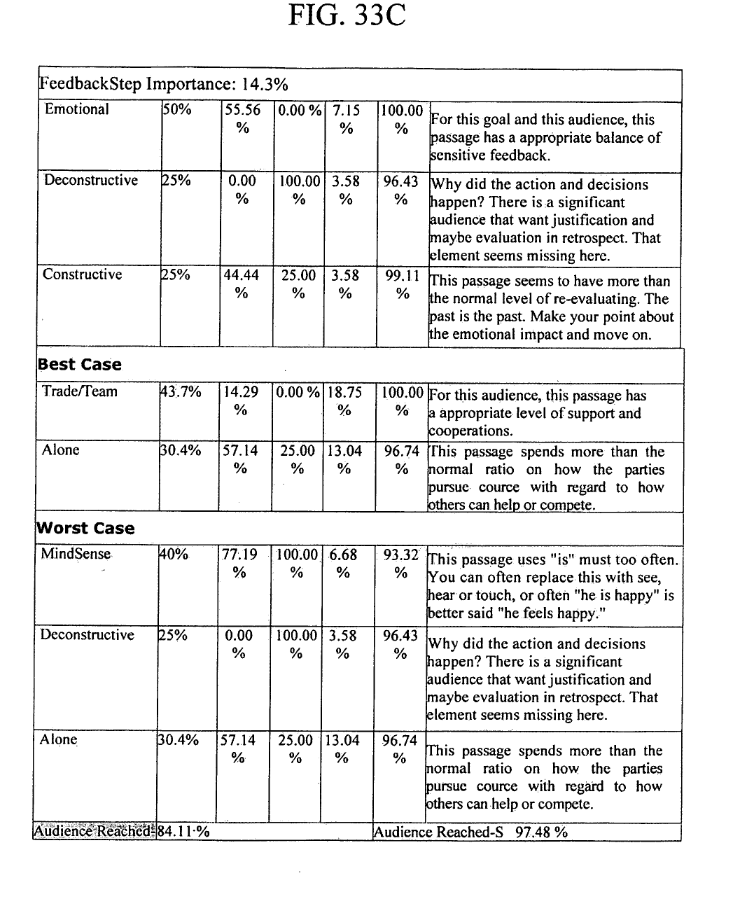

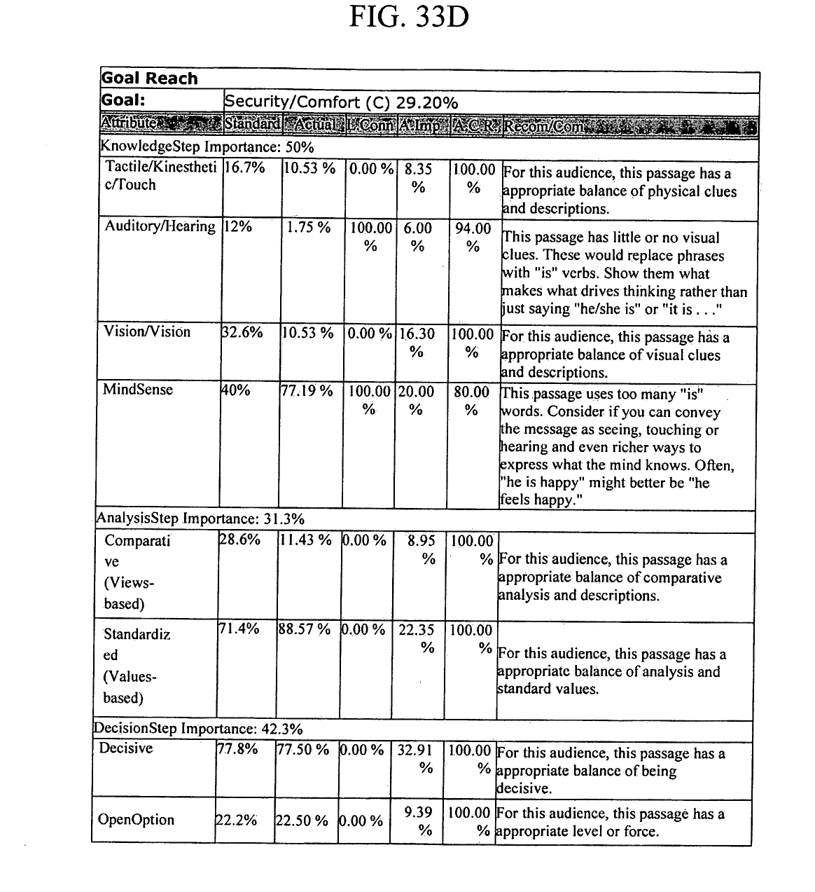

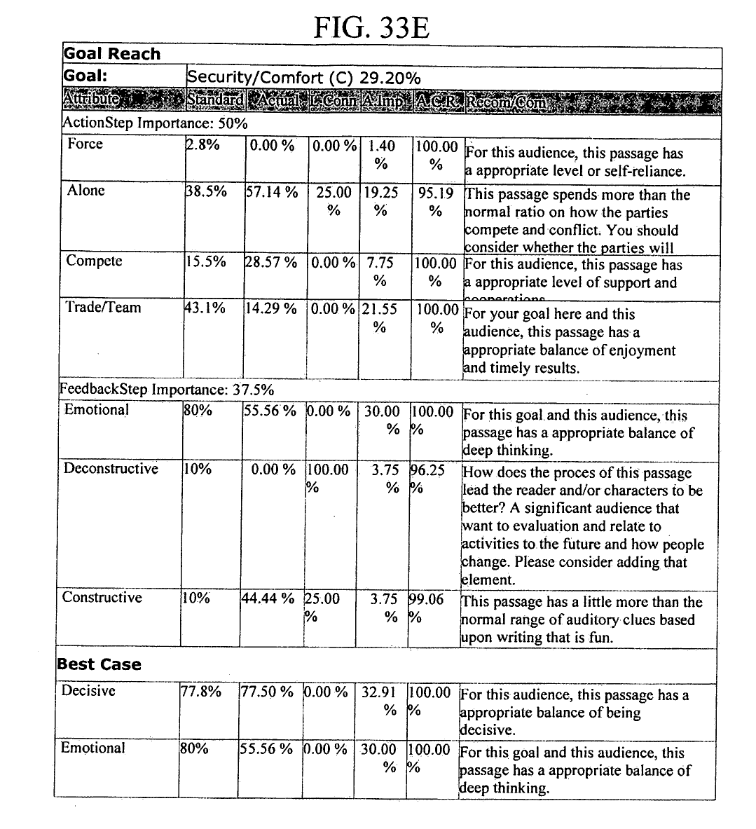

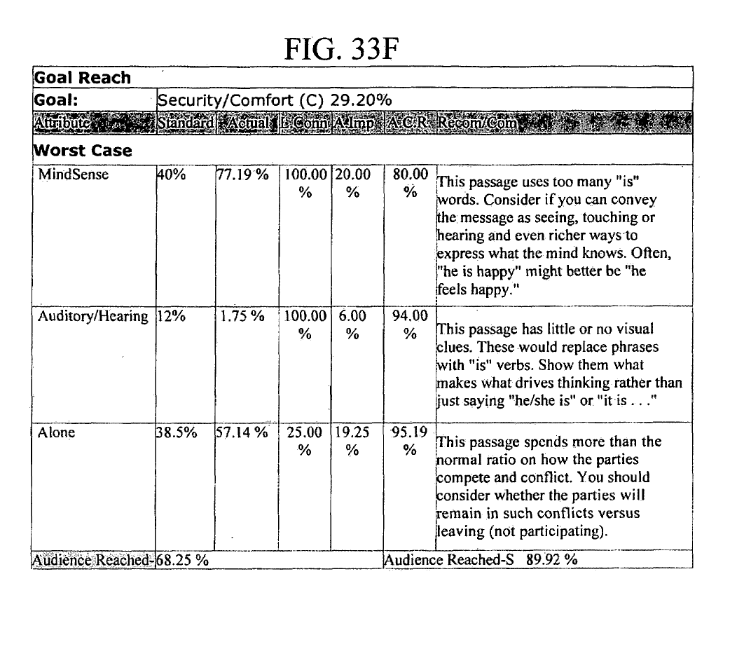

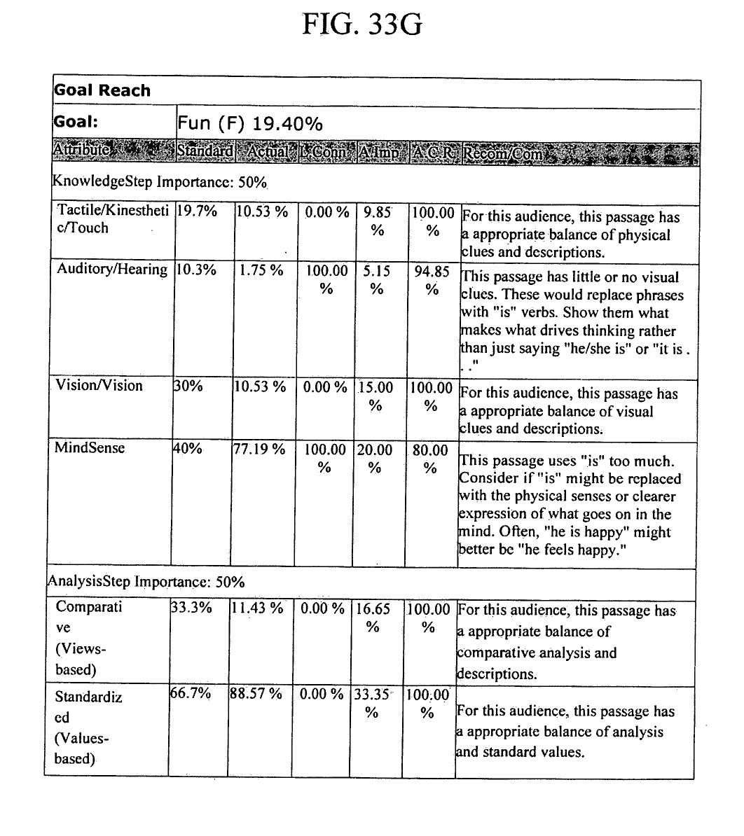

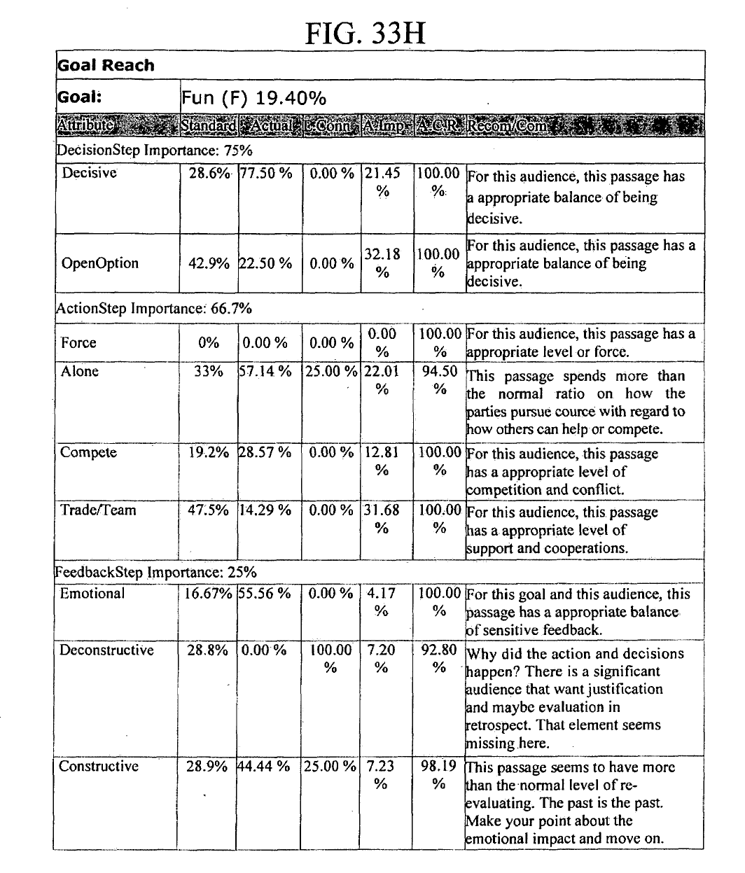

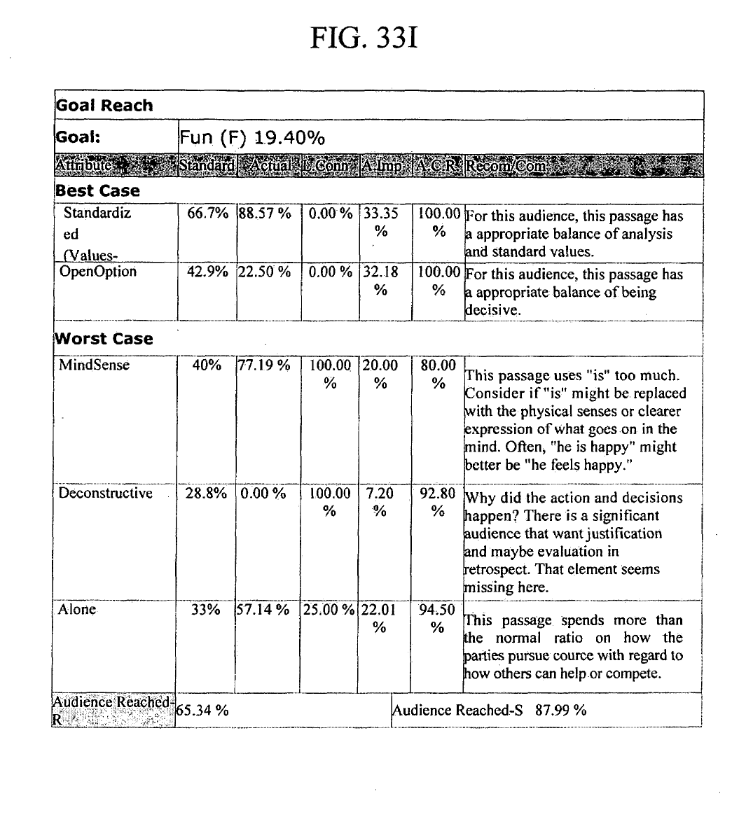

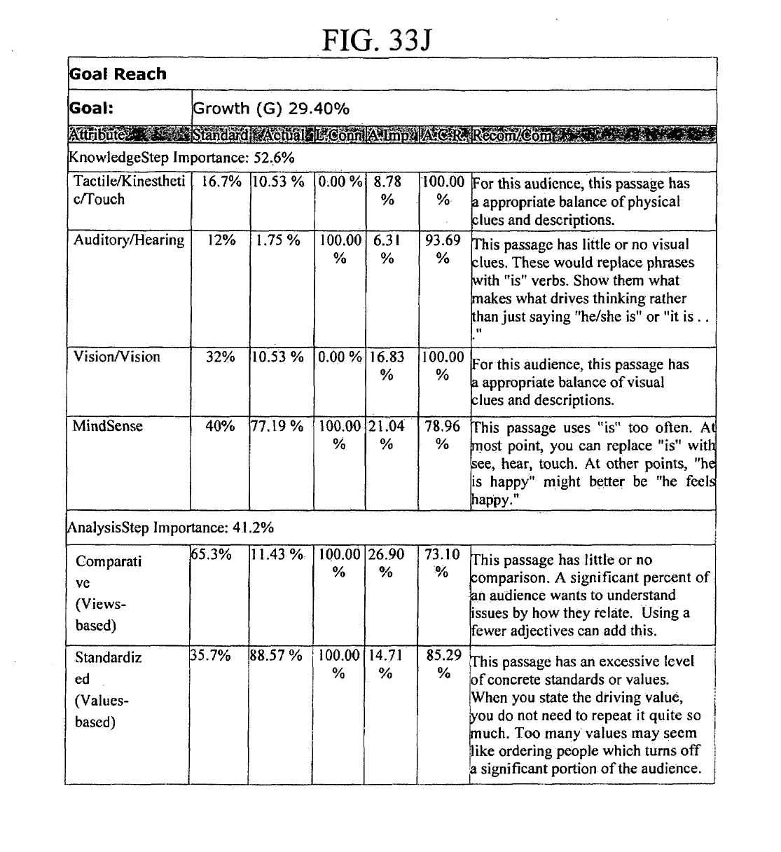

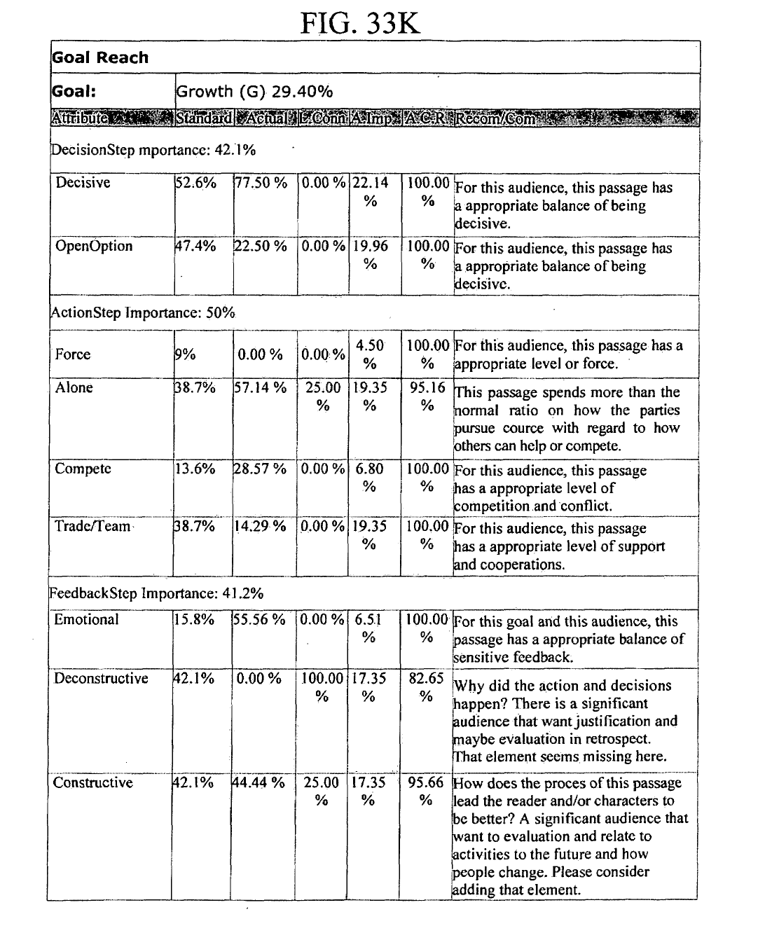

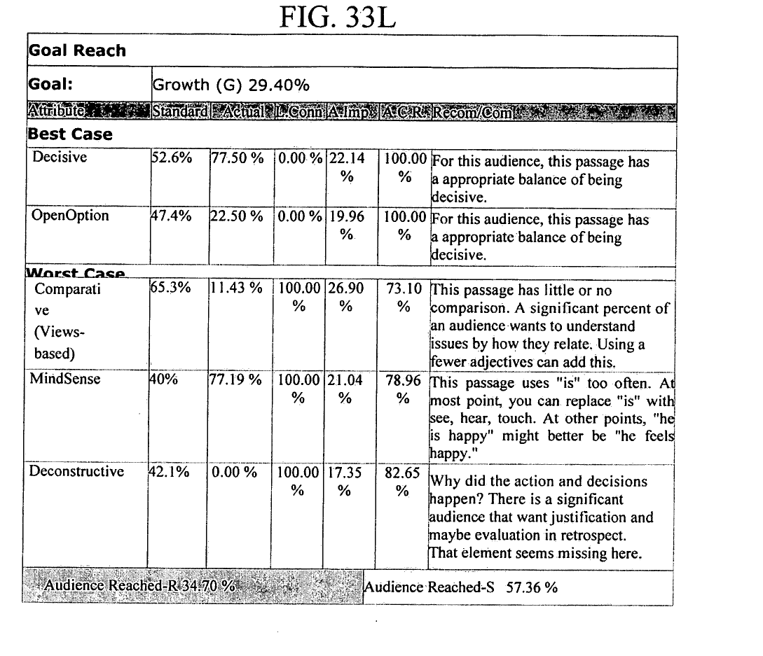

In order to provide a real world illustration of the usefulness of the Audience Connectivity Factor of present system and method, Martin Luther King, Jr.'s “I Have A Dream” speech was analyzed in view of it being widely recognized as a masterpiece of rhetoric. Representative screen shots of the output by the system associated with the Audience Connectivity Factor is illustrated in FIGS. 33A-33E.

Communicator Profiles Using Multiple Communications

In one or more embodiments, multiple communications can be used in combination for analysis and improving data. For instance, a communicator's profile can be based on a collective analysis of multiple communications. A review of further communications might better identify if the tone of the communications has changed in relationship to the specific goal. In one or more embodiments, the style or tone of the communications should match the audience and the objective, and the present system and method provide information that allows a communicator to communicate to different goals and/or different audiences. For example, a number of communications along with their respective Goals, the Voices of the Sender and Recipient Audience, the Recipient's Historical Goals and the Audience Connectivity calculation is shown in the table below.

| | | | Recipient | Recipient's | |
|---|---|---|---|---|---|
| | | | Audience | Historical | Connectivity |
| | Goal | Sender Voice | Voice | Goals | Calculation |
| Communication 1 | Support | Fun | Fun | Fun | 70% |
| Communication 2 | Support | Fun | Security | Fun | 75% |
| Communication 3 | Support | Fun | Fun | Fun | 80% |
| Communication 4 | Fun | Fun | Fun | Fun | 90% |
| Communication 5 | Security | Security | Security | Fun | 40% |
| Communication 5 | Security | Fun | Fun | Fun | 80% |

Analysis based on multiple communications might be used to indicate improvements and other useful information that can be presented to the user based upon the changes to the communications. In general, the Connectivity Factor is desired to improve in most communications, from educational analysis to business applications.

In one or more embodiments, the results can be presented separated by the driving (selected) factor. This enables the results to be sorted for further presentation of the information (e.g., determining that the communicator is better skilled at Fun and Security Voices but not nearly as well in the Support Voice. The portfolio of communications analysis reports given the use of the relational attributes structure provides more granularity and more relationships to present communications. Further, in one or more embodiments, this analysis can be done for other elements and attributes. The use of the Results in the above chosen embodiment occurs because that element has some of the highest correlations to human grading and interpretations. Result attributes provide calculations that present in a similar format than the full range of factors used by the system.

In one or more embodiments, analysis over multiple communications provides valuable information about writing skills that could be missing from a single communication, where such information would only be learned by analyzing a collective sum of multiple communications. The system can use multiple communication to document trends, personality traits and persuasive process preferences, which could be a useful evaluation tool over time, such as by tracking student or employee progress over entire portfolios of communications.

Disambiguating Searches or Other Communications

When using current conventional website search methods, such as a website search for the name of the present inventor “Arno Vigen,” a user would get thousands of ambiguous results that may be wholly unrelated to the results the user desired. These search results include the name “Vigen Tumanian,” where Vigen is a surname and not a family name. Vigen is a common surname in Armenia. These search results would also include “Benedict Arnold” where Arno appears as part of the family name. The search results would also include names such as “Joe Vigen” and “Arno Smith.” In these cases, the communication, via text, position and grammar has actually specified a meaning that unambiguously does not match the request. Arno Vigen is not Vigen Tumanian, Benedict Arnold, Joe Vigen or Arno Smith. Many users would benefit from a method such as the present one that would clearly, unambiguously eliminate those additional results that are unrelated to the results the user desired.

In one embodiment, the system would review both the extracted information about the words as a ‘human specific identification’ or a ‘human’ part of the ‘who’ Party part of a Situation in one embodiment of the classification hierarchy plus ‘identification’ and its subcategory ‘specify.’ The recognition by the definition database applied to the words is the first step. In one embodiment, the system further recognizes the position and grammar rules to determine a more specific meaning for the search requests with ‘Arno’ as the surname specific human identifier and ‘Vigen’ as the family name. This method creates a disambiguation of the search request. In this manner, the new analyzed search request is more exact in defining the search request.

In one embodiment, the system would contain the more specific information extracted from websites where the ambiguities are resolved by the combinations and relationships of the hierarchical placements. That is, the meaning of the website communications are identified with clearer and less ambiguous meanings for the communications themselves before any matching process even occurs.

In one embodiment, the search criteria input will generate a response that requests clarification of the ambiguity before proceeding. The input of a search request (e.g., ‘Arno Vigen’) would generate a response that asks for additional information, possibly deeper in the hierarchy. For instance, the user could be queried, “Is there another surname?” The first name and middle name being subcategories of surnames within human identification. So far, the system only has one surname for the search request “Arno Vigen.” This method of requesting information at a level below the identified information differentiates John Adams versus John Quincy Adams or John B. Smith versus John Q. Smith. It makes the system easier to ask for applicable information automatically in a useful category. Alternatively, the system can ask for parallel categories. Since the “who” Party may be clear as possible and still be ambiguous, the system might provide a request to make the search request less ambiguous using categories of the hierarchy (e.g., having a “who” Party and requesting information about the “where” Location, the Abilities, “when,” etc.). This provides a method to improve the search request information to make it unambiguous before matching it to any websites.

Using hierarchical structures to classify extracted specific meanings from that search request would indicate that words have an element of meaning including human identification, a subcategory of ‘who’ the Party portion of a Situation in one embodiment of the hierarchical structure. In at least one embodiment, the system would recognize by the words from a definition database as human identifiers and further specify that ‘Arno’ is the surname and ‘Vigen’ is the family name. This disambiguates the results. Thus, a search for Arno surname and Vigen family name would eliminate a substantial number of results. The ambiguous results of Arno Smith and Sonia Vigen would get excluded by the method herein.

Existing search engines that do not employ such methods for the segmentation of meaning using the hierarchical structures described herein could be modified to use disambiguating methodologies to eliminate erroneous matches for search results that are returned to a user.

In one or more embodiments, the system and method provide results by combination of disambiguating and ambiguating searches. For example, a search where ‘Vigen’ is the family name, identified either by additional clarification or by identification from the position and/or grammar using hierarchical structures can be linked with the results of missing ambiguous surnames as generated by ambiguating search methods. The present meaning extraction disambiguating process described herein can be used with other types of disambiguating search methods and/or other ambiguating search methods. When the present meaning extraction disambiguating process is implemented in combination with existing search engine functionality (e.g., ambiguating search methods), the combination of the two methods for both disambiguating and ambiguating can generate useful results in combination.

Analysis Specific to the Communicator and Recipient(s)/Audience

In one or more embodiments, the system and method for analyzing communications further provides information related to the profile of an intended recipient of a communication to allow the communication to be modified or specially tailored to address the intended recipient's profile. The communication can be matched against the intended recipient's attributes, patterns and preferences. For instance, the goals, tone (voice), motivation, and other attributes of the communication can be matched to reflect similar goals, tone (voice), motivation, and other attributes of the intended recipient. In one or more embodiments, the information related to the profiles of both parties to a communication (i.e., both sender and recipient) can be matched to ensure the communication matches certain attributes of at least one of the parties.

In one or more embodiments, from the analyses described herein, the system can identify the historical preferential Voice of both parties to the a communication (e.g., sender and recipient) based on analysis performed on prior communications of the sender and recipient. Based on a comparison between the parties' profiles, a set of recommendations can be generated. As an illustrative example, the parties could have the following profile:

Sender's Historical Preference Voice: Security
Recipient's Historical Preference Voice: Security

| Sender | Recipient |
|---|---|
| Sender's Goal | Recipient's Goal |

| | |
|---|---|
| 1-Support | 2-Fun |
| | 1-Security |

| | |
|---|---|
| Voice | Audience (from history) |

| | |
|---|---|
| 2-Fun | 2-Fun |
| 1-Security | 1-Security |

The system could then provide an analysis of the comparison and/or recommendations, such as:
“You have chosen a voice consistent with the audience. That is excellent.”
“Your topic is Support, but you have an audience that does not value Support highly (not #1 or #2). You might improve your connectivity if you can connect the message to Security, which is this audience's primary decision driver.”
“You are writing a message in a voice the same as your natural style—Security.”

The system may then identify the goal of a communication from importance factors. It then identifies the Voice of that communication based upon relative closeness of many factors to a determined tone typical of successful communications achieving that goal.

In one or more embodiments, this matching between communicators may be performed by the system as an automated process that might be the same as a review of a prompted communication. The initial, incoming communications are analyzed as a prompted communication (e.g., similar to grading an academic essay) and compared to the response communications. An illustrative example is set forth below in which the count of various attributes are determined by both word-attribute database and grammar/composition logical rules, wherein the following is determined.

| | |
|---|---|
| Prompt Goal: | Security Goal |
| Prompt Voice: | Security Voice |
| Response Goal: | Fun Voice |
| Response Voice: | Security Voice |

In this manner, the system provides additional functionality to match the calculations of the attributes (e.g., Goal, Voice (tone) Motivation, etc.) of a communication with those of the intended recipient/audience to determine compatibility at a level deeper than the one-sided relationship. The recipient's response can now be matched against these attributes and patterns to determine not just the response's goals, tone (voice), motivation, but also those goals, tone (voice), motivation, etc. of the chosen audience (original sender). In one or more embodiments, the system could be integrated within communication systems combining the analysis over multiple communications, connect received and response communications, and provides additional functionality and reporting extending from the hierarchical structure. The communication system may include email functionality or otherwise be connected to an email server or email program, such that a responsive email sent back in response to a received email would be analyzed before sending it, where grading and recommendations could be generated directing the party sending the responsive email to use a different goal, voice (tone), motivation or other attribute based on at least one of the intended recipient's profile and an analysis of the received email. The information that is created and the recommendations provided can further based upon relationships to ratios and data gathered from incoming email received from that person.

In one or more embodiments, when delivering an email communication to a recipient, the system can highlight only the important passages of the email communication to the recipient based on any one of the analysis described in the various embodiments here. Thus, instead of needing to read every email in detail, the system can highlight the key statements allowing the recipient to skim or view as a summary only 5-20% of the sentences instead of the entire passage or communication. Further, the email communication can be even further condensed by using values, situation or view summaries, if a recipient so desires.

Automated Response System

In one or more embodiments, the system and method for analyzing communications are provided for analyzing an incoming communication to determine the attributes of the incoming communication and for providing an automated responsive communication to one or more intended recipients based the analysis performed. In one or more embodiments, different responsive communications are respectively generated for different recipients based upon the profile and/or attributes of the different recipients. For example, the system could include search engine functionality for searching Internet web sites, such that the particular results that are returned to an individual submitting the search request can be filtered or selected based upon the individual's profile (e.g., attributes, preferences). The results could be limited to those matching the individual's profile or the results could be presented to the individual in an order defined by the correspondence between the attributes of the results and the attributes of the individual. Furthermore, rather than being a responsive communication, the system and method can similarly generate initial communications to one or more intended recipients based upon at least one of an analysis of the communications being sent and the respective profiles of the intended recipients.

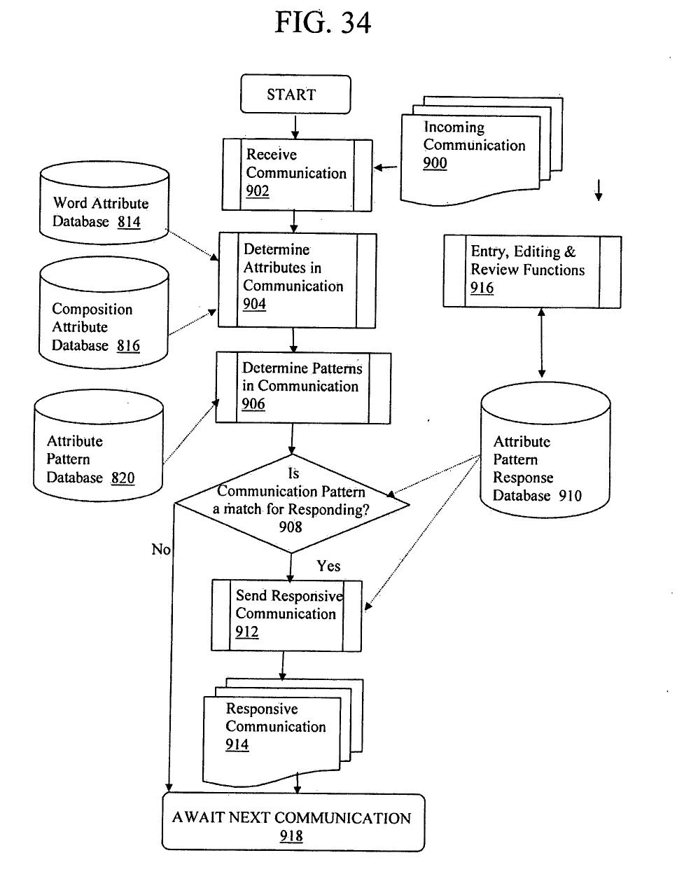

With reference to FIG. 34, an operational flow diagram is provided for the process of generating an automated response using the analyses described herein. For an incoming communication 900 received in step 902, the communication is separated into its respective elements (e.g., words, sentences, paragraphs) via known communication analysis methods (e.g., word processors, electronic text, scanner, optical character readers, voice recognition, picture and video analysis techniques, etc.), and the meaning and/or attributes of the incoming communication are determined in step 904 using the Word Attribute Database 814 and the Composition Attribute Database 816. Patterns of the incoming communication 900 are then determined in step 906 utilizing the Attribute Pattern Database 820. In step 908, a determination is made to determine if a responsive communication exists in an Attribute Pattern Response Database 910 containing attributes and patterns that match those determined for the incoming communication. If so, the matched responsive communication 914 is retrieved from the Attribute Pattern Response Database 910 and sent in step 912. Entry, editing and review functions 916 can then be provided to a user to access and manipulate the responsive communication 914. If no match is located, the system then awaits the next communication to be received in step 918.

For example, the system could recognize those different goals, voice (tone), motivation, etc. of a communication and generate responses different to each sender group based upon the attributes and patterns of the communication and of each sender group. For example, a political campaign can identify a Security versus a Support personality (tone) and respond with an automated response matched to the pattern. Similarly, a visual versus an auditory Knowledge preference identified in an inquiry communications can received personalized, individualized responses in an automated fashion (e.g., one person can receive a picture in the response and another receive a spoken audio presentation based on their analyzed preferences).

In one or more embodiments in which the system and method for analyzing communications provides automated responsive communications involving web site search engine functionality, the system first identifies a set of user preferences (e.g., from prior analysis of the user's communications) and delivers responses to the user's web search with those responses that match both the requested topic and the communication style of the user. Examples of such web site searches may include Internet web page search services, social networking web sites, Internet blog sites, dating web sites, just to name a few possibilities, where it is understood that any type of search program could be utilized where responsive communications are generated. The system would also analyze and filter search results for: a) qualify of the located communications and/or b) style, tone, and voice that match the user's preferences. For example, one user who has a communication style similar to one magazine (e.g., The New Yorker) may automatically get different responsive search results than a person who has a communication style similar to a newspaper (e.g., the Wall Street Journal) or similar to a web site blogger that each approach similar issues in a very different reasoning path.

In this embodiment, the system responds to a search request with information, email, product advertisements and/or websites based upon a user's preferences, where such filtered responsive communications may be more enjoyable or valuable to the user and may also have a much more likelihood to get a user response because they match that user's preference set. For instance, instead of getting numerous pages of countless matches that would take a significant amount of time to review one by one, the present system and method filters the responsive matches to eliminate poor quality matches at a certain level (e.g., eliminate 80% of those that are poor quality) and those that are below a certain threshold with respect to a chosen level of similarity in style, voice, tone and/or reasoning methods. In this manner, if the unfiltered search results may have generated 2,000 responses, the quality filtering may reduce the number of quality matches to a lower number (e.g., down to 400 responsive matches if 80% are eliminated) and then further reduce the number of quality matches to an even lower number based on user style preferences (e.g., down to 100 quality matches). The user will then only have to review a much more limited number of responsive matches, which will help reduce search time and wasted efforts, and will also deliver results that are more likely to be used by the user because they match the user's preferences.

When combined with current methods of using the “hit” measurements in search results or other methods, a three-tier prioritization can be developed based upon user individuality. The trade-off of more results to review (Time) versus missed information is a user determined function. When the present system and method are connected with another search method (e.g., based on number of hits, user-survey ratings, etc.), the responsive search results can be personalized even greater. In one embodiment, surveys can be used to rank websites that would be enhanced by division and/or filtering of the results based upon certain communication hierarchy attributes determined by the survey response method. The survey results would yield different results for different individuals. Most existing methodologies return values that are non-filtered. In one aspect, the present system provide at least one new and useful method to provide results in a further, more individualized method. This personalization can also be used to lead to very personalized matching advertising based upon the various components utilized in the automated responses (sender communication>analysis performed by system>personalized response). As such, automated communications can likewise be proactively generated and delivered to users based on their preferences instead of being generated as a responsive communication.

In one or more embodiments, the understanding of the communicator's preferences can be utilized by companies in their customer service, sales and marketing implementation, where automated communications can be generated based on the communicator's analyzed preferences. For instance, multiple communications can be analyzed to provide automated marketing responses and even updated marketing responses as the communicator's preferences change. It also allows persuasive automated communications to be generated where the communications are more persuasive than traditional “mass mailings” because they can be matched to the particular preferences of each intended recipient, as long as the preferences of the intended recipient are known.

Furthermore, in a very specific example, public companies can use embodiments of the present system and method to monitor employee communications in order to ensure that certain laws are not being broken by the employees (e.g., sexual discrimination, compliance with Sarbanes-Oxley, etc.). Currently, there are billions of dollars spent by public companies being forced to comply with many of these types of requirements. Auditors can reduce their costs by selecting by the methods described herein to filter all communications of a public company for only critical issues. The auditor can expand their scope and actually review a company more completely. Instead of reviewing only signed contracts and invoices, the auditors can review the full scope of a company's communications to identify topic sentences that include audit issues—like warranties, legal threats, contract breaches. Every promise may not be in a contract in the Finance department, but an automated review of every email for certain attribute combinations in the present system may find those types of written communications by the present methods effectively. The benefit to identify unreported liabilities and changes to a company's position are one of the key goals that Sarbanes-Oxley seeks to address, but the structure of financial invoice analysis alone continues to shortchange these goals. The communication analyses described herein could be used to help supplement and achieve these goals.

Specific Communications Analysis Functions

In one or more embodiments, the system and method for analyzing communications is provided that analyzes specific relationships in the communications for recognizing topic sentences, long chain reasoning threads and certain outlines.

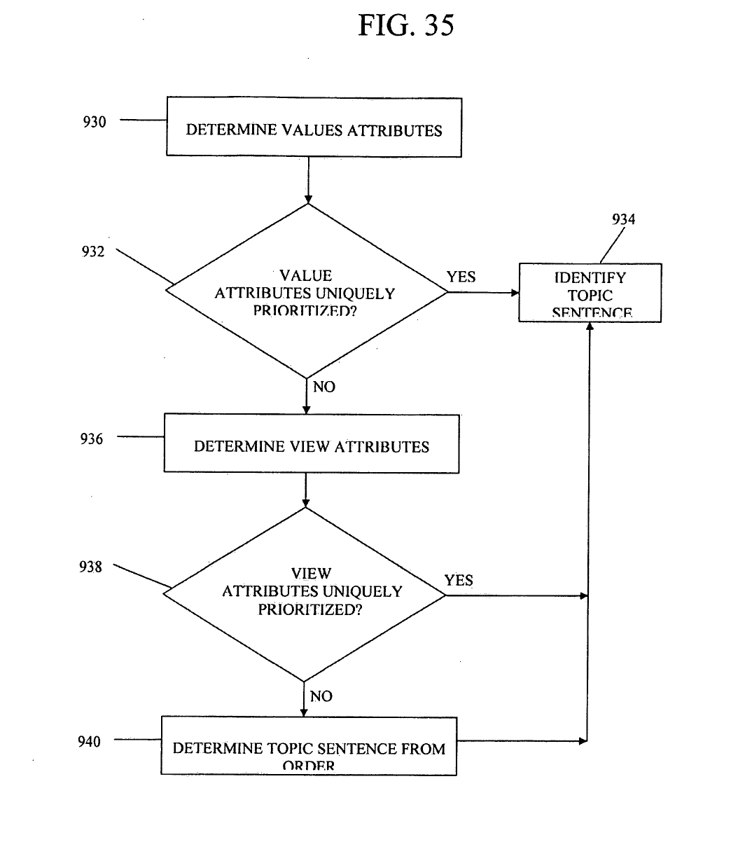

In one or more embodiments, with reference to the operational flow diagram of FIG. 35, the system and method is capable of analyzing specific relationships in the communications for recognizing topic sentences. In step 930, the Values attributes are determined for each word and phrase in the communication, where it possible to created a table of these results. It is then determined in step 932 if one of the Values attributes are uniquely prioritized. If so, the sentence containing that Value attribute is determined to be topic sentence in step 934. Otherwise, the View attributes are determined for each word and phrase in the communication in step 936, and it is determined whether one of the View attributes are uniquely prioritized in step 938. If so, the sentence containing that View attribute is determined to be topic sentence in step 934. If neither the Values or the Views dimension determine the topic sentence, then the topic sentence is determined from the order of the communication where the first mentioned of those sentences with equal values in the other two dimensions is identified as the topic sentence in step 940.

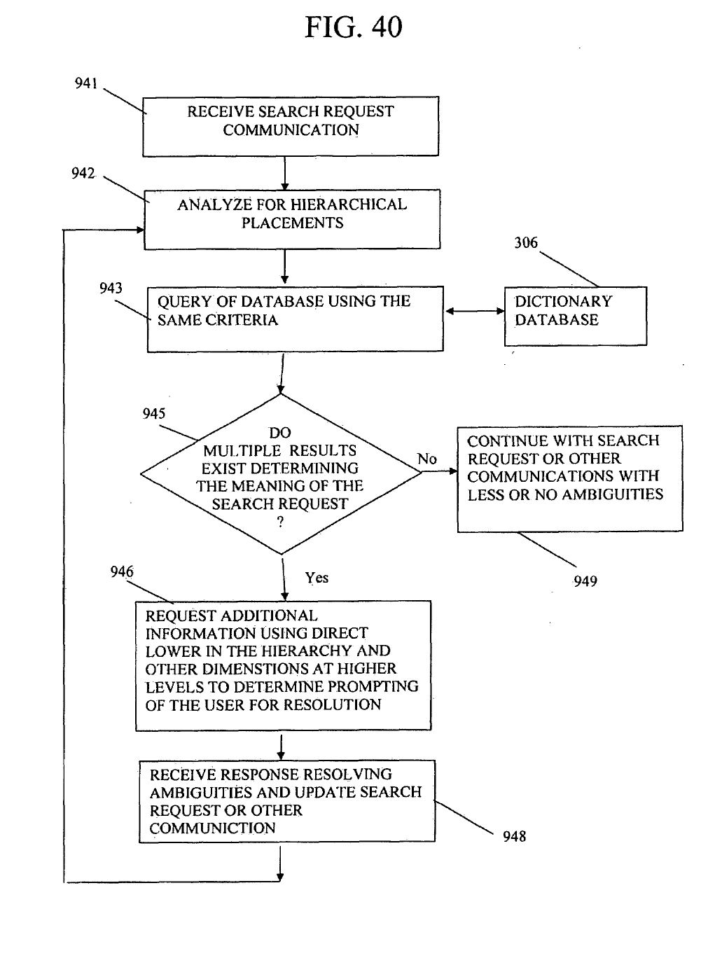

In one or more embodiments, with reference to the operational flow diagram of FIG. 40, a search request or any other communication is received by the system at step 941. The received search request is then analyzed using at least one of the embodiments described herein to create hierarchical placements in step 942 in order to identify the meaning(s) of the search request. The combination of meaning placements would be queried in step 943 using the dictionary database 306 to determine and receive a set of results with the same meaning. The database results set are then analyzed in step 945 to determine if multiple matching definitions were returned from the query. If only one meaning was determined, then the search query or other communication would continue using the definition as determined at 942 and the search or communications would continue at step 949. If multiple meanings were received from the database 306, then the system would query the user at step 946 to provide additional clarification, either deeper in the hierarchy of the meanings identified or in parallel categories where no defining placements were found at step 942. The system then uses the received results from the user to update the search request or communication at step 948 to change and update the search request or communication. The operational flow would then return to step 942 to determine if the refinement resolved the ambiguity.

Topic Sentences—Example 1

The following illustrative example is presented for demonstrating the topic sentence identification analysis using the following example communication paragraph:

“1 There are over twenty million people suffering without health insurance today. 2 They clog our emergency rooms and then hospitals raise the rates to all of us. 3 We must create a national health care system. The people believe in government to help them fix this.”

For this paragraph, the Decision Matrix table would appear as:

| | Pro | Neutral | Con |
|---|---|---|---|
| Practical Reality | 3 ‘must’ | | |
| Basic Respect/Protection | | | |
| Core Personal Beliefs | 4 ‘believe’ | | |
| Higher Order Goals | | | 1 ‘suffering’ |
| | | | 2 ‘clog’ |
| Interaction Commitments | | | |
| Lower Order Goals | 4 ‘fix’ | 1 “twenty million” | |

From this, it can be seen that the same results would be produced if the paragraph was written in the following different order:

“1 We must create a national health care system. 2 There are over twenty million people suffering without health insurance today. 3 They cloq our emergency rooms and make hospitals raise the rates to all of us. The people believe in government to help them fix this.”

In both of the paragraphs in this example, the analysis would still identify the sentence “We must create a national health care system” as the topic sentence even when presented in different presentation orders. The order selected (e.g., given to build suspense or the flow of the story) does not impact the result that one sentences drives the action by the highest value.

Topic Sentences—Example 2

The following additional illustrative example is presented for demonstrating the topic sentence identification analysis using the following example communication paragraph:

“1 There are many reasons to eliminate the death penalty. 2 It is morally evil to kill another person. 3 The justice system executes innocent people every so often. 4 The cost of the court system to administer every death penalty is an unimaginable $10 million in trials and appeals. 5 That is more than we spend on a lifetime of an inmate in prison.”

For this paragraph, the Decision Matrix table would appear as:

| | Pro | Neutral | Con |
|---|---|---|---|
| Practical Reality | | | |
| Basic Respect/Protection | | | |
| Core Personal Beliefs | 1 ‘reasons’ | | 2 ‘evil’ |
| | 3 ‘justice’ | | 3 ‘innocent’ |
| | | | 4 ‘unimaginable’ |
| Higher Order Goals | | | |
| Interaction Commitments | | | 5 ‘prison’ |
| Lower Order Goals | | 4 10 million | 4 ‘cost’ |
| | | | 5 ‘spend’ |

The analysis determines a number of sentences that could be the topic sentence based solely on the Value dimension. In the second stage, the items in the View dimension are analyzed using only those items at the top Value dimension, as shown by the following table:

| Value (Decision | | |
|---|---|---|
| Matrix | | |
| subdivision) | Views | Comments |
| Core Personal | | |
| Beliefs | | |
| 1 ‘reasons’ | 1 ‘many’ | Grouping |
| 2 ‘evil’ | — | |
| 3 ‘justice’ | — | |
| 3 ‘innocent’ | — | |
| 4 ‘unimaginable’ | — | |

At the first level, four sentences show that same highest value. As such, the Value dimension does not determine a specific topic sentence. Since only one sentence of the paragraph has a View dimension, the system identifies this at the topic sentence.

In this example, the presentation order of the sentences in the paragraph can in some instances change based upon the communicator's writing style, but the system will still identify the topic sentence. For example, analysis of the following paragraph would still generate the same topic sentence:

“1 The justice system executes innocent people too often. 2 If that we not enough, there are many other reasons to eliminate the death penalty. 3 It is morally evil to kill another person. 4 The cost of the court system to administer every death penalty is an unimaginable $10 million in trials and appeals. 5 That is more than we spend on a lifetime of an inmate in prison.”

However, in some instances, a communication paragraph that reverses the order of the paragraph does not provide the same topic sentence, such as the following paragraph:

“1 It is morally evil to kill another person. 2 There are many reasons to eliminate the death penalty. 3 The justice system makes mistakes that execute innocent people every so often. The cost of the court system to administer every death penalty is $10 million in trials and appeals. That is more than we spend on a lifetime of an inmate in prison.”

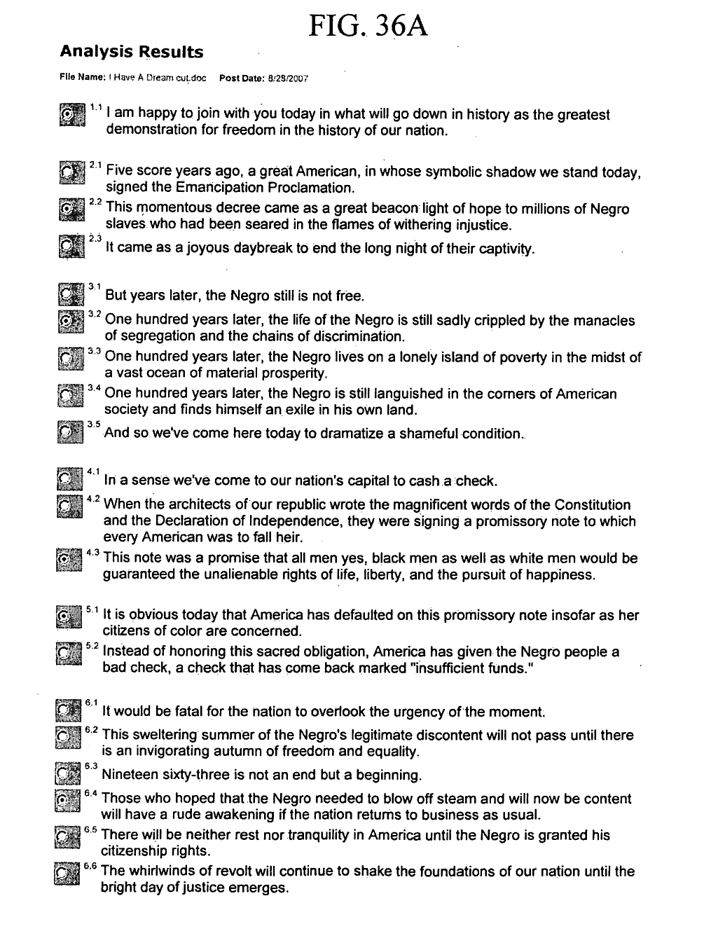

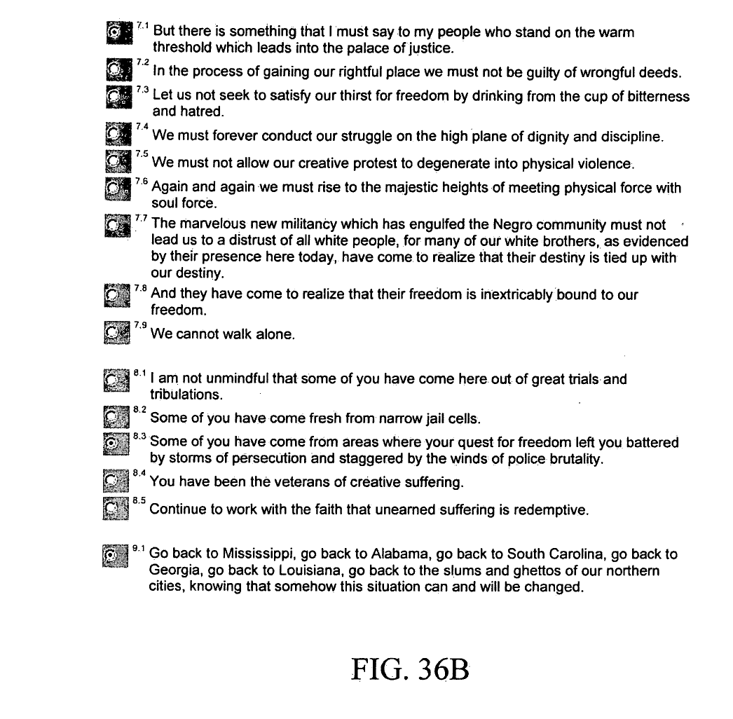

By way of further example, the topic sentence analysis is shown being performed on a section of Martin Luther King, Jr.'s “I Have A Dream” speech, the analyzed portion of which is illustrated in FIGS. 36A and 36B. The speech is separated into paragraphs and then further separated into sentences, where the topic sentences that have been identified for each paragraph in the speech are checked or highlighted in the output presented to the user.

Calculation Methods—Expansion Elements

In one or more embodiments, the specific relationships that can be used for communications analysis can further be defined by recognizing the expansion and stable relationship of the attributes of the hierarchical structure described in the various embodiments herein. For instance, threads follow writing elements until the steady element changes. That is, an opening paragraph may include and expand the Situation elements, but stay within the Knowledge step of the Process dimension. That thinking may will continue for some paragraphs until the Views stay relatively constant. A different passage may be an exchange of opinions, where the View and Parties are changing, but the Belief involved remains constant.

In order to illustrate the expansion elements calculation method, the following text taken from Charles Dickens' story “A Christmas Carol” is analyzed: “Once upon a time—of all the good days in the year, on Christmas Eve—old Scrooge sat busy in his counting-house. It was cold, bleak, biting weather: foggy withal: and he could hear the people in the court outside, go wheezing up and down, beating their hands upon their breasts, and stamping their feet upon the pavement stones to warm them. The city clocks had only just gone three, but it was quite dark already: it had not been light all day: and candles were flaring in the windows of the neighbouring offices, like ruddy smears upon the palpable brown air.”

The results of the data extraction process find attributes, sometimes combinations of multiple attributes, for the various elements. The placements of these attributes into the hierarchical structure are primarily from word/definition extraction, but some grammar presentations create placements. For example, the infinitive “to warm” creates an additional placement as Situation: Goals. Grammar structures create placements as well, not process clauses or imperatives, to generate some grammar driven placements:

“Once (Views1: Selection) upon a time (Situation1: Time)—of all (Views2: Selection) the good (Value1 Pro & Beliefs) days (Situation2: Time) in the year (Situation2: Time), on Christmas Eve (Situation2: Time & Values2: Pro and Values: DM Factor: Beliefs)—old (Situation3: Abilities & Values3: Con & Values: DM Factor HOGs) Scrooge (Situation: Party) sat (Process1: Knowledge) busy in his counting-house (Situation: Location & Situation: Resources). It was cold (Process2: Knowledge & Values4: Con & LOGs & Situation: Abilities), bleak (Values5: Con & HOGs), biting weather: foggy (Values6: Con & LOGs & Situation: Abilities) withal: and (Views3: Grouping) he could (Process3: Analysis & View: Choice) hear (Process4: Knowledge: Auditory) the people in the court outside, go wheezing (Process5: Results & Value7: Con & HOGs & Situation: Abilities) up and down, beating (Process6: Action & Values8: Con & LOGs) their hands upon their breasts, and (Views4: Grouping) stamping (Process7: Action) their feet upon the pavement stones to (Situation: Goal) warm (Process8: Results & Situation: Abilities & Values9: Pro & LOGs) them. The city clocks (Situation: Time) had (Process9: Knowledge) only just gone three, but it was (Process10: Knowledge) quite dark (Situation: Abilities and Value10: Con & LOGs) already: it had (Process11: Knowledge) not been light all (Views4: Grouping) day: and candles were (Process12: Knowledge) flaring (Process13: Knowledge) in the windows of the neighbouring (Views: Relativity) offices, like ruddy (Values10: Con & LOGs) smears (Values12: Con & LOGs) upon the palpable (Situation: Abilities) brown air.”

These results can be represented by the following table:

| | Number to | Total # of | | | Total # Of | |
|---|---|---|---|---|---|---|
| | Different | Attributes In | Percentage | Largest | Attributes With | |
| | Attributes | Dimension | Complete | Category | Placements | |
| Situation | 7 | 7 | 100% | | 7 | |
| Process | 4 | 6 | 67% | 7 | 13 | 55% |
| Value | 2 | 6 | 33% | | | |
| Views | 1 | 5 | 20% | | | |

The above noted results can be explained as follows, the paragraph has Situation Subdivisions of:

| | |
|---|---|
| Parties: | “Scrooge” and subsequent “he” so you know capitalized |
| | Scrooge is Party not Location |
| Location: | “house” |
| Time: | “time” “days” “Christmas Eve” |
| Resources: | “candles” |
| Ability | “old” as in “old Scrooge” |
| Beliefs: | “good” and “Christmas” |
| Goals: | “to” in the infinitive presentation “to warm” |

In this example, many of the subdivision placements are based upon attributes connected with the word definition. Yet, other attribute are determined by composition rules (“to . . . ” creates a Goal) or the understanding that Scrooge is a Party because it is capitalized and followed by a Party pronoun “he.” In one or more embodiments, the present system determines useful information by the combination of such using the structure.

Using this analysis, this paragraph is determined as an expansion of Situation dimension (main attribute). The Situation element is the most complete dimension, with the KADARF table shown below:

| Knowledge | Analysis | Decision | Action | Results | Feedback |
|---|---|---|---|---|---|
| 1 | | | | | |
| 2 | 3 | | | | |
| 4 | | | 6 | 5 | |
| | | | 7 | 8 | |
| 9 | | | | | |
| 10 | | | | | |
| 11 | | | | | |
| 12 | | | | 13 | |

The steady attribute (dimension) can be seen to be the Process, where over 50% of the steps remain within one attribute. The inconclusive dimensions or main attributes include the Values are not highly weighted towards to totally weight toward one type (Pro or Con) but will be partially weighted (e.g., some Con, but not completely), as shown by the following table:

| Pro | Con |
|---|---|
| 1 “good” | |
| 2 “Christmas Eve” | 3 “old” |
| | 4 “cold” |
| | 5 “bleak” |
| | 6 “foggy”, |
| | 7 “wheezing” |
| | 8 “beating” |
| 9 “warm” | |
| | 9 “dark” |
| | 10 “ruddy” |
| | 11 “smears” |

Further, the division of the factors is not complete or highly weighted when combined with the Value Factors (Decision Matrix), shown by the following table:

| | Pro | Con |
|---|---|---|
| Practical Reality | | |
| Basic Respect | | |
| Core Personal Beliefs | 1 “good” | |
| | 2 “Christmas Eve” | |
| Higher Order Goals | | 3 “old” |
| | | 7 “wheezing” |
| Interaction Commitments | | |
| Lower Order Goals | 8 “warm” | 4 “cold” |
| | | 5 “bleak” |
| | | 6 “foggy” |
| | | 9 “dark” |
| | | 10 “ruddy” |
| | | 11 “smears” |

The analyze passage has more Cons; however, those Cons are at Lower factors of importance. The most important factors noted fall on the Pro side. Further, that factor is placed first (giving it a dual placement value in this embodiment). This is not steady; it is expansive in the Values dimension, but it would be ranked as not fully expansive because of the missing top element. The paragraph passage expands in the Values dimension, but so completely as the same passage expands in the Situation dimension (100% vs 67%).

One expression of the View dimension comes at the end of the passage in the word “neighboring.” In addition, the passage has a few other elements for selectors that are common in almost every passage that are steady. The passage stays substantially with one View, as shown by the following table:

| View Dimension | |
|---|---|
| Identification: Selection | 1 “all” |
| Identification: Grouping | |
| Relativity: Importance/ | |
| Priority | |
| Relativity: Sequence/ | |
| Convergence | |
| Relativity: Relationship | Neighboring |
| Comparison | |

Overall, the calculated expansion elements for the four Dimensions (Situation, Process, Values, Views) for this example passage can be summarized by the following table:

| | | |
|---|---|---|
| Situation | Expansion - fully | |
| Process | | Steady in Knowledge |
| Values | Expansion - partially | |
| Views | | Steady |

Calculation Methods—Long Chain Reasoning

In one or more embodiments, the system and method is capable of analyzing specific relationships in the communications for identifying long-chain reasoning threads. The identification of long chain reasoning threads can be a powerfully important tool in the analysis of communications, in artificial intelligence, in sales and marketing, in education and elsewhere. Whether segmenting the thinking of a chain of topic sentences versus the individual phrases within a paragraph, or reporting the element of expansion for each, the identification of the process, content, context of elements across communications is useful. The system provides unique, useful ways to approach the challenges of automating the understanding of thinking and communications.

One manner of identifying long-chain reasoning threads would be to look for the most common element in a communication. In order to avoid false or inaccurate results (e.g., avoiding instances where the word “a” or “the” is identified as the most important element based on its frequency of use), certain types of words like articles, propositions and conjunctions can be excluded from this analysis. All of the non-excluded words can then be counted to identify the most common, which could be used as the topic or theme of the communication.

Non-Text Based Communications

In one or more embodiments, the various embodiments described herein can be expanded as the same hierarchical information can be identified in non-text based communications. For example, an analysis of sound may find patterns that can be classified as Decisions or Feedback Process steps that are not words, but certain inflections in a person's voice. Similarly, a review of pictures or video, or even smells and taste, may yield certain motions or visual relationships that can be translated to hierarchical structure of the present system and can provide another example of translating from one communication type and/or medium to another. A change versus a move are different in a video. These can be translated by the present system into the hierarchical structure, as shown on the following KADARF table:

| | | | | | |
|---|---|---|---|---|---|
| Knowledge | Analysis | Decision | Action | Results | Feedback |

| | | | |
|---|---|---|---|
| Parties | | | |
| Abilities | | | |
| Beliefs | | | |
| Goals | | | |
| Location | Different | “move” | Different |
| Time | | | |
| Resource | | | |

A “move” in an Action that applies only to Location. A “change” keeps the Location the same and the Parties of Resources in the frame changes. As such, a video can be mapped to the attributes of the hierarchical structure and therefore translated to a text description. The various communications analyses described herein can then be performed on the translated text description.

Improving the Presentation of Priorities

In one or more embodiments, the system and method for analyzing communications derives and uses information about relative priorities. For instance, instead of indicating that a communicator is visual, the relative priorities of the communicator may indicate that the communicator is, in order, 1) visual, 2) auditory and 3) kinesthetic. This preference set is different than relative priorities in the following order: 1) visual, 2) kinesthetic and 3) auditory. Understanding these relative priorities allows the system to provide better results when presented.

Preference Presentation

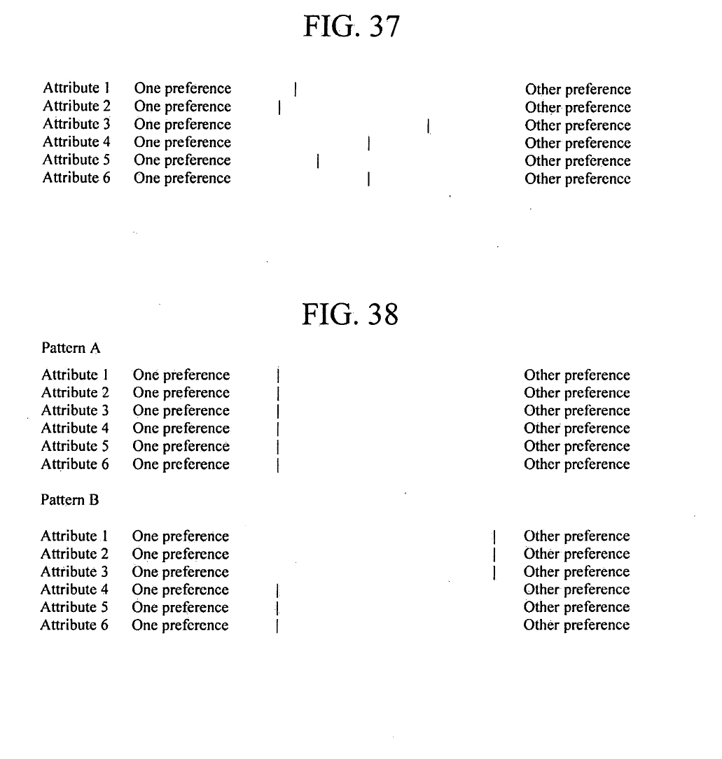

One element of the system is the presentation of these preference sets. The preferences and patterns of preferences can be presented to a user in a display attached to the system. These presentations can further be refined to be related the patterns of these preferences of standard observed combinations, as illustrated by one representative example pattern of preferences in FIG. 37. These are related by their closeness to common patterns. For example, for the Patterns A and B illustrated in FIG. 38, Pattern B may be similar to Pattern A in some attributes (#4 to #6), but Pattern B may be very different to Pattern A in other attributes (#1 to #3).

Calculation of the Total Variance

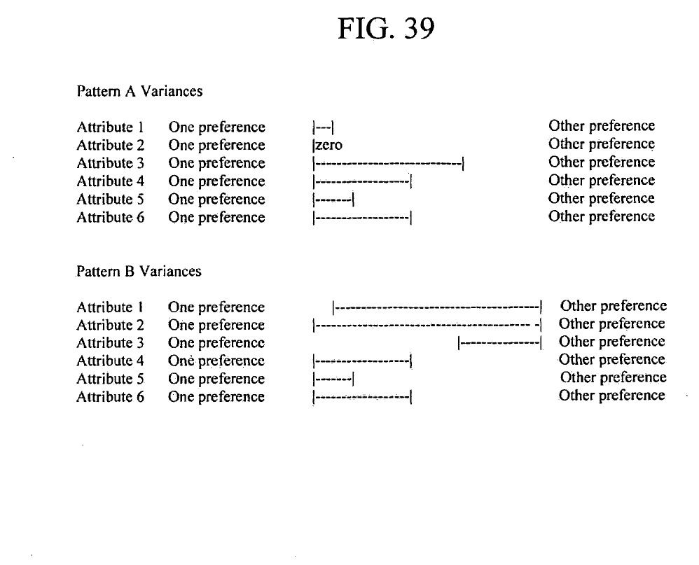

The sum of the variance from the calculated set of preferences to each of the patterns becomes a prioritization. This is often a simpler final presentation—thereby, more useful (faster) for some users. The pattern variances between the target communication of FIG. 37 and the Patterns A and B of FIG. 38 are illustrated in FIG. 39. In this example calculation, the sum of the Pattern A variances versus the target communication is less than the sum of the Pattern B variances versus the target communication, thereby indicating that Pattern A is closer than Pattern B to the target communication. Instead of presenting all these variances and details, the pattern can be named and a relative closeness to this pattern can be identified. Even though Patterns A and B variances are calculated measurements, the pattern of a passage can be calculated as closely. Further, the closeness to the Patterns can be measured, such that the system can quantify and statistically analyze if the closeness measurement corresponds to success (more sales, better grades, etc.). In this manner, each measurement of variance can be further scaled for importance. The system can report if one attribute is more important than another attribute, where the attributes can then be weighted differently. For instance, Attribute 1 and 2 are more important versus 4 or 5 in the illustrative table below:

| | Observed | | Combined |
|---|---|---|---|
| | Variance | Importance | weighting |
| Attribute 1 | 0.9 | A | 0.9 * A + 1.0 * B + 0.4 * |
| Attribute 2 | 1.0 | B | C + 0.4 * D + 0.2 * |
| Attribute 3 | 0.4 | C | E + 0.4 * F = P |
| Attribute 4 | 0.4 | D | |
| Attribute 5 | 0.2 | E | |
| Attribute 6 | 0.4 | F | |
| | | | P = Pattern |
| | | | connectedness |
| | | | Factor |

Closeness can be presented in various methods. A closeness of A higher than B could be presented AB. Closeness can be ABCD or CDBA and so on. The longer presentation might be truncated so only the most closely matching patterns for the user is presented. For instance, both closeness ABCD and closeness ABDC can be presented as A or AB only, since only the most important attributes are likely to be of value to the user in making a determination.

Preference Presentation Example

The following example will be set forth for illustrative purposes only. The may analyze the Results (Goal) preference and/or the Voice (tone) (deeper KADARF pattern) preferences of the communications process in a grid of relative priorities. Choices of one attribute for the Results (Goal) versus another calculates material changes the patterns in other attribute choices. A choice of Security will be more Decision-Decisive than another Results primary choice. As such, the closeness of communication to one pattern can be measured and presented relative to the other.

A communicator might be identified as a Fun-Security preference, or a Support Security preference or a Security-Growth preference. This preference can be documented in tables, but might also be documented as a visual grid of which attribute holds priority #1, #2, etc. This can shown in shorthand, as SG or Security-Growth, or graphically, such as a grid pattern of the four priorities as shown in the table below.

| | | | |
|---|---|---|---|
| Support | Fun | | 1 |
| Growth | Security | | 2 |
| Support | Fun | 1 | |
| Growth | Security | | 2 |
| Support | Fun | | |
| Growth | Security | 2 | 1 |

Further, preferences can be presented in an useful fashion for users, such as marks or colors in a contact list display. This provides additional functionality of being able to view and use the preferences easily. Further, this presentation actually provides additional information for response preparation. For the following table,

| | | | Actions | Results |
|---|---|---|---|---|
| Support | Fun | Now | | 1 |
| Growth | Security | Future | | 2 |

This presentation provides a relationship where the combination of the top preferences provides additional information easily and in better format for the user. The first line is heavily weighted for the Results. As such, communications responses should focus on Results persuasive drivers. This presentation is unique and useful. Users save effort because the system provides summaries without the effort required to do the analysis themselves. Users can further find benefit from visual presentations that allow them to understand complex preference data above language instantly.

For example, the system provides a review of the communication process to identify the preferred communication process (voice or tone) as a set of priorities, as shown by the following table.

| | | | Actions | Results |
|---|---|---|---|---|
| Support | Fun | Now | | |
| Growth | Security | Future | 2 | 1 |

These combinations also provide methods to better prepare communications. The present system would allow a user to see the proposed recipient preferences and be able to adjust their tone, and further the system provides automated feedback if the communication draft has matched that recipient preference. Further, the system provides recommendations for improvement based upon changes to those elements which can be matched to specific words, phrases, compositions elements, order and priority of the communication.

In one or more embodiments, the present system compares the goal of a communication to the preferred pattern of other elements. Using the hierarchical structure, analysis methods described herein produce information about priorities. For instance, more than just identifying a priority as priority #1, the relationship of priority #1 to priority #2 is identified and the relationship of those priorities versus other elements. For example, in one embodiment, the automated comparison of the Goals elements of a communications are compared to the Process elements of other communication step elements typically relative to four types of Results and their most common patterns. This leads to an easy recognition of relationships.

Communication Goal and Method (Process) Determination

In one or more embodiments, the system and method analyzes communications to find that communications are written in a pattern that favors one attribute, but the actual goal of the communications (determined by placements—number, order, grammar and composition) are calculated by the system which is different than the pattern of use for other attributes. The presentation of one illustrative example of this embodiment is shown side by side by the tables below:

| | |
|---|---|
| Goal of | Voice (Tone) of |
| Communication | Communications |

| | | | |
|---|---|---|---|
| Support-2 | Fun-1 | Support-2 | |
| | | | Security-1 |

In this manner, a user without a long description can visualize that they wrote about a Fun activity as the goal, but used the communication steps typical of and more convincing for a Security audience. As such, the user could change the tone to match the goal, and the system would measure that change in a recursive improvement process. Further, a user might recognize that Support was in fact important to the persuasion or connecting and choose to increase both, thereby increasing its importance and the communication process of other attribute to make the method and the message coordinate.

The Communication Goal is determined by creating a table of all attributes within the Results subdivision that are in primary composition placement. Primary placement being the location outside of prepositional phrases and certain relative clauses. Further, a premium value is placed on those found with topic sentences by the analyses described herein. The highest ratio of the four attributes, in this illustrative example, Results, to all placements is the Goal of the Communication:

| | Number of | | |
|---|---|---|---|
| | placements | % | Priority |
| Fun | 18 | 45% | 1 |
| Support | 10 | 25% | 2 |
| Security | 8 | 20% | |
| Growth | 4 | 10% | |

This can be compared for all placements, for only topic sentence placement or for only main clause statements or other filtering methods. In the current embodiment used in the illustrative example, the review is done for all placements as results seemed adequate. It was a choice to eliminate additional process time of the further filters. The system then presents these results to the user:

| | Actions | Results |
|---|---|---|
| Now | 2-Support | 1-Fun |
| Future | | |

Multiple Party Comparisons

In one or more embodiments, the system matches both the preferences of the goals and the communication process (voice) for the sender and the recipient of a communication. Both the goal (“the message”) and the method can be seen for matches from sender to recipient, which makes the relationships more useful. In one or more embodiments, the system further compares the preferred goals and communications of the sender communication (actual or draft) and the recipient preferences, as shown in the illustrative example tables below.

| | |
|---|---|
| Goal of | Tone of |
| Communication | Communications |

Communicator

| | | | |
|---|---|---|---|
| Support-1 | Fun-2 | Support-1 | |
| | | | Security-2 |

Recipient

| | | |
|---|---|---|
| Support-1 | Support-1 | 2-Fun |
| Growth-2 | | |

A user can see which preferences match and which preferences block the message communication process. Most people only get this information verbally, such as from instructors, teachers and/or experts. The time and cost of such derivations are improved by this system. The presentations are unique and itself useful, and even more unique with the further enhancements of specific recommendations and automated responses.

In one or more embodiments, the system can use these four results to create various recommendation and automated responses. In doing so, the system can utilize the stored tables from prior analyses to generate automated responses or create presentations summarizing elements of communications for better, faster, different understanding methods. The responses can be generated visually as shown above, verbally in writing, or through speaking, etc. The same information can be done verbally with automated paragraphs or recommendation prompts on audio describing the preferences and related recommendations. A user could see or hear these as they write in word processing systems. The system can make these changes kinesthetic. For example, a user could mark a passage or move that passage to view or hear the changes. They could hover or right-click on words and get, if removed or if changed by recommendation, kinesthetic results. The user could take the results as written and move one of the boxes and get the specific recommendations to implement that change, as shown by the illustrative example tables below.

| | |
|---|---|
| Goal of | Voice (Tone) of |
| Communication | Communications |

Communicator

| | | | |
|---|---|---|---|
| Support-1 | Fun-2 | Move here | <<<Fun-1 |
| | | | Security-2 |

Recipient

| | | |
|---|---|---|
| Support-1 | Support-1 | 2-Fun |
| Growth-2 | | |

In one or more embodiments, the system may response to the kinesthetic change above to say: “to change the outgoing tone to Supportive: 1) add Feedback Constructive elements (after Results noted in sentence x & y or marked with a highlighting method, 2) Give the reader an Open Option in Decisions (review sentence z where the Voice shows Decisive to either add an option or remove or reduce the forcefulness of the Imperative tense used . . . .”

Rating System

In one or more embodiments, the system can apply a prioritization to the cross-dimensional relationships. An attribute in one leg of the hierarchical structure has predictable importance relative to placements chosen in other elements of the hierarchical structure. This prioritization has the acronym of GATESOPFP (pronounced GATESOUP) that stands for:

Goal for the Situation

Audience/Voice/Tone/Style

Theme/Motivation

Expansion

Support

Organization

Poetry

Focus

Punctuation, Spelling, Grammar and Composition Conventions

The elements of this prioritization can be further understood according to the following descriptions of the elements of the GATESOPFP acronym

Goal for the Situation—this is a prioritization of any linkage in sets of Situation attributes to Results (Goal) defining attributes.

Audience/Voice—this is the importance of the Audience/Voice.

Theme/Motivation—this is the Pros and Cons (Decision Matrix) that drive the various reasoning threads that drive each of the parties.

Expansion—this is the path from the Situation to the Goal with all the attributes required to create that path.

Support—this indicates that the steps chosen must be accepted by the Audience.

Organizations—this indicates that there is an order for presentation based upon the higher criteria.

Poetry—this indicates that there are words that sound and flow better than others.

Focus—this identifies unnecessary, repetitive steps or steps that divert the path that should be eliminated.

Punctuation, spelling, grammar and composition conventions—this indicates that each language has certain rules that make the final communications follow establish norms.

Each of the top layers of the hierarchy has two endpoints measurements and a measurement for appropriate consistency through the communications for those. Some elements should remain steady and some should change according the endpoints and path chosen. For instance, the paths are indicated by the following table:

| | Origin | Destination |
|---|---|---|
| Goal | Situation (who, what . . . ) | Changed Situation |
| Audience | Voice (speaker) | Audience |
| Theme | Decision Matrix causing | Resolved Decision Matrix |
| | conflict or cause of action | |

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of analyzing communications to disambiguate meaning from at least one communication, the method comprising:
receiving a communication including at least one communication element;
transforming the communication into a set of placements in a hierarchical structure corresponding to the communication elements; and
analyzing the hierarchical structure to disambiguate meaning of the received communication.

2. The method of claim 1, wherein the at least one communication element comprises words, order and grammar in the communication, the method further comprising:
transforming the communication into the set of placements in the hierarchical structure corresponding based on the words, order and grammar of the communication elements; and
analyzing relationships and relative ratios of the placements in the hierarchical structure to disambiguate the meaning of the received communication.

3. The method of claim 1, wherein the communication comprises a search request.

4. The method of claim 1, wherein the communication comprises search results being returned to a user in response to a search request.

5. The method of claim 4, wherein the search results comprise information from a website.

6. The method of claim 4, further comprising:
filtering the search results returned to the user using the disambiguated meaning of the search results as a filtering criteria.

7. The method of claim 1, wherein the communication comprises an email communication.

8. The method of claim 7, further comprising:
using the disambiguated meaning of the email communication to generate recommended changes to the email communication to achieve desired communication results.

9. The method of claim 8, wherein the desired communication results are to match communication preferences of an intended recipient of the email communication.

10. The method of claim 1, wherein the communication comprises a word processing document.

11. The method of claim 10, further comprising transforming and analyzing the word processing document in real-time to provide a real-time indication of the disambiguated meaning of the word processing document.

12. The method of claim 1, further comprising transforming the communication into a set of placements in a multi-dimensional hierarchical structure including Situation, Process, Values and Views dimensions.

13. The method of claim 12, wherein the Process dimension of the hierarchical structure further includes Knowledge, Analysis, Decision, Action, Results and Feedback dimensions.

14. The method of claim 1, further comprising:
analyzing the hierarchical structure to identify ambiguous meaning within the received communication;
requesting further information with respect to the identified ambiguous meaning in order to eliminate the ambiguity in the received communication.

15. The method of claim 1, further comprising disambiguating meaning by identifying attributes of the received communication.

16. The method of claim 15, wherein the received communication is associated with at least one communicator, the method further comprising storing the identified attributes in a database as a profile associated with the at least one communicator.

17. The method of claim 16, further comprising:
receiving multiple communications from the same communicator,
transforming each of the multiple received communications into a corresponding set of placements in a hierarchical structure,
identifying attributes of the multiple received communications from their corresponding placements in the hierarchical structures, and
updating the stored profile of the communicator to include the identified attributes from each of the multiple received communications.

18. The method of claim 16, wherein the at least one communicator comprises a group of communicators.

19. The method of claim 15, further comprising analyzing the placements in the hierarchical structure to identify patterns of attributes of the received communication.

20. The method of claim 16, further comprising:
receiving a communication for which an intended recipient of the received communication has a respective profile stored in the database,
transforming the communication for the intended recipient into placements in a hierarchical structure corresponding to communication elements in the communication;
analyzing the hierarchical structure to identify attributes of the communication intended for the intended recipient,
determining that the intended recipient has a profile of attributes stored in the database;
retrieving the attributes of the intended recipient from the intended recipient's stored profile in the database, and
comparing the retrieved attributes of the intended recipient with the identified attributes of the communication intended for the intended recipient.

21. The method of claim 20, further comprising identifying changes to the communication intended for the intended recipient that would improve the match between the attributes of the communication intended for the intended recipient and the retrieved attributes of the intended recipient.

22. The method of claim 16, further comprising:
receiving an incoming communication including at least one communication element;
transforming the incoming communication into placements in a hierarchical structure corresponding to the communication elements in the incoming communication;
analyzing the hierarchical structure to identify attributes of the incoming communication;
comparing the identified attributes of the incoming communication against the attributes contained in the profiles stored in the database to identify communicators having stored attributes that match the identified attributes of the incoming communication.

23. The method of claim 1, further comprising transforming the communication into a hierarchical structure that places the communication elements into an array as the communication elements relate to the preferences, personality, tone or style of the communication.

24. The method of claim 15, further comprising generating a responsive communication having attributes that match the identified attributes of the received communication.

25. The method of claim 1, wherein at least one of the communication elements in the received communication includes a sentence, the method further comprising:
analyzing the hierarchical structure to identify a topic sentence in the received communication.

26. The method of claim 25, wherein the hierarchical structure includes a value dimension including classification information related to the relative weighting of positives and negatives in a communication, the method further comprising identifying a topic sentence in the communication as a sentence having the highest value in the value dimension.

27. The method of claim 26, wherein the hierarchical structure includes a view dimension including classification information related to comparisons, orderings, and variances used to classify relative values based on perspective, the method further comprising, when no single sentence exists having the highest value in the value dimension, identifying a topic sentence in the communication as a sentence having the highest value in the view dimension.

28. The method of claim 27, wherein when no single sentence exists having the highest value in either the value dimension or the view dimension, identifying a topic sentence in the communication based on an order of the sentences in the communication.

29. The method of claim 1, further comprising analyzing the hierarchical structure to identify stable elements versus expansion elements in the received communication.

30. The method of claim 29, further comprising identifying stable elements as those elements having relatively more placements in one of the attributes within a subdivision of the hierarchical structure.

31. The method of claim 30, wherein expansion elements comprise those elements having relatively less placements in one of the attributes within a subdivision of the hierarchical structure while also having placements in relatively all of the attributes within each subdivision of the hierarchical structure starting from the top of the hierarchical structure.

32. The method of claim 29, further comprising combining identified expansion elements with other communication attributes to create a path to outline communications.

33. A method of generating a communication matched to the preferred attributes of an intended recipient, comprising:
determining the attributes of at least one historical communication associated an intended recipient of a communication;
generating a communication to the intended recipient having attributes that match the attributes of the at least one historical communication associated an intended recipient.

34. The method of claim 33, wherein the historical communication associated an intended recipient is a communication previously received from the intended recipient, the method further comprising generating a responsive communication to the intended recipient that is responsive to the previously received historical communication.

35. The method of claim 34, further comprising separately determining the attributes of multiple intended recipients of a communication using at least one historical communication associated with each intended recipient; and
generating communications to each of the multiple intended recipients, wherein each of the generated communications possess different attributes that respectively match the attributes the intended recipients receiving each of the communications.

36. The method of claim 33, wherein the historical communication and the generated communication are email communications.

37. The method of claim 25, wherein the generated communication contains the search results.

38. A system for analyzing communications comprising:
a processor;
a computer-readable medium having computer-executable instructions stored thereon for analyzing communication by performing the steps of:
receiving a communication including at least one communication element;
transforming the communication into a set of placements in a hierarchical structure corresponding to the communication elements; and
analyzing the hierarchical structure to disambiguate meaning of the received communication.

39. The system of claim 38, wherein the at least one communication element comprises words, order and grammar in the communication, wherein the computer-readable medium further comprises computer-executable instructions for:
transforming the communication into the set of placements in the hierarchical structure corresponding based on the words, order and grammar of the communication elements; and
analyzing relationships and relative ratios of the placements in the hierarchical structure to disambiguate the meaning of the received communication.

40. The system of claim 38, wherein the communication comprises a search request.

41. The system of claim 38, wherein the communication comprises search results being returned to a user in response to a search request.

42. The system of claim 41, wherein the search results comprise information from a website.

43. The system of claim 41, wherein the computer-readable medium further comprises computer-executable instructions for:
filtering the search results returned to the user using the disambiguated meaning of the search results as a filtering criteria.

44. The system of claim 38, wherein the communication comprises an email communication.

45. The system of claim 44, wherein the computer-readable medium further comprises computer-executable instructions for:
using the disambiguated meaning of the email communication to generate recommended changes to the email communication to achieve desired communication results.

46. The system of claim 45, wherein the desired communication results are to match communication preferences of an intended recipient of the email communication.

47. The system of claim 38, wherein the communication comprises a word processing document.

48. The system of claim 47, wherein the computer-readable medium further comprises computer-executable instructions for transforming and analyzing the word processing document in real-time to provide a real-time indication of the disambiguated meaning of the word processing document.

49. The system of claim 48, wherein the computer-readable medium further comprises computer-executable instructions for transforming the communication into a set of placements in a multi-dimensional hierarchical structure including Situation, Process, Values and Views dimensions.

50. The system of claim 49, wherein the Process dimension of the hierarchical structure further includes Knowledge, Analysis, Decision, Action, Results and Feedback dimensions.

51. The system of claim 38, wherein the computer-readable medium further comprises computer-executable instructions for:
analyzing the hierarchical structure to identify ambiguous meaning within the received communication; and
requesting further information with respect to the identified ambiguous meaning in order to eliminate the ambiguity in the received communication.

52. The system of claim 38, wherein the computer-readable medium further comprises computer-executable instructions for disambiguating meaning by identifying attributes of the received communication.

53. The system of claim 52, wherein the received communication is associated with at least one communicator, wherein the computer-readable medium further comprises computer-executable instructions for storing the identified attributes in a database as a profile associated with the at least one communicator.

54. The system of claim 53, wherein the computer-readable medium further comprises computer-executable instructions for:
receiving multiple communications from the same communicator,
transforming each of the multiple received communications into a corresponding set of placements in a hierarchical structure,
identifying attributes of the multiple received communications from their corresponding placements in the hierarchical structures, and
updating the stored profile of the communicator to include the identified attributes from each of the multiple received communications.

55. The system of claim 53, wherein the at least one communicator comprises a group of communicators.

56. The system of claim 52, wherein the computer-readable medium further comprises computer-executable instructions for analyzing the placements in the hierarchical structure to identify patterns of attributes of the received communication.

57. The system of claim 53, wherein the computer-readable medium further comprises computer-executable instructions for:
receiving a communication for which an intended recipient of the received communication has a respective profile stored in the database,
transforming the communication for the intended recipient into placements in a hierarchical structure corresponding to communication elements in the communication;
analyzing the hierarchical structure to identify attributes of the communication intended for the intended recipient,
determining that the intended recipient has a profile of attributes stored in the database;
retrieving the attributes of the intended recipient from the intended recipient's stored profile in the database, and
comparing the retrieved attributes of the intended recipient with the identified attributes of the communication intended for the intended recipient.

58. The system of claim 57, wherein the computer-readable medium further comprises computer-executable instructions for identifying changes to the communication intended for the intended recipient that would improve the match between the attributes of the communication intended for the intended recipient and the retrieved attributes of the intended recipient.

59. The system of claim 53, wherein the computer-readable medium further comprises computer-executable instructions for:
receiving an incoming communication including at least one communication element;
transforming the incoming communication into placements in a hierarchical structure corresponding to the communication elements in the incoming communication;
analyzing the hierarchical structure to identify attributes of the incoming communication; and
comparing the identified attributes of the incoming communication against the attributes contained in the profiles stored in the database to identify communicators having stored attributes that match the identified attributes of the incoming communication.

60. The system of claim 38, wherein the computer-readable medium further comprises computer-executable instructions for transforming the communication into a hierarchical structure that places the communication elements into an array as the communication elements relate to the preferences, personality, tone or style of the communication.

61. The system of claim 52, wherein the computer-readable medium further comprises computer-executable instructions for generating a responsive communication having attributes that match the identified attributes of the received communication.

62. The system of claim 38, wherein at least one of the communication elements in the received communication includes a sentence, wherein the computer-readable medium further comprises computer-executable instructions for analyzing the hierarchical structure to identify a topic sentence in the received communication.

63. The system of claim 62, wherein the hierarchical structure includes a value dimension including classification information related to the relative weighting of positives and negatives in a communication, wherein the computer-readable medium further comprises computer-executable instructions for identifying a topic sentence in the communication as a sentence having the highest value in the value dimension.

64. The system of claim 63, wherein the hierarchical structure includes a view dimension including classification information related to comparisons, orderings, and variances used to classify relative values based on perspective, wherein the computer-readable medium further comprises computer-executable instructions for, when no single sentence exists having the highest value in the value dimension, identifying a topic sentence in the communication as a sentence having the highest value in the view dimension.

65. The system of claim 64, wherein the computer-readable medium further comprises computer-executable instructions for, when no single sentence exists having the highest value in either the value dimension or the view dimension, identifying a topic sentence in the communication based on an order of the sentences in the communication.

66. The system of claim 38, wherein the computer-readable medium further comprises computer-executable instructions for analyzing the hierarchical structure to identify stable elements versus expansion elements in the received communication.

67. The system of claim 66, wherein the computer-readable medium further comprises computer-executable instructions for identifying stable elements as those elements having relatively more placements in one of the attributes within a subdivision of the hierarchical structure.

68. The system of claim 67, wherein expansion elements comprise those elements having relatively less placements in one of the attributes within a subdivision of the hierarchical structure while also having placements in relatively all of the attributes within each subdivision of the hierarchical structure starting from the top of the hierarchical structure.

69. The system of claim 66, wherein the computer-readable medium further comprises computer-executable instructions for combining identified expansion elements with other communication attributes to create a path to outline communications.

70. A system for generating a communication matched to the preferred attributes of an intended recipient, comprising:
a processor;
a computer-readable medium having computer-executable instructions stored thereon for generating a communication by performing the steps of:
determining the attributes of at least one historical communication associated an intended recipient of a communication;
generating a communication to the intended recipient having attributes that match the attributes of the at least one historical communication associated an intended recipient.

71. The system of claim 70, wherein the historical communication associated an intended recipient is a communication previously received from the intended recipient, wherein the computer-readable medium further comprises computer-executable instructions for generating a responsive communication to the intended recipient that is responsive to the previously received historical communication.

72. The system of claim 71, wherein the computer-readable medium further comprises computer-executable instructions for:
separately determining the attributes of multiple intended recipients of a communication using at least one historical communication associated with each intended recipient; and
generating communications to each of the multiple intended recipients, wherein each of the generated communications possess different attributes that respectively match the attributes the intended recipients receiving each of the communications.

73. The system of claim 70, wherein the historical communication and the generated communication are email communications.

74. The system of claim 70, wherein the generated communication comprises search results.

75. The method of claim 4, further comprising analyzing the search results using additional criteria for selection by disambiguating the search request using sets of ratios, relationships or combination of meaning elements derived the analysis of the hierarchical structure.

76. The method of claim 75, further comprising disambiguating the search request using a combination of derived hierarchical placements defining the meaning of the search request in addition to the search request itself.

77. The method of claim 75, further comprising analyzing the search request to include the disambiguated combination of derived hierarchical placements defining the meaning of the search request and calculated additional ratios and relationships indicating tone, quality, and measurements subject to a personalized set for further refinement of the search request.
